(19) United States
(12) Patent Application Publication
(10) Pub. No.: US 2006/0020500 A1
(43) Pub. Date: Jan. 26, 2006

(54) Method and apparatus for a creative guidance system

(76) Inventor: Julie Ann Turner, Plano, TX (US)

Correspondence Address: SLATER & MATSIL, L.L.P., 17950 PRESTON RD, SUITE 1000, DALLAS, TX, 75252-5793, US

(21) Appl. No.: 11/187,538

(22) Filed: Jul. 22, 2005

Related U.S. Application Data
(60) Provisional application No. 60/590,195, filed on Jul. 22, 2004.
(60) Provisional application No. 60/701,809, filed on Jul. 21, 2005.

(51) Int. Cl. G06Q 10/00

(52) U.S. Cl. 705/7

(57) ABSTRACT

A system, methods and apparatus for use in creating a dynamic plan for achieving a desired outcome is provided. Methods for identifying and describing the desired outcome by an individual or group are provided, methods for evaluating the current set of circumstances of the group or individual are provided, and methods for developing a navigationally modeled plan for executing the steps necessary to achieve the desired outcome using a variety of evaluation and dynamic feedback tools are provided. A system combining certain conceptual models for planning and the above methods to produce a plan for execution to attain the desired goals by an individual or group is provided. Software implementing the methods and system is provided. Apparatus in a kit form for use in leading a group through the planning process of the invention is provided.

This application claims priority to and incorporates by reference herein the provisional Patent Application Ser. No. 60/590,195, filed Jul. 22, 2004, entitled “Method and Apparatus for a Creative Guidance System,” and this application claims priority to and incorporates by reference herein the Provisional Patent Application Ser. No. ______, Attorney Docket No. JAT-001P2, filed Jul. 21, 2005, entitled “Method and Apparatus for a Creative Guidance System.”

### FIELD OF INVENTION

This invention relates to a system, apparatus, and methods for individual and group planning and strategy development.

### BACKGROUND

In the prior art, various planning or scheduling tools are known. For example, business planners use so-called day-runners, planners, calendars or schedules that are provided as paper forms, or sometimes as software programs, which implement static scheduling tools. Sometimes visual aids such as so-called Gantt charts or other chart forms are used. These planning tools are useful to schedule tasks which are normally performed by the individuals and are most successful when the planned tasks are well understood, and when the group or individual has past or prior experience in performing the task, because the planning model assumes that the task is one where the scheduler knows the steps needed to perform the task and generally knows how long or how much effort is needed to complete the task.

Groups of individuals may also engage in planning sessions. In the prior art, the planning tools are typically oriented to producing “to-do” lists or assigned tasks with a planned schedule for groups, or for individuals within the group to implement a static plan. Such static, step-by-step plans are generally determined by a situation analysis at a current point in time, and, once strategy and steps are determined, they tend to be implemented as is, with little alteration or further assessment of ongoing flux in situation dynamics. Shoploading or resource and manpower scheduling tools are known in the prior art. However, these prior art planning approaches are generally analytical or reactive, in that they focus on analyzing and responding to issues or problems entering or already within the group's awareness, rather than on potentials or opportunities that may lie outside the current scope of operation. Specifically, the focus of prior art planning or strategy efforts tends to be on the current situation or status, the “What Is”—“what already exists” or “what is currently happening”—often with one or more issues identified as problems, which are then addressed by an critical action plan or other planned schedule of tasks intended to redress the problem. Such analytical or reactive approaches, which focus on only past or current issues and events (rather than future potentials), along with the associated static (one-time, rather than dynamic) planning sessions and tools, are thus inherently limited in scope and relevant application.

Moreover, the rate and scale of change in business, society and the community is rapidly increasing. This effectively reduces the time a business, individual or organization has to react to a new development, change, or problem, to very short time periods. With the current business and personal climate changing so quickly, prior techniques for responding to change are inadequate. In the business example, by the time a marketplace change is identified using these traditional methods and tools, often the opportunity has already been seized by a new market entrant or another competitor, and therefore, it is too late to respond, through a traditional planning cycle, to plan, execute, act and begin competing in the new area.

Traditional planning techniques also tend to create static schedules based largely on prior experiences by the individual or group. FIG. 1 depicts an illustrative view of an example 10 of the limited focus of a typical planning session addressed by the prior art. Circle 11 illustrates how a typical individual, company or group in the current state may perceive and identify a collective set of circumstances (Box 13) as a “problem,” and yet, without proper context, groups using traditional approaches do not have the tools to adequately assess whether a given set of circumstances is actually a problem, a distraction, or even an opportunity. Because traditional planning approaches used in the prior art typically focus on the issues identified as problems, these approaches tend to limit the focus of the planning session to the immediate new event or “problem,” and possibilities considered tend to be conventional resource-allocation, scheduling, or emergency reaction responses. Such limited approaches do not lead the individual or the business or group to consider transitions to a new and broader set of circumstances which might hold the potential for substantially different—and more favorable—outcomes than the present, limited set of circumstances 11. This conventional approach may thus be described as “problem-centric”

The traditional strategic planning model uses tools that also result in a limited, static plan. FIG. 2 depicts an illustration of the current circumstances, or “What Is,” circle 11 and the use of traditional “to-do” lists and scheduling 18 to perform strategic planning in response to change 15. The thinking during the traditional planning process begins with the focus on the current circumstances, the “Now,” and breaks down a known approach to a solution of this set of circumstances, defined as “the problem(s),” which are results of Change 15, into a set of smaller steps of “to-dos,” or the “How,” to be performed by individuals or groups to address the problem. These steps are usually expressed as a timeline, schedule or combined “to-do” list. Traditional planning cycles typically begin with the focus on what is happening “Now,” or an analysis of past actions which may have caused the current situation, so that the scope of the planning is limited to “What Is,” or what already exists—an approach which generally excludes consideration of the broader scope of “What Can Be” (FIG. 4). The traditional planning approach thus collects information about the “Now,” the present state or circumstances of the individual or group, analyzes the causes of this present state, and then attempts to define the “How,” which typically takes the form of a schedule and/or plan of steps to address a need or a problem. This traditional approach also tends to focus the plan on resource limitations and other limitations that currently exist—defined as “problems”—and attempts to resolve these problems by scheduling tasks using the existing skills of an organization or individual to eliminate the problem by meeting the “to-do” goals of the plan.

Because the traditional strategic plan begins and ends with a focus and analysis of only the current circumstances, or “What Is,” such traditional strategic planning approaches are inherently limited in scope and meaningful application. Moreover, the resulting resource allocation assumes or inherently begins from a “scarcity” view; that is, it assumes only the present resources are available. As a result, this traditional planning typically produces static, limited plan, which is not adequate to anticipate and address major changes in business, careers, or lifestyle, or to respond to major changes in the environment outside the group or business, such as a new method for doing business developed by a competitor, immediate product obsolescence, and other disruptive or radical changes. The traditional strategic planning approach only contemplates conventional stepwise plans and schedules that are only appropriate for slow, measured and incremental change, and are thus inadequate to address the constant change and increasing flux individuals, groups and businesses face today.

Change is a constant, inherent in the nature of business and life, and requires strategic thinking and planning approaches that are dynamic enough to address, or “navigate” this constant flux. Many today experience change as increasing in magnitude and speed, as well, a shift often attributed to advances in technology and communication, and associated increases in competition, local and global. Unfortunately, traditional planning and strategic consideration tends to consider change as a coercive force to be avoided, and thus there is a perception that the individual or organization is not in control of the situation or future. This outlook also tends to create a perception that resources are scarce and does not comprehend that new resources may be available, developed or otherwise may be accessed.

For example, a business using a static plan may suddenly discover that a new market entrant has begun introducing a product with features or improvements in technology, inevitably causing a shift in the industry that requires a change in their own products or factory, etc. The business, already behind the competition or the market in this wave of change, must adapt to the new reality by transitioning to a new set of circumstances such that their products or capabilities include the new technology; however, their static plan does not enable the business to adequately address this abrupt market shift in real time, much less give them the tools to actively anticipate this technology shift, to navigate and adapt to the new market dynamically, and even to proactively lead and create the next wave of change themselves. The static, formulaic planning tools focus primarily on analyzing past experiences and responding to current circumstances, rather than actively envisioning and intentionally creating the desired change they want to see in their market or their lives. Moreover, these traditional static plans are generated once, based on one set of analysis, and thus are almost immediately outdated, without a built-in mechanism and tools to enable the user(s) to dynamically change course and reallocate resources to navigate and adapt to market changes in real time.

A need thus exists for a system, methods and apparatus to enable individuals, businesses and groups, to plan for and attain a future outcome or state of existence that is desired—to enable individuals and groups to create plans and tools to achieve “What Can Be,” rather than simply to react to “What Is,” what is currently happening now.

### SUMMARY OF THE INVENTION

A method, apparatus and system is described for a planning system, referred to herein as the Creative Guidance System, for individuals, teams, businesses and organizations. The methods and apparatus of the invention are useful for short- and long-term planning, product or service innovation, business strategy development, new business creation, career development, development of majors or career choices for students and individuals in transition, and life and relationship planning and development. For purposes of this description, creation is defined as “the process of defining and taking purposeful action to realize a new reality to which the individual or organization would like to transition or would like to attain.” Examples are creating a new career possibility, creating a new business or community organization, creating an educational plan of study to attain a certain degree or qualification, and the like.

The system provides one master process at first three, and, ultimately, just seven interrelated steps that would that would enable you to create a desired future life relationship project work or career community or society.

The system of the invention operates as a master or “meta” model of the creative process, describing not only the overall process, but also containing and unifying its underlying, recurring forms. This system places the essential elements of the creative process into an operational framework, while retaining the original patterns, stages, steps and sequence of the process. The system is based on two master forms—the creative spiral—and the arc—which is actually a fractal-like form that composes the parts of the spiral form itself.

The arc tools used in the system of the invention are fractals, the proportional “sub-segments” that comprise the whole: each fractal arc is self-contained, and each builds on the next to form the expanding, master spiral pattern. These universal forms are transformed into the simple yet powerful creative planning tools that are easy to remember and apply. The system of the invention provides a creative process or Creative Guidance System that can be applied to all aspects of an individual's life, including career, relationships, personal development, businesses and community planning, and other creative or planning situations.

Using the overarching, universal framework of this process, the individual is able to create a desired future to be obtained, with freedom to choose among possibilities. Because both freedom and structure are captured within this master process, a single, scalable system with the power to create a plan for and obtain any desired outcome is provided. This unique system, then, captures the fundamental patterns and self-replicating, fractal forms for creating a vision for a future outcome. It also allows the associative, pattern-creating process to operate.

The individual fractal arc forms of the core creative process (FIG. 8) recurs at each level of the vision or creation process (which are contained within the arcs of WHERE, NOW, HOW and VISIONSPARC, within the CREATIVE GUIDANCE SYSTEM).

At each higher level, spiraling out to form a unified whole, an overarching pattern which mirrors the overall, evolutionary creative process (just as the individual arcs within the VISIONSPIRAL model compose an overall spiral form).

The CREATIVE GUIDANCE SYSTEM, then, is not a static, merely descriptive model or formula; it is a dynamic, working model of the creative process as “dynamic navigation”. Clearly, to be a creator in the present day environment of searing speed and constant change, more than just a traditional, static plan or formula is required. The system of the invention provides a navigational guidance system that helps individuals or groups using the system move, maneuver, assess and reorient in real time. The creative process provided by the invention is fractal-like and recursive, in that, at each level of creation, the same process repeats.

Once an individual understands the core elements and steps of the core process, the steps can be applied at any level of creation or planning—from project, to career, to relationship, to organization, to community, to society. This master, recurring pattern operates in parallel, on unlimited levels. The system of the invention enables the user to identify, at any time, a desired future outcome, where the user is within the process, to orient to an adjusted destination, and to adjust his or her course. In addition, by establishing a common, shared framework, the system enables users to align and co-create with others along the way. The system is one master process—at its most basic level, just three simple, yet powerful stages—“Where, Now, How”—that enable individuals or groups to create a desired future set of circumstances and create a plant to attain it.

Although this system models the master creative process, it is not a static formula. In the system, the planning process is conceptually described as the process of creation, that is, creating a new set of circumstances which are desired and then creating a plan to transition to that new set of circumstances. In each instance of creation, although the core creative process remains the same at every level, the exact course taken to reach the creative destination may vary—with the creator (the user), with the destination, with the environment.

This flexible system also expands as needed to accommodate higher orders of complexity, with each stage broken down into detailed, yet still simple, steps, to provide guidance at every level of the process.

The recurring forms and stages within the CREATIVE GUIDANCE SYSTEM, as well as the descriptive and memorable mnemonic names designating each element of the process, work with the brain's natural, associative ability to aid recall of the stages and steps, so that creators can access and apply them whenever and wherever they desire.

In addition, this self-similar, recurring structure enables teams and organizations to share a “common language”; through the use of the similar names and terms used to identify stages and steps across all levels of the process, teams may quickly compare progress, reorient and align efforts as they proceed toward joint vision and goals.

The system may be applied to the creation and planning processes encountered in business and in personal and community development, such as, without limiting the invention:
Branding
Naming—Products or Services
Product or Service Market Positioning/Messaging
Innovation—Product or Service Development
Strategic Thinking—Changing Fundamental Modes of Thought
Strategic Planning—Navigational Planning
Organizational Development/Team Alignment
Navigating Change—in Real-Time
Individual Life Planning
Career Development
Relationship Development
Life Direction—Students Charting College, Determining Major

Forms or core tools of the invention for planning (FIG. 3) are 1) an arc form (FIG. 4), which represents the planning journey or time period, and also represents a series of specific core planning steps (FIG. 8), and 2) a spiral form, in which a series of identical but ever larger and expanding fractal arc forms comprise the greater second form of the spiral (FIG. 6).

It is important to note that the arc form is used as a tool which represents a specific, recurring sequence of core planning steps, such that the same arc tool, and the set of steps it represents, may be used at any level of creation (FIG. 5), whether the subject of planning is a project, an individual's career, an organization, or a community. This recurring, “fractal” nature of the Creative Guidance System's arc and spiral tools greatly simplify the understanding and application of this planning system, since the same tool-set works at all levels, and for both individuals and groups. The overview of the Creative Guidance System (FIG. 3) shows how the system of the invention uses the arc to represent this recurring set of steps, first, at the most basic 3-step level, designated as “Where, Now, How” (FIG. 8), then the same arc with the recurring steps described at the more detailed 7-step level, designated as VisionSPARC (FIG. 34), and finally, with the arcs depicted as forming a vertical spiral—including a series of related iterations of the arc as a planning tool—with the spiral, designated as VisionSPIRAL (FIG. 37), describing the recurring steps of the system through which individual or group long-term planning would evolve, when the individual or group consistently uses the system over time to create the results they desire.

While traditional planning methods are focused on controlling, avoiding, or eliminating change (FIG. 44)), a dynamic or “navigational” planning system (FIG. 8) focuses on proactively creating the change that is desired. In addition, the planning methods and tools must be dynamic or “navigational”—that is, dynamically able to adapt flexibly to, and accommodate, changes in the environment or marketplace over time, as well as scalable—such that the planning technologies and tools are equally applicable for both individuals and groups, including businesses and other groups, for example, community organizations. The present invention addresses these needs.

Individuals and groups may apply the methods and process of the invention to perform short-term planning by creating plans using the arc(s) as planning tool(s). As planning progresses, the arcs may be combined together to form a greater route that may either be visually depicted as a long-term or “master” life arc (FIG. 19) or as a spiral (FIGS. 3 and 35), which would be comprised of a series of fractal arcs to form longer-term plans. Groups of individuals may also combine their arcs to align their planning actions into a group navigational plan, which may be visually depicted a series of aligned arcs (FIG. 28) within the same planning journey or time period, where each arc represents actions that contribute to and support the overall navigational plan.

The purpose of the system of the invention is to enable groups or individuals to plan for and attain desired future results, or future alternative states of existence, and to provide a useful planning tool or technology to use to make effective progress towards these shared goals. Methods of the invention guide creativity through a “navigational” model (FIG. 3), in which planning may be viewed as a journey along a navigable route toward the desired new state, circumstance or development.

An individual or a facilitator who may teach or train a group, or individuals, to use the methods and system of the invention at an event (live or online) at which the methods increase dialogue and information exchanges between these individuals, during a strategic planning initiative, or at a facilitator training or certification seminar or series or seminars, may employ the planning tools of the invention for training purposes. The Creative Guidance System includes methods that operate to enable the group to collectively create their new desired state or outcome and to collectively create the planning arcs that will comprise the overall plan for making the transition to the newly desired states. Each planning arc can be further analyzed to create aligned arcs within the same planning journey or time period, using separate arcs to further define the particular plans, including steps to be performed and target dates of completion for the steps to be performed, which may be depicted in the form of a timeline or operational plan. Because the methods and tools are scalable, with the same set of steps working at every level of planning, they may be used for the group collectively or for any particular individual within the group.

The apparatus includes various tools provided in the form of a kit, for use by an individual or to enable a meeting facilitator to present and use the system of the invention with a diverse group of persons within an overall community, or within an organizational (such as corporate or non-profit) structure. The apparatus includes tools for identifying and soliciting new and desirable capabilities or a new status or new results as part of a “Where” or Vision creation step (FIG. 9) from within the group or for an individual to develop, tools for identifying and quantifying possible steps to be taken or skills to be acquired to achieve the new outcome, tools for identifying and quantifying the current state—the Scan State or the “Now” (FIG. 12) of the planning initiative—or capabilities of the individual or organization, planning tools for creating a navigational model for the steps to be taken—the “How” (FIG. 17) of the planning initiative—to transition from the present state or current capabilities or status to the newly desired state or to add the newly desired capabilities or outputs, and a modeling system to enable the plan or navigation to be visually modeled (FIG. 55) or verbally expressed and to incorporate steps and dates to be performed to enable the individual or group to execute the plan.

In some embodiments of the methods of the invention, visual modeling of the plan are used to enhance the use of the invention, in preferred embodiments an arc is used as a visualization of a navigable plan and scheduling tool (FIG. 8) to be used to plan the transition of the individual or group from a current status to the newly envisioned status or capability. The arcs may be used to model plans for a variety of aspects of an individual or groups activities including work and career development, family and relationships, community activities, charitable activities and any aspect of an individual's life, which may be changed or enhanced, by a planning a transition (FIG. 5).

In some embodiments the arcs may be combined to create a visual depiction of a three-dimensional spiral form of a journey or planning period (FIG. 38) to illustrate the growth and development of the individual as the many aspects of their life are enhanced. Similarly, a group or a business may use the spiral visual model (FIG. 38) to plan for the combination of many activities, modeled as individual arcs, as part of a master or strategic plan, which is modeled as the spiral.

Additional methods and apparatus are provided to incorporate the visually depicted plan into other planning documents to create an overall group or community plan to achieve a created new reality or status, and to enable the individuals and the group to navigate through the steps and changes needed to transition to the new reality or status. Methods and tools are provided to measure progress and reevaluate the process as part of this navigational approach to the planning process, and to dynamically respond to changes in the desired outcome as the process is continuing, or to respond to new challenges that may arise during the process.

Apparatus for a facilitated meeting embodiment of the system of the invention are provided. Methods for a facilitator to communicate the system of the invention and to conduct a meeting with a group where a newly created outcome is developed and a navigational guidance system is implemented to enable the group to embark on a transitional journey to progress towards and achieve the new outcome are provided. Various tools for communicating the meeting schedule and location and for encouraging attendance by the target members of the various diverse groups who are intended to benefit from the meeting are provided. The apparatus described herein includes tools for use in an enhanced dialogue method that is the subject of U.S. patent application Ser. No. ______, filed Jun. 21, 2004, entitled “A Method and Apparatus for Enhancing Influence,”, which claims priority to Provisional Patent Application Ser. No. 60/543,851, filed Feb. 11, 2005, herein incorporated by reference. This referenced patent application describes various methods for conducting dialogue sessions with groups of individuals to develop enhanced dialogue to enable the participants from a group or organization to collectively identify the newly desired capability, result or state, and to use the Creative Guidance System to create a customized navigational plan for achieving that newly desired state at the event itself; including tools for allowing the members to self-organize in smaller groups, and game-like tools for use within the smaller groups to encourage the free exchange of frank dialogue between individuals and tools and methods for allowing each smaller group to effectively autonomously conduct one or more dialogue sessions where frank viewpoints are exchanged about the new creation and dialogue is encouraged and facilitated among all of the members, regardless of the individuals' social rank, age, economic or professional standing, or participants' racial or cultural diversity. Facilitators' kits are provided containing cards, objects, posters and materials to enable self-selected group leaders to quickly learn how to facilitate and lead the dialogue session and to keep the exchanges open and to ensure fairness in speaking time and floor time for each member of the dialogue group.

Methods are provided to use the materials within the kit (FIG. 43) for the Creative Guidance System to conduct one or more sessions. The methods include a method for guiding a discussion to identify newly created desired outcomes or goals, a method for identifying necessary capabilities to be added or steps to be taken, a method for depicting a navigational plan and for communication and facilitation using a web-based interface or alternatively using bulletin boards, phone trees, recorded messages and other means to communicate the plan to and within the members of the group or organization. Methods are provided to use the materials within the kit to facilitate the exchange of dialogue and enhance the influence at the particular session. These include methods which enable the attendees to self-organize, to propose topics about which they wish to engage in dialogue, and to conduct the individual dialogue sessions in a manner designed to enhance and encourage each attendee to fully participate in the exchange.

Methods for conducting the Creative Guidance System of the invention using software are provided. Various methods of the invention may be provided in software modules or in a complete suite of software applications (FIG. 42) for use on a computer by an individual or by a group to create and plan a navigational methodology for attaining a desired goal or change. The software will lead the user through the steps of the methods of the invention by providing forms or questions to be answered and charts to be filled in by the user, the user will develop a vision or desired outcome and will collect information about the current status or set of circumstances of a particular aspect of their life, and the software will then guide the user through the application of the navigational planning method of the invention. In some embodiments the software may output a calendar or schedule, or in certain embodiments the software may create a file that is compatible with existing software or scheduling tools. The software may assist the user in creating visual representations of plans as navigable arcs, or visual representations including a series of navigable arcs, or extending the visual representation to spiral forms comprised of a series of the arcs. Schedules including deadlines, resource allocation, and persons responsible for certain tasks may be created and visually represented along a navigable arc form.

The tools and methods of the invention thus provide a dynamic, navigational planning method or system for creating a visually representable plan to achieve a desired goal. The Creative Guidance System is a planning system that is future-oriented and potential-generating, rather than being past-analytical and problem-centric as the planning systems of the prior art.

While prior art planning focuses primarily on past trends or analysis of current conditions and problems/issues (Now and How) and developing a static plan to address the these current issues and circumstances which already exist, the navigational planning system of the preferred embodiments focuses on desired future outcomes and experiences (Where), guides the participants to explore potentials (What Can Be), and creates a dynamic plan to enable the participants to generate desired outcomes which do not yet exist.

The planning methods and tools of the invention enable users to proactively, consciously create intentional and desired change, rather than merely to react to changing circumstances or problem-solve. The planning system enables users to dynamically navigate and constantly adjust and adapt the plans and timelines produced in order to incorporate emerging opportunities and address new challenges, and to accordingly reallocate resources (both human, and financial) in real time so as to attain desired result(s). Thus, plan priorities and resource allocation is always optimal and up to date. The planning system of the invention is inclusive, encouraging dialogue and collaboration from across the organization, with planning tools shared at every level to engage all stakeholders in creating the plan. The planning system operates using unique tools or forms, the arc and spiral, which represent the recurring sequence of steps of the invention that are applicable at every level of the planning situation, such that the steps contained within the process represented by one repeating arc combine to generate an expanding spiral planning system. For convenience in understanding and to enhance communication, the planning system and tools of the invention use mnemonic names for each sequence of steps, such that each sequence is easily remembered as an acronym (Where, Now, How; VisionSPARC; VisionSPIRAL).

### BRIEF DESCRIPTION OF THE DRAWINGS

FIG. 1 depicts an illustration of the typical planning style of the prior art;

FIG. 2 depicts the use of traditional planning or problem-solving approaches to respond to a change in a situation;

FIG. 3 depicts some of the planning tools for use in the methods of the invention;

FIG. 4 is an illustrative view of a transition from a present state to a future desired state using a creative arc as a planning tool of the invention;

FIG. 5 illustrates a variety, of levels of activities modeled as creative arcs of the invention and where the arcs are in alignment;

FIG. 6 depicts the fractal creative arcs of the invention combined to form a larger form of a visual tool of the invention, the creative spiral;

FIG. 7 depicts another tool of the invention, the creative spiral form composed of fractal forms of creative arcs;

FIG. 8 depicts a first method of the invention using the creative arc as a planning tool, the “Where, Now, How” method;

FIG. 9 depicts the Vision process of the “Where” step of FIG. 8;

FIG. 10 depicts a possible Vision statement produced while performing the methods of the invention;

FIG. 11 depicts a possible Mission statement produced while performing the methods of the invention;

FIG. 12 depicts the steps performed in the “Now” step of FIG. 8;

FIG. 13 depicts an example P.O.W.E.R. analysis worksheet used in the Analyze step of FIG. 9;

FIG. 14 depicts additional steps that may be performed in the “How” step of FIG. 8 in the form of collaboration;

FIG. 15 depicts a S.W.O.T. worksheet that may be used in the Analyze step of FIG. 9;

FIG. 16 depicts the SCOPE step of the method of FIG. 9;

FIG. 17 depicts the steps of the Plan step of FIG. 8.

FIG. 18 depicts the life events of a certain individual modeled as a creative arc of the invention;

FIG. 19 depicts a worksheet for use with the creative arc tool and the methods of the invention;

FIG. 20 depicts a second worksheet for use with the methods of the invention;

FIG. 21 depicts the methods of the invention applied to creating future realities and planning for kids;

FIG. 22 illustrates a framework for use with another method of the invention as applied to brand creation;

FIG. 23 illustrates the use of the creative arc in the brand creation method of the invention;

FIG. 24 illustrates the use of a framework of the invention in the brand creation method of the invention;

FIG. 25 depicts the application of the “Where, How, Now” method of the invention to brand development;

FIG. 26 depicts typical events which may occur during a brand development;

FIG. 27 depicts the events of FIG. 26 with the creative arc tools of the invention applied to the events;

FIG. 28 depicts the use of the methods of alignment of the creative arc planning tools applied to the events of FIG. 26;

FIG. 29 depicts the creative arc tool of the invention as applied to the brand development process and events of FIG. 26;

FIG. 30 depicts the brand experience using the creative arc tool and the methods of the invention;

FIG. 31 depicts the hierarchy of brand arc synergy that may be achieved using the methods of the invention;

FIG. 32 depicts the brand arc tool of the invention applied to brand development;

FIG. 33 depicts the VisionSPARC planning tool and method of the invention;

FIG. 34 depicts a portion of the VisionSPARC tool of the invention;

FIG. 35 depicts a the use of the creative arc tool of the invention to form the spiral form of the tool of the invention;

FIG. 36 depicts the application of the creative spiral of the invention to certain events that occurred in the lifetime of an individual;

FIG. 37 depicts a graphical representation of the VisionSPIRAL tool and method of the invention;

FIG. 38 depicts in detail the particular methods and steps of the VisionSPIRAL tool of the invention;

FIG. 39 depicts in flow chart form the “Where, Now, How” method and the creative arc tool of the invention;

FIG. 40 depicts in flow chart form the VisionSPARC method and the two dimensional spiral tool of the invention;

FIG. 41 depicts in flow chart form the VisionSPIRAL method and the three dimensional spiral tool of the invention;

FIG. 42 depicts in flow chart form a software tool for practicing the methods and tools of the invention using a computer;

FIG. 43 depicts a kit form for providing various objects and tools for use with the methods of the invention;

FIG. 44 depicts another illustration of the impact of the creative arc tool and methods of the invention in contrast to the static planning tools of the prior art;

FIG. 45 depicts a series of events that may occur in an individuals experience in response to change;

FIG. 46 depicts the creative arc tool of the invention applied to the events of FIG. 45;

FIG. 47 illustrates the concept of the power of choice as a creative force;

FIG. 48 depicts a poster which may be used, for example, at an event to illustrate the tools and methods of the invention;

FIG. 49 depicts a guidesheet visual aid which may be used with the methods of the invention;

FIG. 50 depicts a creative arc worksheet which may be used with the methods of the invention;

FIG. 51 depicts a life arc worksheet which may be used with the methods of the invention;

FIG. 52 depicts a worksheet for performing the navigational planning methods of the invention;

FIGS. 53A-Q depict an example Master Plan for a corporation;

FIGS. 54A-B depict an example Operational Plan for a corporation;

FIG. 55 depicts sample arc planning template and timeline which utilizes the creative arc tool of the invention and visually represents a plan for achieving a desired goal as a navigable arc, with the deadlines and executable tasks depicted as steps along the navigable arc; and

FIGS. 56A-D depict, in flow chart form, the steps for the first level, the “Where, Now, How” method of the invention.

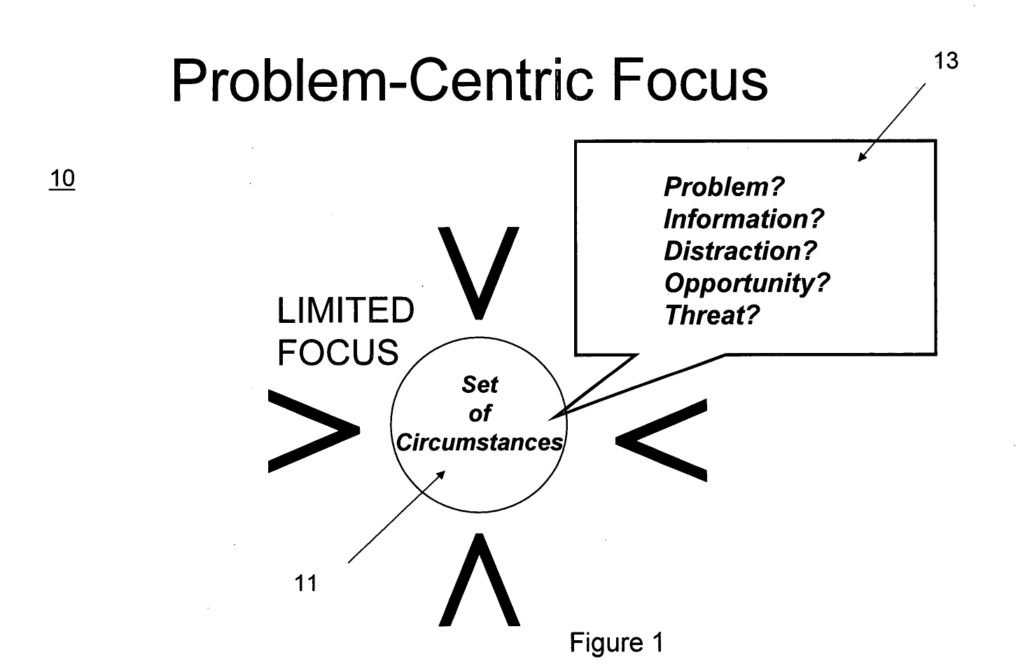

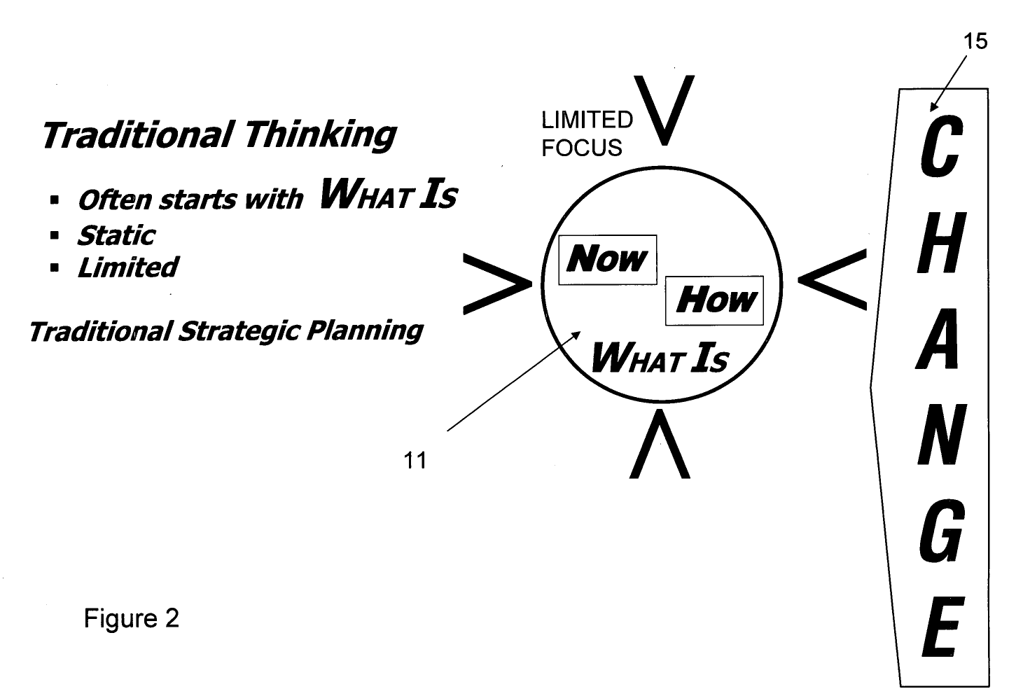

Where common elements are used between drawing figures, common reference numerals are applied.

### DETAILED DESCRIPTION OF ILLUSTRATIVE EMBODIMENTS

The invention is a system, methods and apparatus for guiding the creation of desired change in an individual's or group's circumstances or current state and for creating a navigationally styled plan or journey model for making the transition to the newly envisioned set of circumstances, state or added capability. The invention can be applied by any individual or group to many areas, including applications such as career planning, business strategy planning, new product development, branding or marketing campaigns, life planning, educational planning, family planning, community organization development, political planning, and the like. The methods and apparatus of the invention provide a flexible, scalable and dynamic set of tools and methods to be used in creating a new outcome or state for the individual or group to attain, in identifying the various resources and opportunities available, and in planning a navigationally modeled process of steps to be performed to move the individual or group from the current state or status to the new desired state or status. The methods and apparatus of the invention provide a dynamic, forward-looking tool for identifying the desired outcome and developing a plan to achieve this outcome using various methods and tools to develop the values, vision and mission of the individual or group, tools to analyze and collect information about the current state or present set of circumstances of the individual or group, and tools to be used in developing the navigationally styled plan or journey for making the transition to the new set of circumstances, the resulting plan being dynamic and the tools including innovative feedback and monitoring steps to dynamically update the vision and to dynamically update the navigation plan as the process of transition to the new outcome or set of circumstances continues.

Prior to describing the particular methods and systems of the invention, the overall system will be described. Conveniently referred to as the “Creative Guidance System”, to reflect the invention's creative and navigational approach, the invention provides methods and processes, and apparatus, in the form of a kit, for use in applying the methods, which may be used by individuals, groups, businesses or communities in planning and transitioning to a desired, future outcome or set of circumstances. The invention is useful for career development, project planning, educational planning and counseling, business planning, new product development, life and relationship planning, health and fitness planning and may be applied to any or all levels of activities of an individual, business or group.

Prior to beginning the planning process, the methods of the invention first, as a prerequisite step, requires consideration of a new comprehension model or approach to what a planning step is. In prior art planning systems, the individuals or participants using the system are typically focused on “What Is,” that is, the current state or set of circumstances, and then the “How,” that is, a specific set of steps to address a problem, resolve a crisis, or react to a change. The prior art approaches to planning therefore tend to limit the concepts applied to the planning or problem solution, because the focus is on the past and particularly the present, which looks at current resources and capabilities only, and is therefore self-limiting. Plans developed by such tools tend to create only obvious and conventional outcomes, as they rely on past or present experiences of the individual or organization.

In contrast, the planning process of the methods of the invention begins with a first step of considering the act of planning as a creation step. Participants, by describing a desired outcome or future set of circumstances, are in fact creating a desired future, which, if the plan is successfully executed, will happen at some point in time. The method of the invention provides a phrase which describes this creative approach to the planning step as “What Can Be?” In determining “What Can Be?” the participants are directed to consider a future and to describe the future circumstances in terms of a desired set of circumstances, focusing on the attributes and experience of that future as if it were already present, and they are not to limit their planning or goal with their knowledge of the present or by considering resources as scarce or unavailable. (The present state and the plan for making a transition to the future will be addressed as described below, but importantly, the methods of the invention begin by determining the desired outcome first, as will be further described.)

The novel approach to planning of the invention transforms the planning process. Because the act of creation is basically an unlimited resource, it leads to unconventional or unexpected possibilities, and entirely new potentials, in the planning process. The focus of this new planning method is on abundance, not scarcity—on growth, not limitations. Future circumstances may be created as a attainable goal—even when the goals are not within the past or present experience of the individual or group or business, and, advantageously, the methods of the invention will develop a plan and strategy for attaining these future goals, even when the experience or current state of the individual, business or group does not presently include the capabilities or resources needed to attain them.

The various processes and methods of the invention will now be generally described. Specific applications and examples will follow, however these are provided as illustrative examples only and do not limit the invention. The invention involves specific sets of steps that may be used at one time or over a period of time, by different individuals or groups within an organization, or by a same group or by a single individual. The methods may typically be performed in the order described, but some steps may be performed in other orders, or steps may overlap, as appropriate to the planning situation, and the invention is not to be limited by the order of the description.

The system and methods of the invention approach planning as a creative process, rather than as a reactive or responsive process. In contrast to traditional strategic planning processes, with the Creative Guidance System, an individual or group begins the planning process by first considering “What Can Be?” without regard, initially, to how that outcome would be achieved, the “How,” or to what the current set of circumstances, “What Is,” might presently be. For purposes of this description, the terms “creative” and “create” will refer to the process of defining a future outcome in terms of “What Can Be.” The initial focus of the methods of the invention is to plan a future outcome by using a creative or creative thinking model, and to first identify the desired future set of circumstances, or future capability, by creating it, through the use of the invention's processes and tools, to develop what the desired future is.

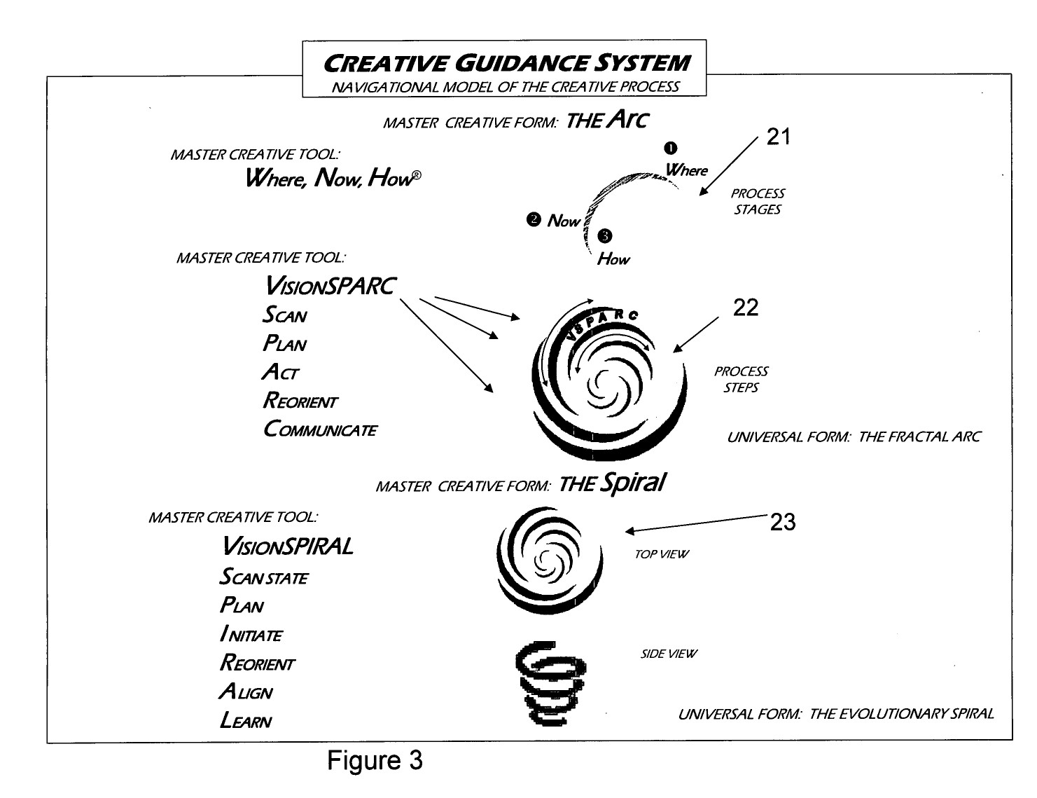

As planning tools and conceptual forms for the time and steps needed to transition from a current state or set of circumstances to a desired future state or set of circumstances, the methods of the invention use two basic conceptual and symbolic forms: an arc and a spiral. The arc represents a navigable path or journey, and conceptually moving along each arc represents the time period needed to execute the steps to complete the planned transition. The arc is a fractal, or repeating or replicating, form, and so may be aligned with other similar arcs to create multi-level plans, and, for example as will be further described, arcs may be combined to form a two-dimensional, or three-dimensional, spiral form. FIG. 3 depicts the planning forms of the invention. In FIG. 3, the creative tools of the invention used in the planning methods are depicted, element 21 is the creative arc form, element 23 is the two-dimensional spiral referred to as the VisionSPARC form, which is comprised of fractal arcs in an expanding, replicating combination, and element 23 is the VisionSPIRAL which is also comprised of combined fractal arc forms. These tools are part of the invention, and will be described in more detail below; for convenience they are referred to as the “master creative tools” of the invention. Each form is a visual representation of a process which involves a series of process steps, or methods, to define a desired outcome or changed circumstance, to identify and evaluate the present circumstances, capabilities, resources and limitations, and to develop and produce a plan for making the transition to the desired changed circumstance.

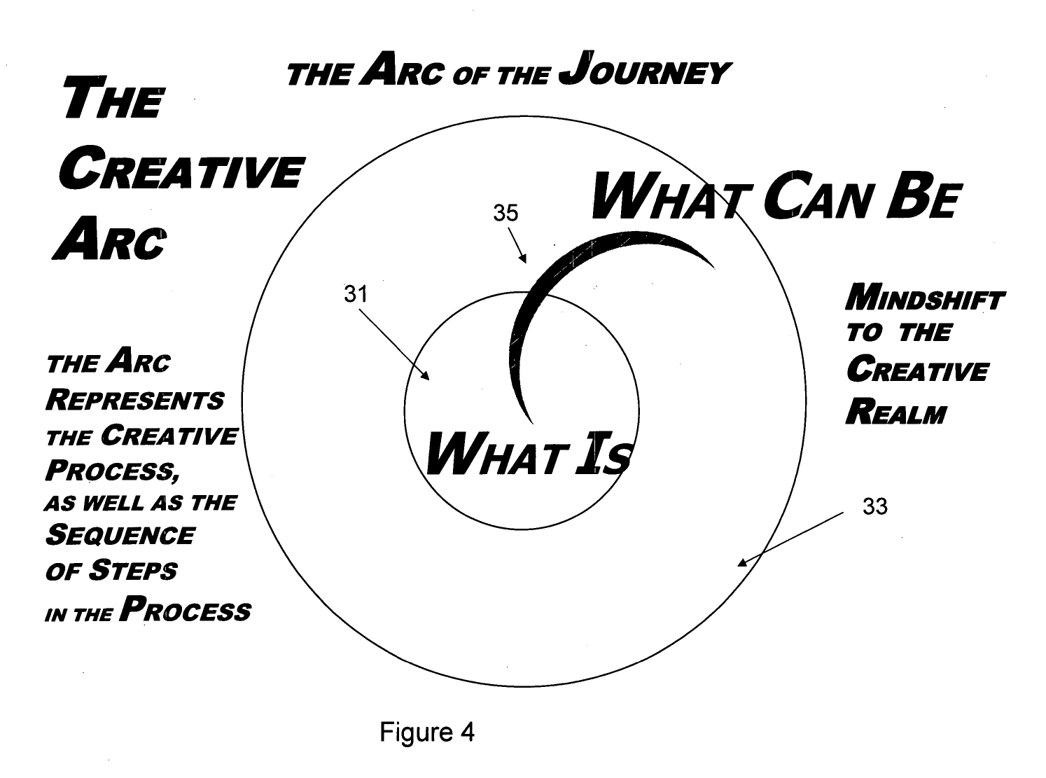

FIG. 4 depicts a visual aid useful with the methods of the invention that provides an illustration of how the creative arc tool or model of the invention is used. In FIG. 4, sphere 31 represents the current set of circumstances, that is, “What Is,” or what already exists. Sphere 33, the outer sphere, depicts the future set of circumstances, that is, “What Can Be.” Arc 35 depicts a powerful navigational style planning concept of the invention, the tool or method which represents the master creative process by which an individual or group may shift—both its individual or collective thinking, and, by envisioning and executing a plan based on the creative process steps represented by the arc, its individual or collective circumstances or reality—into a new desired state of being. The symbol of the Arc 35, then, represents both the planning journey—and the set of recurring creative process steps—the group or individual will envision and execute in order to successfully transition from the current set of circumstances 31 or capabilities to the desired future set of circumstances 33. This model of planning encourages the individuals to start planning by first clearly envisioning the future set of desired circumstances, and then creating a navigational plan generated through the steps of the Creative Guidance System, which may be depicted as a navigational arc, or, over time, a spiral model comprised of a series of fractal arcs, in which the resulting navigational plan details the scheduling and executing of specific action steps required to make the transition from the current set of circumstances (the present) to the planned future circumstances or desired reality.

Hence, the term “Creative Guidance System” may be used, as this name appropriately describes a set of interrelated elements that comprise a comprehensive planning system, involving creative planning to define a desired future set of circumstances, and then creating a navigational plan to guide an individual's or group's progress toward achieving the future set of desired circumstances.

The individual or group may be instructed to consider this novel approach to planning as a mental journey or a “Mindshift” to a “Creative Realm,” an allegory that invokes and reinforces the unique approach of the invention, which, unlike traditional, reactionary and present-focused planning or critical action teams, the system and methods of the invention focus on a set of creative processes applied to the future desired outcome—a “Mindshift” using an innovative creative thinking method or technology—and this therefore differentiates this new approach to planning from the prior art methods. This phrase is depicted on the illustration of FIG. 4, which may be used by a facilitator or as part of computer based training to explain the concepts of the invention. In addition, the concepts and tools depicted in FIG. 4 may be expressed as in the form of a software program, as an on-line course an individual may experience as a screen shot or interactive learning program, or as a set of simple printed materials or a kit, to explain the terms, concepts and tools or technologies that comprise the invention. These are examples only and do not limit the scope of the invention.

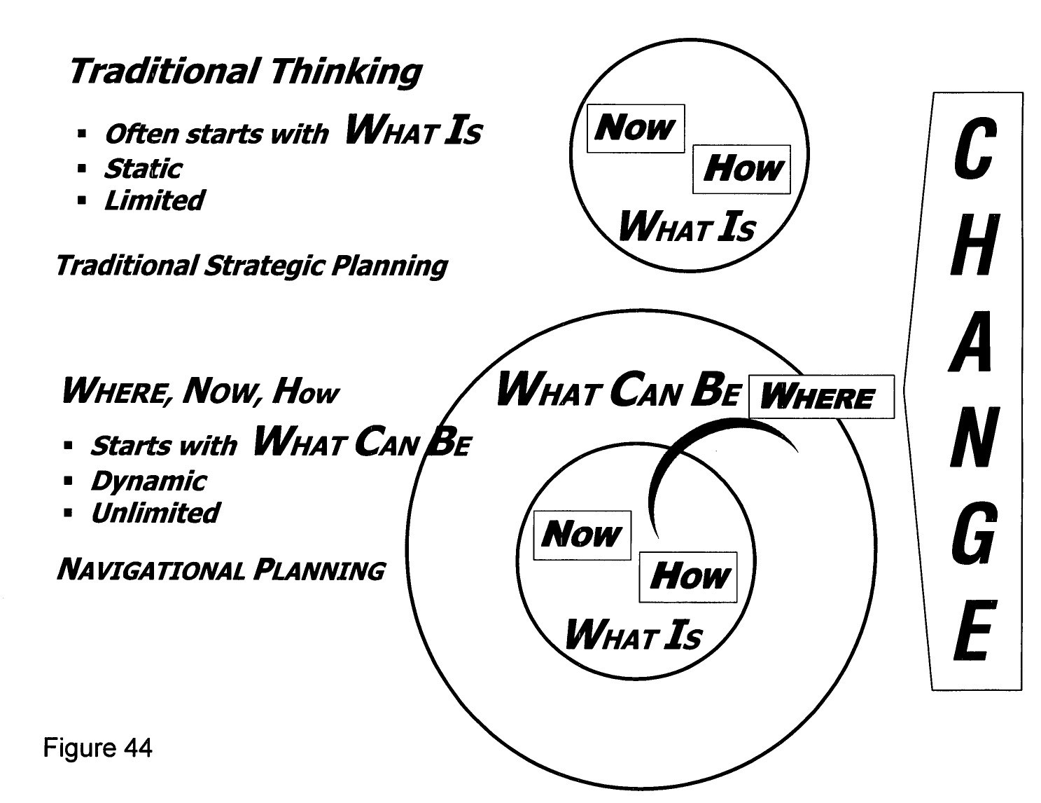

FIG. 44 depicts the contrast between the planning processes of the prior art and the dynamic, adaptable planning methods of the invention. In FIG. 44, sphere 11 again represents a present set of circumstances. Traditional planning approaches as described above involve static planning tools and limited strategic thinking about immediate problem solving. Sphere 31 represents the present set of circumstances (“Now”) in a planning process using the methods and tools of the invention. Sphere 33 represents a future set of circumstances (“What Can Be”) in a future set of circumstances, and arc 35 represents, visually, a dynamically adaptable, executable plan which is represented as a navigable arc and provides the means for transitioning from the present set of circumstances to the future set of circumstances (“How”) using the methods of the invention as are described further below.

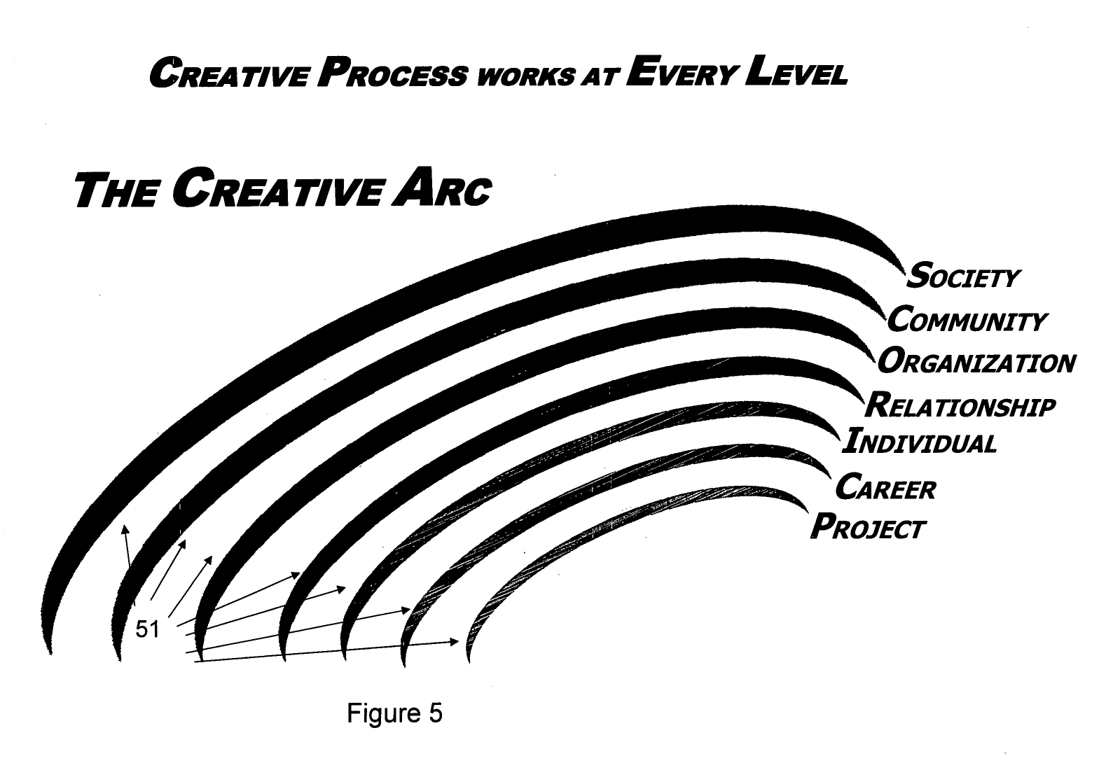

The creative arc model of the method of the invention is a replicable, scalable concept, representing a set of repeating creative steps, and thus may be applied to many different aspects of an individual's, or group's, activities. FIG. 5 depicts an illustration of a variety of activities, or levels, which may each be modeled or comprehended as independent creative arcs 51. For example, the arc concept of the methods of the invention may be applied to a project, career planning, individual development of any kind, relationship development, organization planning, community planning and on a broader scale, even societal planning or development. The use of the methods and concepts of the invention is not limited to any particular level or activity and arcs may be defined for any or all of these levels. If the various arcs are depicted in alignment, as in FIG. 5, that situation represents a state where, through the use of this innovative planning system, integration or synergy (where the combined action of one or more activities, strategies, plans or subplans is greater than the sum of their effects individually) is achieved, in which the different aspects of the activities of the individual or group represented by the arcs 51 are cooperative and reinforcing of one another, as contrasted with a situation where they are separate from, or even in competition or conflict with one another.

The creative arc model of the invention is a fractal form, a geometric shape that can be repeatedly subdivided into parts, each of which is a smaller copy of the whole. As described above with respect to FIG. 4, the symbol of the Arc 35 represents both the planning journey and the set of recurring creative process steps the group or individual will envision and execute in order to successfully transition from the current set of circumstances 31 or capabilities to the desired future set of circumstances 33. The same arc tool, and the set of creative process steps it represents, is applicable at all levels of planning, and for individuals and groups alike. The methods and system of the invention provide that any creative arc may be combined with other fractal arc forms to create an expanding and evolving possible set of future circumstances or outcomes.

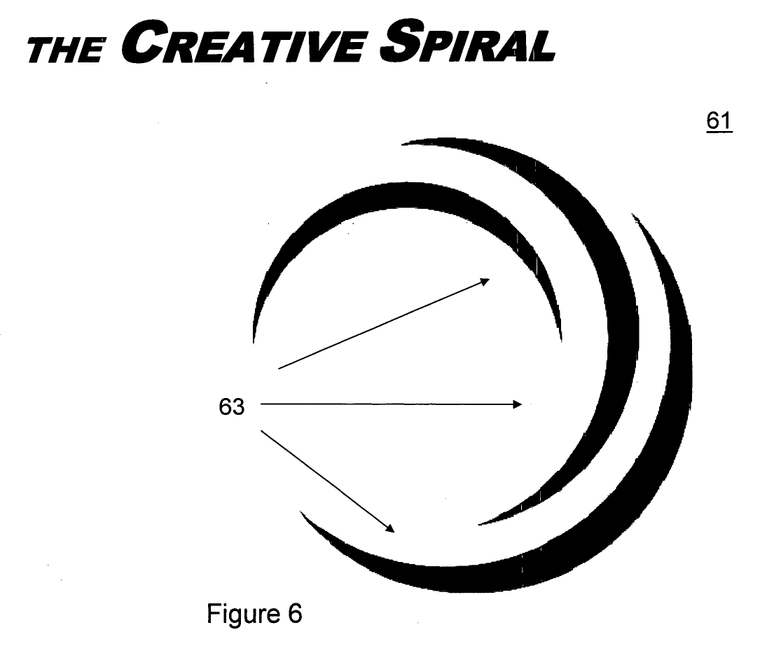

FIG. 6 depicts another concept of the invention, the creative spiral 61, which is depicted as a form comprised of a combination of creative arcs 63, 64 and 66. A transition from the small arc 63 to the middle arc 64 and on to the largest arc 66 depicts the transitions made from a first set of circumstances that evolve along the arc (at the left side of the page) to an enlarged set of circumstances for each expanding arc (moving toward at the right side of the page). The illustration depicts how the transition process may be described as a series of navigational journeys, or planning periods, represented by these creative arcs, which are in themselves tools which comprise a set of specific, recurring planning steps or stages.

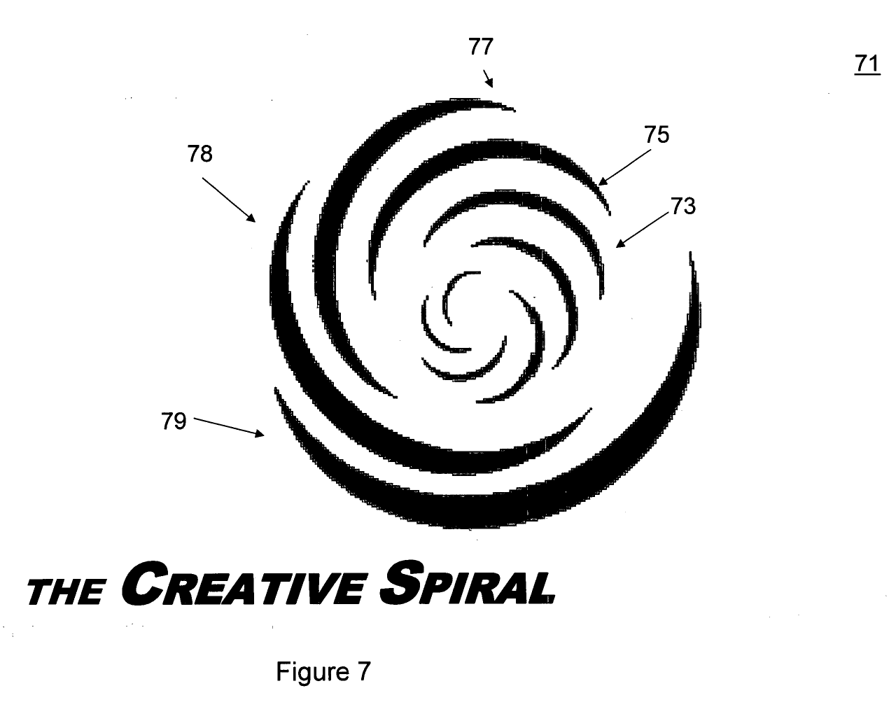

Another view of the creative spiral of the invention, a two-dimensional view, is depicted in FIG. 7. Creative arcs 73, 75, 77, 79 and 78 are fractal forms used together to define spiral 71, which begins with a smaller arc 73 and builds with larger and larger arcs that represent the expanded set of potential desired circumstances an individual or group may attain over time. A transition from the beginning of the first arc 73 to the end of the last arc 78 can be seen as a journey along the series of arcs, each one resulting in an expanded set of circumstances or capabilities experienced by the individual or group. The powerful fractal form of the arc lends itself to being used as a visual representation in a combination with other arcs, so that the methods of the invention are scalable planning tools, which may be added to and built upon to define additional future plans on an ongoing basis; thus the invention provides a scalable system and methods for planning and tools for developing a process or schedule for reaching the planned future set of circumstances.

The basic planning tools of the system of the invention are the creative arc, and the creative spiral, as visually representative tools for planning a transition to a desired future outcome. A series of methods have been developed to use these tools to create and implement a dynamic and adaptable, scalable plan for making the transition to the future outcome. These will now be described in detail.

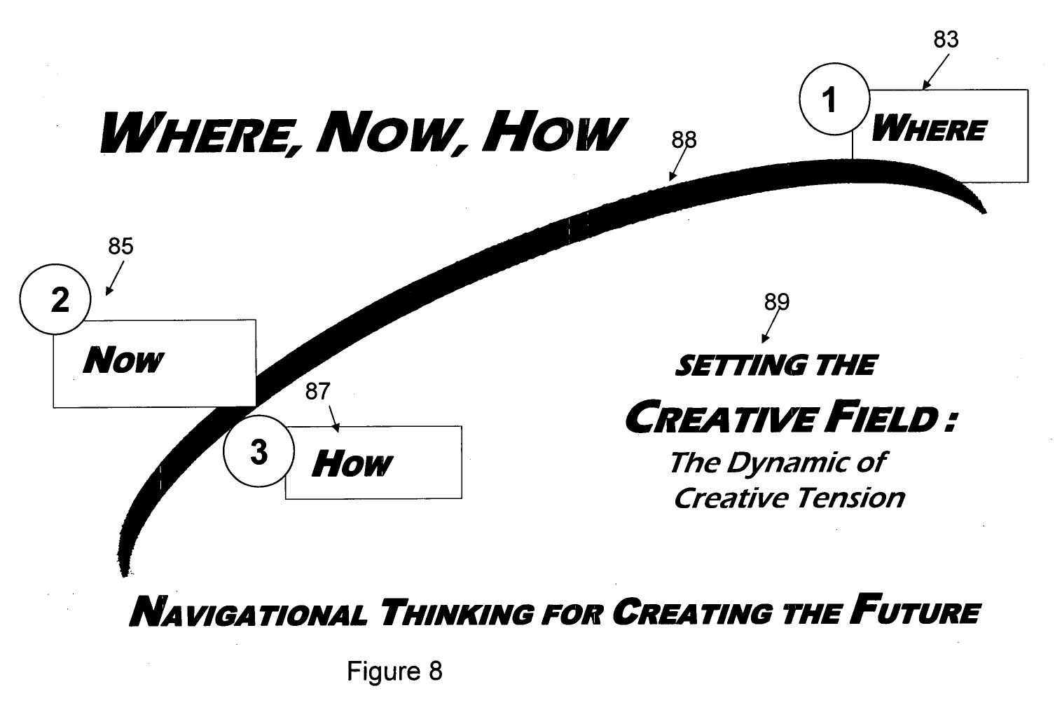

The first set of method steps of one method of the invention involves three definite process steps which may be collectively described as “Where, Now, How.” The method step uses a creative arc as the framework for creating a navigable journey as a conceptual planning tool. FIG. 8 depicts the 3 steps of the “Where, Now, How” method of the invention and the creative arc which defines the navigable journey to be taken as the concept for the plan. In FIG. 8, box 83 depicts the “Where” step. Box 85 depicts the “Now” step, and box 87 depicts the “How” step, each illustrates a method which has additional method steps to be described below. The creative arc 88 depicts the planned journey which will enable the group or individual to move from the current set of circumstances, the “Now,” to the desired future set of circumstances, the “Where.” It should be understood that the descriptive labels “Where,” “Now” and “How” are for convenience and more generally the method of this embodiment of the invention involves the process of defining a desired future outcome which is a process involving several steps to be described, determining the current set of circumstances and defining a planned set of steps to transition from the current situation to the future outcome using as a planning concept a navigable creative arc to plan the scheduled steps. Preferably the order of the steps of the method is to first define the desired future outcome, then to determine the present state of circumstances, and finally to develop the creative arc or plan for transitioning to the future set of circumstances.

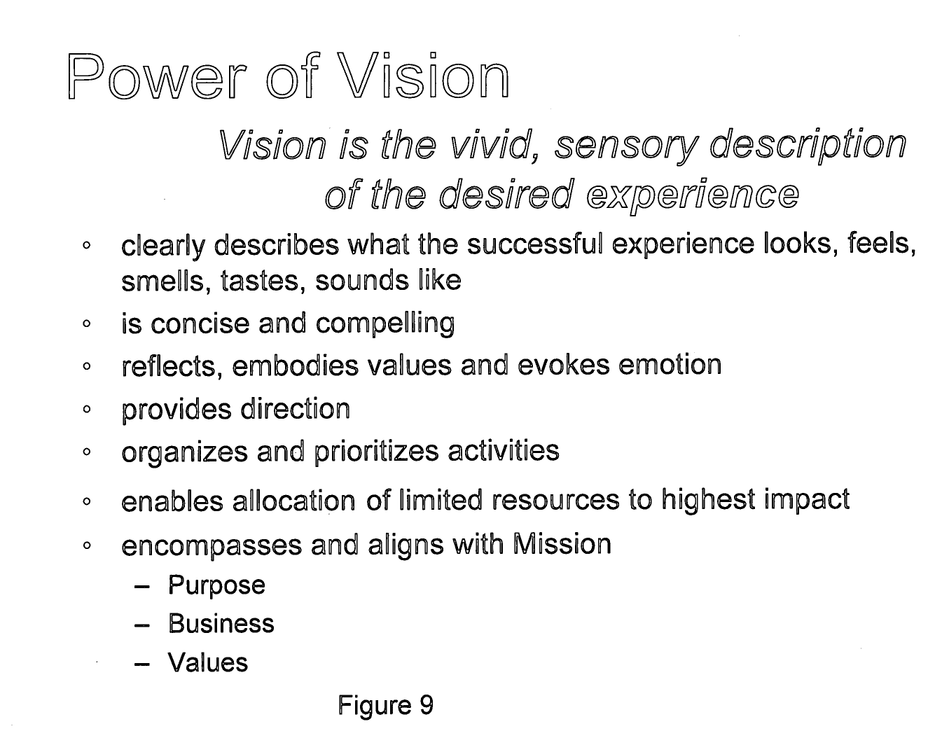

The first step of the three step method depicted in FIG. 8 is the “Where” step. In the “Where” step, the group or individual is to create a description, a “Vision,” and define the future set of circumstances to be attained. This step involves the creative thinking of the methods of the invention in that the focus is “What Can Be,” and the individual or group will create a future. The “Where” step begins with a method of defining the future set of circumstances using a “Vision” process. The Vision step involves describing, in a sensory way, what the future set of circumstances is like as an experience. FIG. 9 illustrates a chart or handout or graphic screen shot that might be used in a facilitated training session or as part of a software package to lead an individual or group through the Vision step. The individual or group is to describe the desired future set of desired circumstances as a Vision using sensory descriptions, for example what it looks like, feels like, smells like, tastes like, sounds like in a concise and compelling description. The advantage of the method step of producing the Vision description of the future circumstances is that will provide direction and organize and prioritize activities during the transition journey, as activities not directed toward achieving the Vision are given a lower priority, for example.

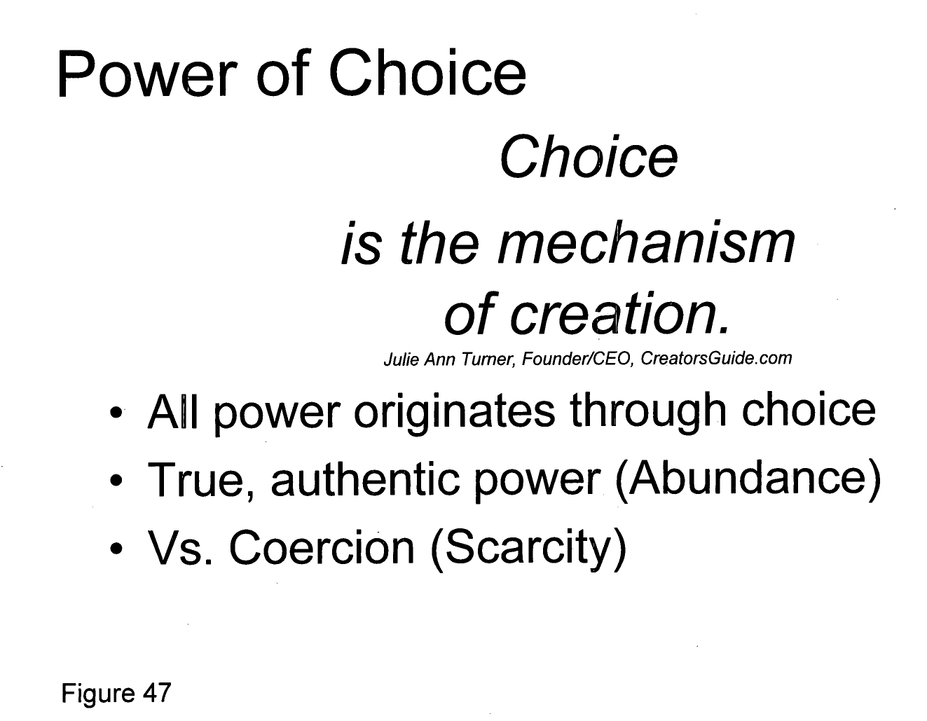

An important conceptual tool to be used in creating the Vision at this step in the “Where” process is to communicate the concept of Choice. FIG. 47 describes the power of the concept of choice as a mechanism for creation. The power of choosing to create a desired future—rather than simply reacting to existing circumstances, an approach which tends to manage limited resources to deal with crises or day-to-day distractions—is that proactive choice can create abundance, i.e., creating more pie, rather than further subdividing an already limited pie. So Choice is a concept that is discussed with the participants as a tool of creating abundance, and in defining the future by describing and developing the Vision they are making a choice, instead of reacting to events that happen around or to them.

Because the Vision step is actually the outcome of a dialogue among the participants in the planning process, methods for conducting an enhanced dialogue may be beneficially incorporated into this step, as well as in other steps of the present invention. U.S. Patent Application No. 60/______, filed Jun. 21, 2004, entitled “A Method and Apparatus for Enhancing Influence,” referred to above describes various methods for conducting dialogue sessions with groups of individuals to develop enhanced dialogue. A group may use the methods of this co-pending patent application to conduct a dialogue event to develop their Vision. Other steps in this invention may also require or benefit from the enhanced dialogue methods of this application. Groups may organize an event such as is provided in the methods of the co-pending patent application to develop their group or business vision, or mission statements, etc. as are described herein. For convenience, this method is referred to as the “Orbits of Influence” method.

In the Vision step, whether the Orbits of Influence methods are used or whether other methods described, or not described, in the invention are used, the individual or group creates the Vision and answers the question “What do we want to create?” The Vision is preferably created and shared by all members of an organization, so that it holds meaning and attraction for all involved in the mission. This “shared vision,” then, is a compelling description of what the members agree expresses the essence of what they desire the project, situation, organization, or other subject of planning, to be. In this way, the Vision becomes, at least in part, the shared identity of the organization. In the Vision method step, the Vision is always stated in the present tense, to indicate that this image of success for the organization reflects what the members collectively aspire to become, and that they will achieve the Vision by performing in the way they would if the vision were already achieved.

A second stage of the “Where” method, which is also performed, is the Mission. FIG. 9 also lists the three steps of the Mission process, labeled “Purpose, Business, Values.” During the Mission step, the group or individuals further identify certain attributes or properties of the desired future circumstance or state, which may include attributes or properties currently possessed by the individual or group, or it may describe attributes or properties the individual or group wishes to attain. That is, some of the described properties may already be in the current set of circumstances; more likely the properties will be those that the individual or group wants the future set of circumstances to include, but the invention encompasses any of these possibilities.

Mission is a more focused concept than Vision. Mission, or a mission statement, contains three major concepts: the purpose, the business an organization engages in to achieve this purpose, and a statement of values guiding the accomplishment of the mission:

Purpose Our reason for being. Why the organization exists, and what it seeks to accomplish.

Business What we do. The main method or activity through which the organization fulfills this purpose.

Values What we care about and share. The principles or beliefs that guide an organization's members as they pursue the organization's purpose.

The Mission statement summarizes the what, how, and why of an organization's work. A mission statement is like an introductory paragraph—it assists in communicating where the plan is progressing and clarifies to the audience that the organization knows where it is going. A mission statement must communicate the essence of an individual or organization to the audience. An organization's ability to articulate its mission indicates its focus and purposefulness. The ability of an individual to articulate a mission also indicates focus and purposefulness.

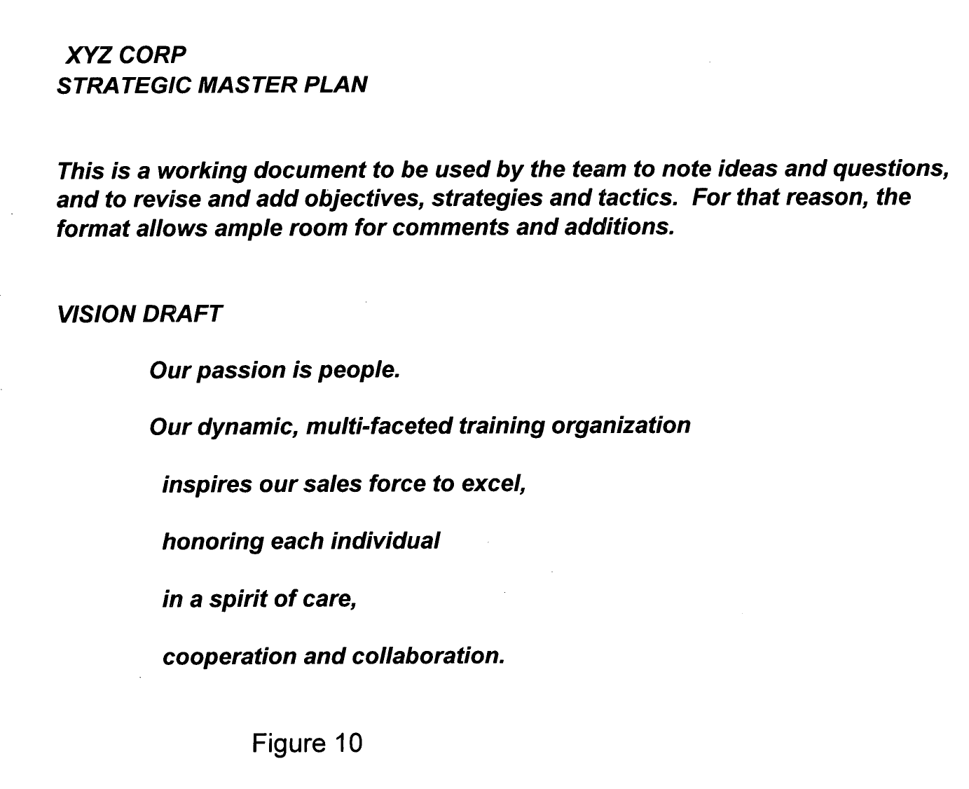

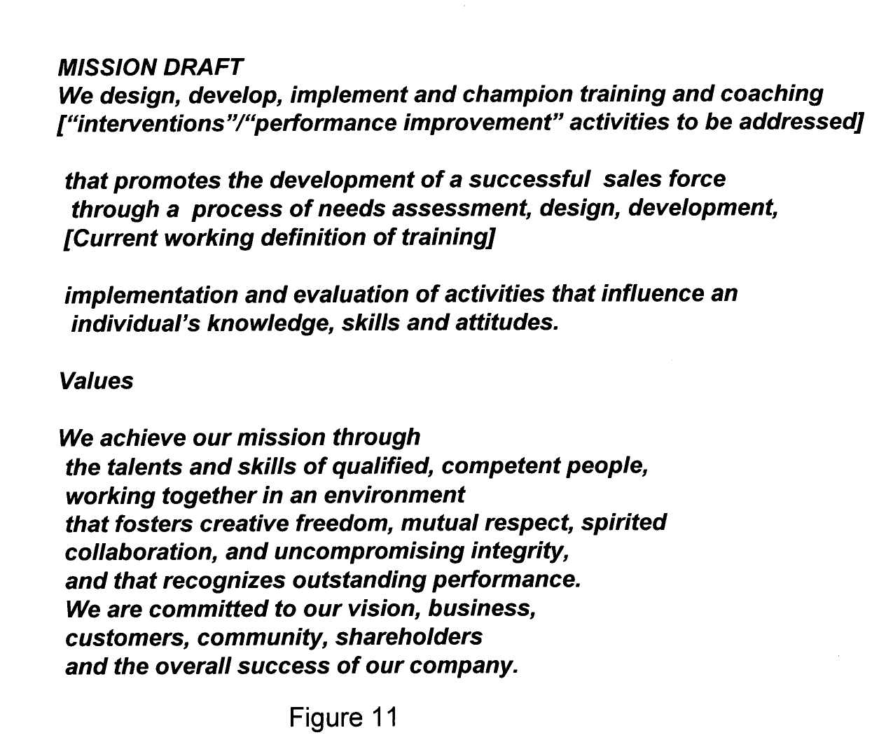

FIG. 10 depicts a sample Vision an organization may develop using the “Where” method. Similarly, FIG. 11 depicts a sample Mission statement, in working draft form, such as an organization may develop using the “Where” method.

Once the steps of the “Where” method are completed, the first step in the current method of the invention, preferably the group or individual begins the “Now” step of the “Where, Now, How” process. Significantly, when an individual or group first defines a vivid, compelling Vision, the “Where” or “What Can Be,” which they desire to attain and which holds great attraction, and then the individual or group turns the focus to defining the state which currently exists, the “Now” or “What Is,” the imbalance between the desired outcome or Vision and the current state or “Now” establishes a positive tension in the direction of the desired Vision, called here “Creative Tension” depicted in FIG. 8, element 89, which also establishes a field of potential creative action, the “Creative Field, between the current situation and the desired outcome, within which the individual or group may take creative action in the direction of their desired Vision to reduce the Creative Tension. Thus the imbalance between the current set of circumstances and the Vision or desired outcome creates a tension in the participants or organization that encourages movement towards the Vision.

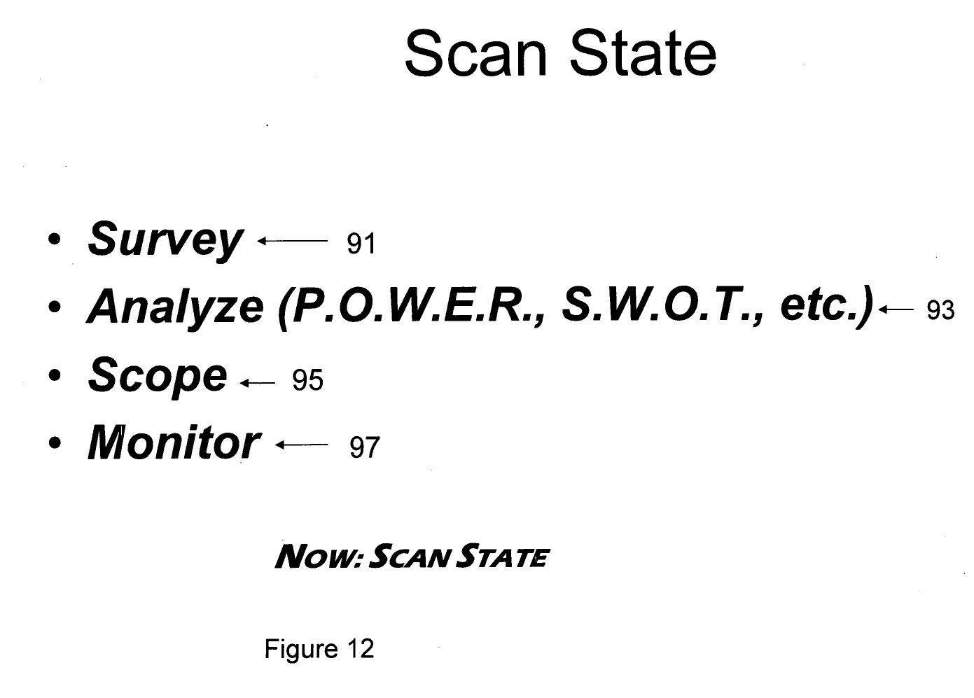

FIG. 12 depicts the method steps of the “Now” process, sometimes referred to as the “Scan” state. Because every individual or group always has a current set of circumstances or state at a given point in time, the “Now” stage is ongoing, once the process of actually implementing the plan by journeying along the creative arc (that is, by taking the steps needed to execute the plan) begins, so the “Now” stage should be continuously performed (by scanning) and the plan should be updated during the planning and execution phases in response to any changes in the desired direction, or, unexpected changes in the environment, newly identified opportunities, etc. In the “Now” step, the individual or group is asked to perform a “Scan,” that is to collect information about the current set of circumstances, and to perform the Scan by performing several steps described as “Survey,” “Analyze,” “Scope” and “Monitor.” The term “Scan” is used to remind the user of the inventive method that the “Now” steps, while initially performed at a given point in time, are in fact to be part of the ongoing process and should be routinely performed as the plan is implemented and executed, and changes in the circumstances need to be fed into the planning and execution process, which is therefore dynamic and constantly ongoing.

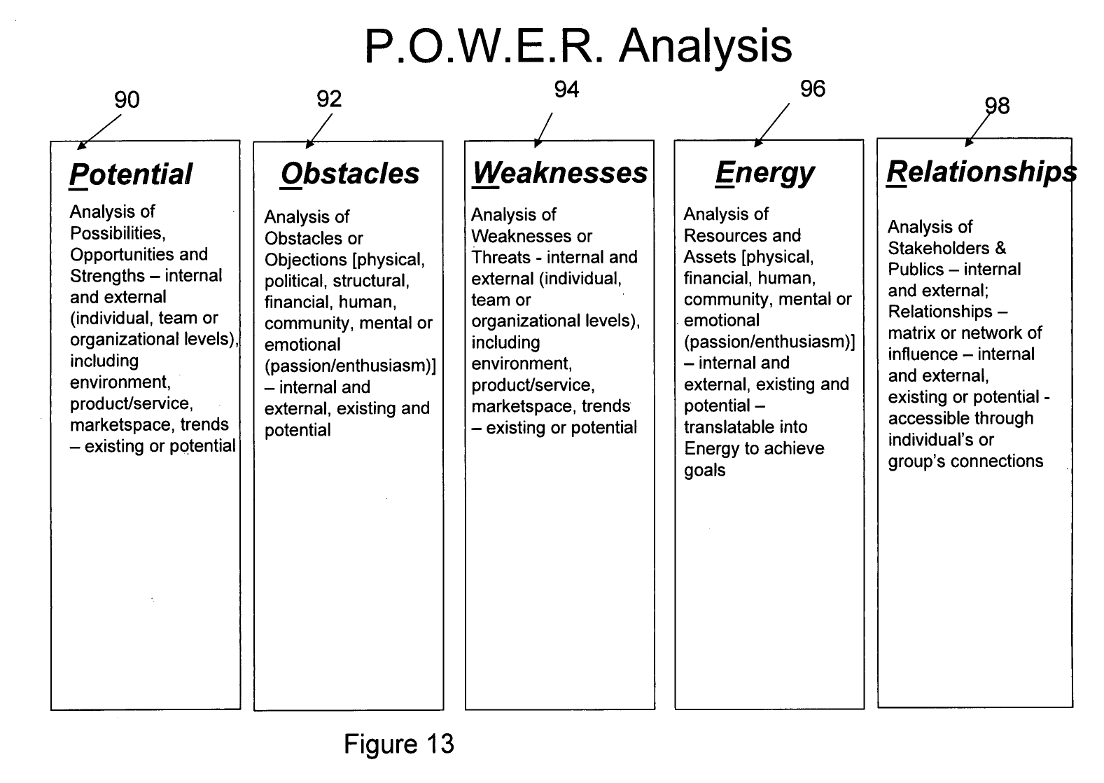

In the “Survey” step 91, the current set of circumstances is evaluated. This may be done by taking metrics, surveying stakeholders in the process including management, the participants, internal and external customers, and the marketplace itself, investors and shareholders, all of these people are potential stakeholders. The tools used in the Survey step are varied, and include measuring outputs or results, customer surveys may be used, defects or scrap may be measured, and any number of other known techniques may be used to determine the current set of circumstances for a particular activity or organization. An “Analyze” step 93 is performed (note again that the order of the steps within the Scan process described here is preferred, but not limiting, and therefore does not limit the invention) to determine more information about the current set of circumstances, preferably the analyze state uses the information acquired by the survey step, but it is not necessary. An example of an “Analyze” step is the use of a worksheet or survey to determine the P.O.W.E.R. Matrix (Potential, Obstacles, Weaknesses, Energy and Relationships; model developed as part of Creative Guidance System), described in FIG. 13, or more traditional analysis tools such as the S.W.O.T. matrix (strengths, weaknesses, opportunity, threats) for the individual or group, or to analyze potential obstacles, either internal or external, which may delay or prevent the individual or group from executing the plan's steps or attaining the desired Vision. Creative analysis methods, such as “Six Thinking Hats” by DeBono, and other analysis methods may also be used during the “Analyze” step. These analysis methods are examples only—others may be used during the Scan state stage—without limiting the invention.

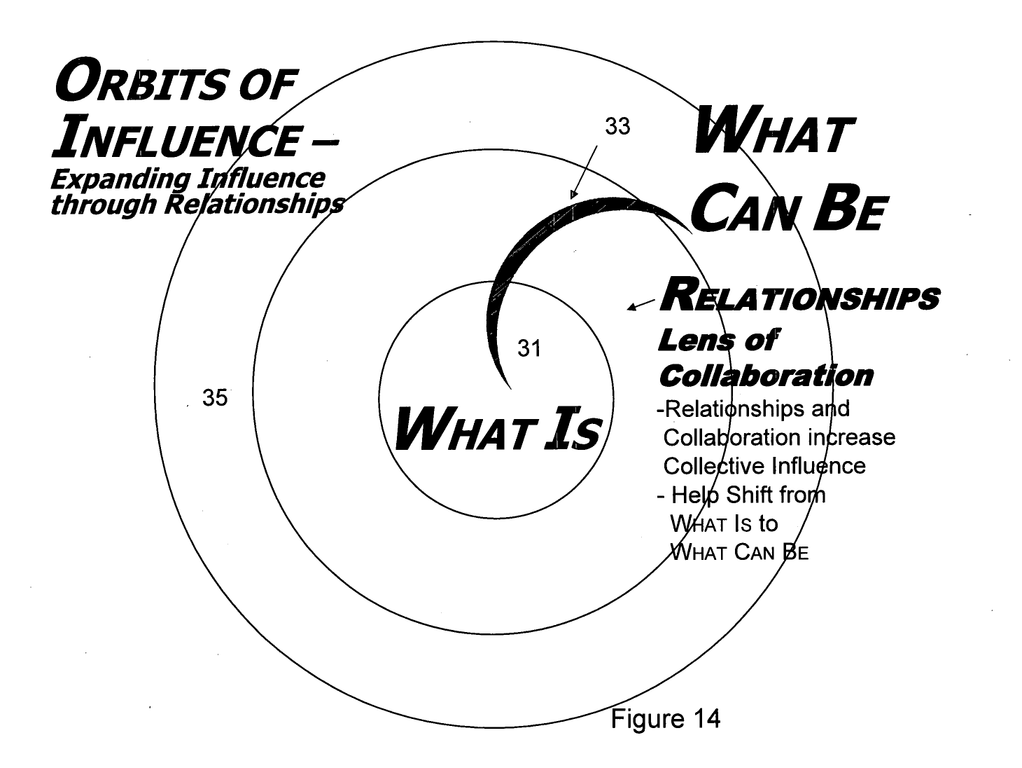

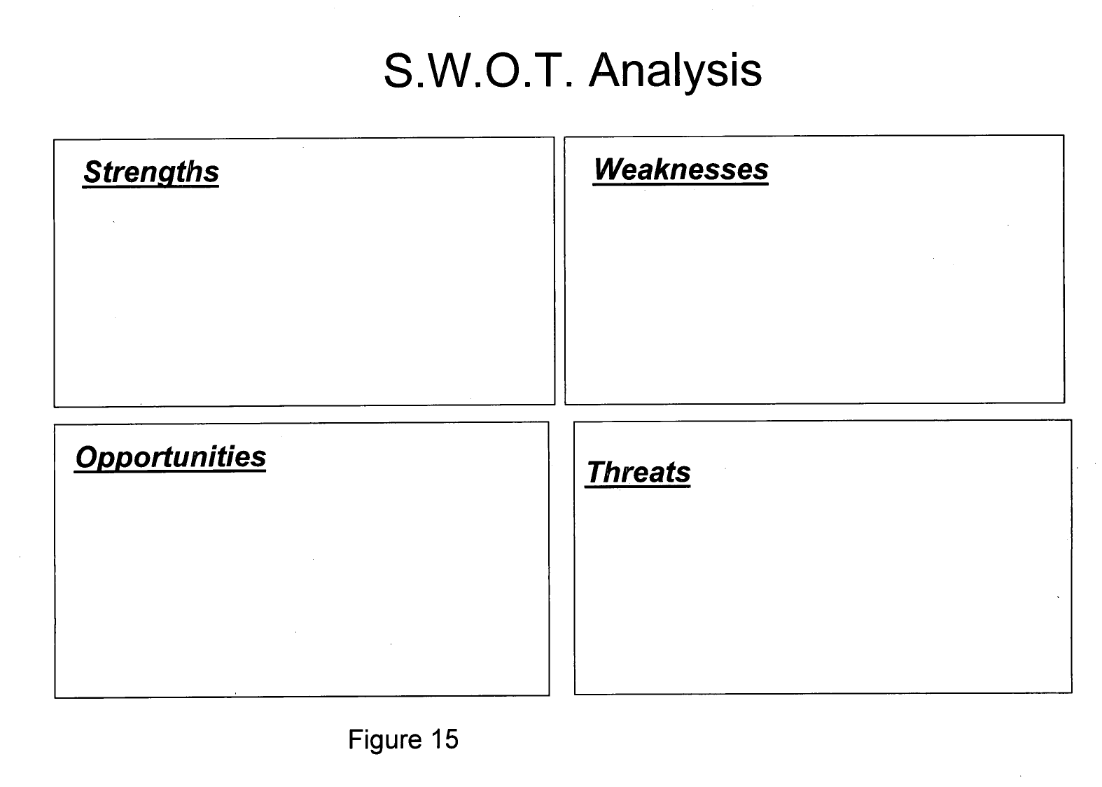

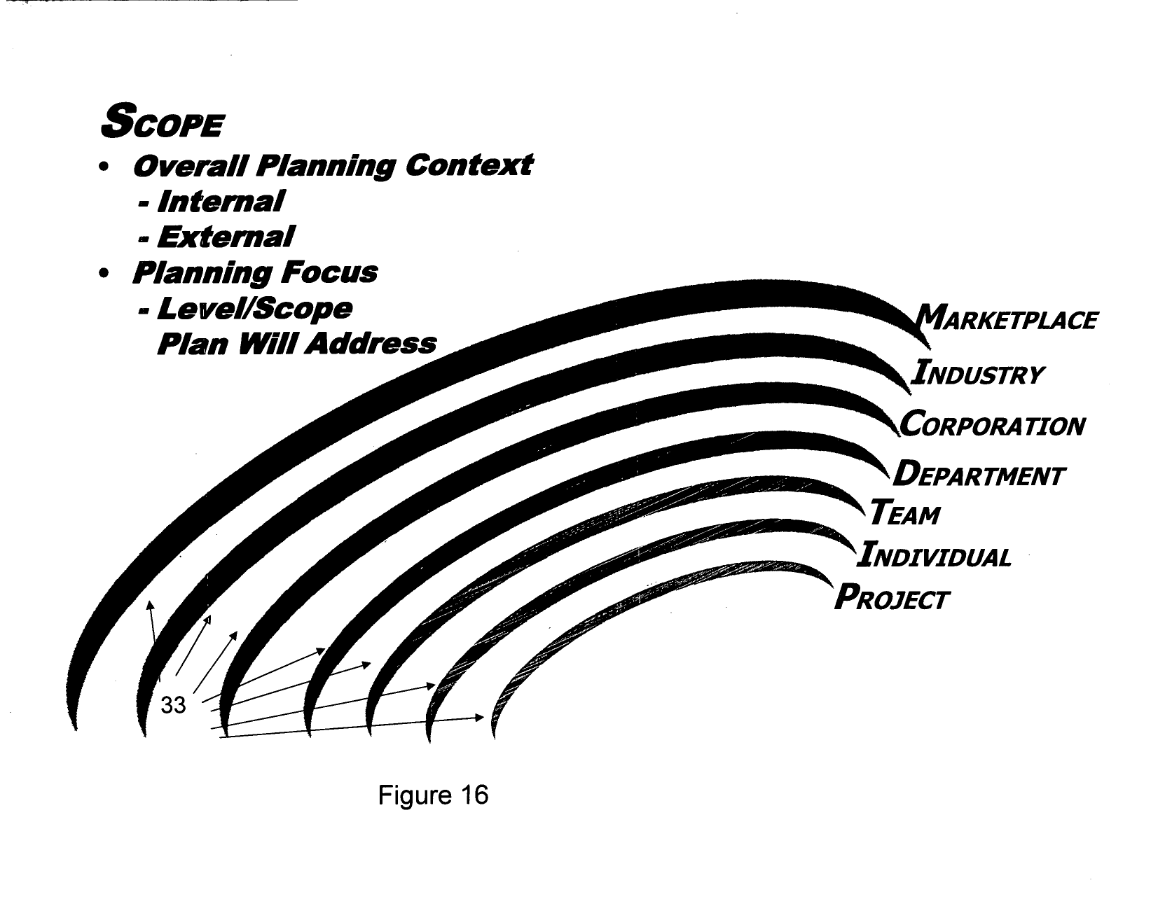

FIG. 13 depicts a worksheet that might be used by an individual or group to perform the “Analyze” step using the P.O.W.E.R. Matrix as one example of an analysis that might be performed. FIG. 14 depicts a visual representation of how an individual or group might analyze the Relationships portion of the P.O.W.E.R. Matrix, by considering not only current “What Is” relationships, but also potential collaborative relationships that could be pursued in order to provide access to additional resources, information and influence that would assist the individual or group in attaining the desired planning Vision, or “What Can Be.” The previously mentioned “Orbits of Influence” methods may be useful in identifying and creating connections and dialogue to facilitate the establishment or expansion of these potential relationships. FIG. 15 depicts a worksheet that might be used by an individual or group to perform the “Analyze” step using the S.W.O.T (Strengths, Weaknesses, Opportunities, Threats) matrix as another example of an analysis that might be performed. Returning to FIG. 12, the “Scope” step 95 is then performed; in this step the individual or group determines the entire scope of activities or capabilities that the current set of circumstances includes. “Scope” refers not only to the overall context for the planning initiative, including a scan of both the internal and external context (FIG. 16), but also refers to a scan of, and a conscious decision about, the scope that the planning initiative should encompass. Often, as an individual or group begins the Scan stage, and moves through “Analysis,” the individual or group will discover issues at many levels or “Planes of Thought” within the person's life or the organization's environment (FIG. 16). FIG. 16 depicts different levels of issues or “Planes of Thought” (FIG. 16) a corporation might identify for potential focus within a specific planning initiative; these are example levels only, and do not limit the invention. [“Planes of Thought,” another concept within the Creative Guidance System, is a useful tool to assist individuals and groups in clearly identifying and agreeing upon which level(s) (aspects of an individual's life, such as Health, Relationships, Career, etc., as in FIG. 5, or aspects of an organizational context, such as Department, Corporation, Industry, etc.) the planning initiative will address. The “Planes of Thought” concept may also usefully refer to the different planes, levels, or modes of thought and planning discussion—“Where,” “Now,” “How” and their associated steps or elements, such as Vision or Mission—such that participants may be directed and reminded about which specific plane or level the individual or group is currently addressing, so that all participants may be guided to focus on the same level or stage of the process together (e.g., “remember, we are just focusing on the ‘Where,’ or Vision, portion of the plan now, and we will focus on the ‘Now’ and ‘How’ stages later”)] In the “Scope” step, the individual or organization identifies the context for the planning initiative, as well as determines which level(s) upon which the planning initiative will focus. While subsequent planning initiatives may later address additional level(s) of the situation, it is important for the individual or group to clearly identify and agree upon which level(s) the specific planning initiative will focus, i.e., to determine the scope of the specific planning initiative. Because the “Analyze” step often focuses the participants in the process, whether an individual or group, on the details of the operations or circumstances, the inventive method advantageously further includes the “Scope” step 95 of FIG. 12 to look at the entire set of circumstances, context or environment related to the planning situation; the activities of the individual or group and the resources and skills available to the individual or group as an entire package. In addition, the Vision is evaluated against the Scope to make sure that there is alignment between the various aspects of the enterprise, the external environment, including the marketplace, industry and general economic and market forces and trends, and the plan being created.

The final “Monitor” step 97 reinforces the need for ongoing assessment and evaluation of the current set of circumstances as the individual or group moves along the arc towards the “Where” destination, as well as identifying changes to the current set of circumstances and dynamically adjusting the plan in response. Each participant in the process is empowered to be a “Monitor” and everyone involved should ideally apply the scan, survey, analyze, and scope steps to their own work as the plan progresses, as well as the group or entity as a whole (again, actively Scanning as the plan goes from implementation into execution). As the plan is executed by moving along the planning arc or journey, the “Now” information should be periodically updated to reflect the current set of circumstances as time advances, to keep the plan aligned with the changes and opportunities that arise as the plan is implemented.

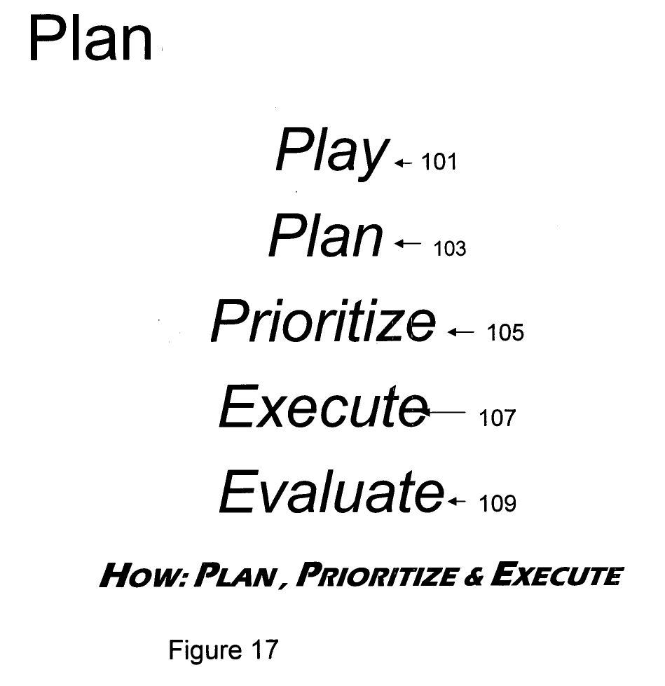

In a preferred embodiment, the last step of the “Where, Now, How” method is next performed, which is the “How” step. FIG. 17 depicts the steps to be performed to complete the “How” method of the current embodiment. Unlike prior art planning tools, the “How” method of the invention is preferably performed only after the desired outcome is created through the Vision process of the “Where” step, and only after the current state or set of circumstances is completely comprehended in the “Now” step. The “How” step, which is used to create and execute the plan for the transition to the desired set of circumstances, or “Where” state, is broken into five smaller steps: play, plan, prioritize, execute and evaluate. The method of the invention further emphasizes the creative nature of the planning process in the “How” step, by beginning the process with a Play step. In the “Play” step 101, the individual or group is encouraged to use play and other creative techniques to facilitation the generation of new approaches to the steps needed to be performed to move to the future set of circumstances. Creative thinking tools such as creativity techniques, games, role-playing, team-building, the Orbits of Influence methods described in the co-pending patent application incorporated by reference above, and the like are used to engage the participants in considering alternative approaches to the issues to be addressed while engaged in the planning process, and to include the resulting creative approaches in the planning process. The “How” step next proceeds to a “Plan” step 103, which is then followed by three additional active steps: prioritize (105), execute (107) and evaluate (109).

In the “Plan” step 103, the creative arc methodology of the invention is further defined with certain steps to be performed, or milestones to be achieved, and a schedule or timeline for each is added to the arc model. In order to realistically plan the steps that need to be performed, the “Prioritize” step evaluates these steps in terms of the Vision created by the individual or group and checks that each step in the plan is aligned with the Vision, that is, the steps in the plan are tested against the Vision to ensure they are necessary and in fact move the current state of the group or individual towards the goal. Further, in the “Prioritize” step 105 the available resources are evaluated and allocated to the highest priority steps first, as each individual or group necessarily has limited time, funds, computers, people, space, consultants, and so on. It is critical to the success of any planning process that this prioritization be performed and be updated regularly as new employees are added, or as resources are used up, and other changes in staffing levels or availability occur, etc., as well as when Monitoring identifies new circumstances, opportunities, market changes, and the like, so that the plan, priorities and associated resources may be appropriately adjusted in real time. Once the plan is initially set out and the priorities are identified, the individual or group begins to “Execute” the plan at step 107. However, the arc or plan is never static or fixed for any length of time, but is dynamic, as updating and revisiting the plan is a key part of the execution process. The steps in the “How” process are ongoing, unlike the planning used in the prior art, and the results of these ongoing processes can change the plan, so that the plan is never “finished,” but is always viewed as a dynamic work in progress.

The “Evaluate” step 109 of the “How” process is performed to ensure that the participants, whether an individual or a group or business, continue to use these processes dynamically as the plan is executed. This ongoing Evaluation step of the invention dynamically generates update to the plan as it is executed, because the “evaluate” step allows the plan to be modified in response to the outcome of the ongoing evaluation. The steps of the “How” process are also to be applied, not only to the overall plan, but to the daily activities of the individuals or smaller groups that are participants in the execution of the plan, so that, at every level, the method of the invention is used to maximize the potential and performance of the individuals and the organization as the plan is executed.

So the basic three-step method of “Where, Now, How” provides a powerful tool for creating a navigational plan, which may be modeled and comprehended as a journey along a creative arc, for transitioning an individual or group or business from a current situation or status to the desired situation or status, which was created as a vision of the future by the individual or members of the group or business. Because the method includes ongoing steps such as the “Monitor” and “Evaluate” steps, and because it allows for updating on an ongoing basis, the plan or arc journey is dynamic and responsive to changes in the environment, the group itself (new hires, retirements, illness, etc., which may change the members of the group), or even changes in the goal or vision which may also occur as the environment or the desires of the individual or group change.

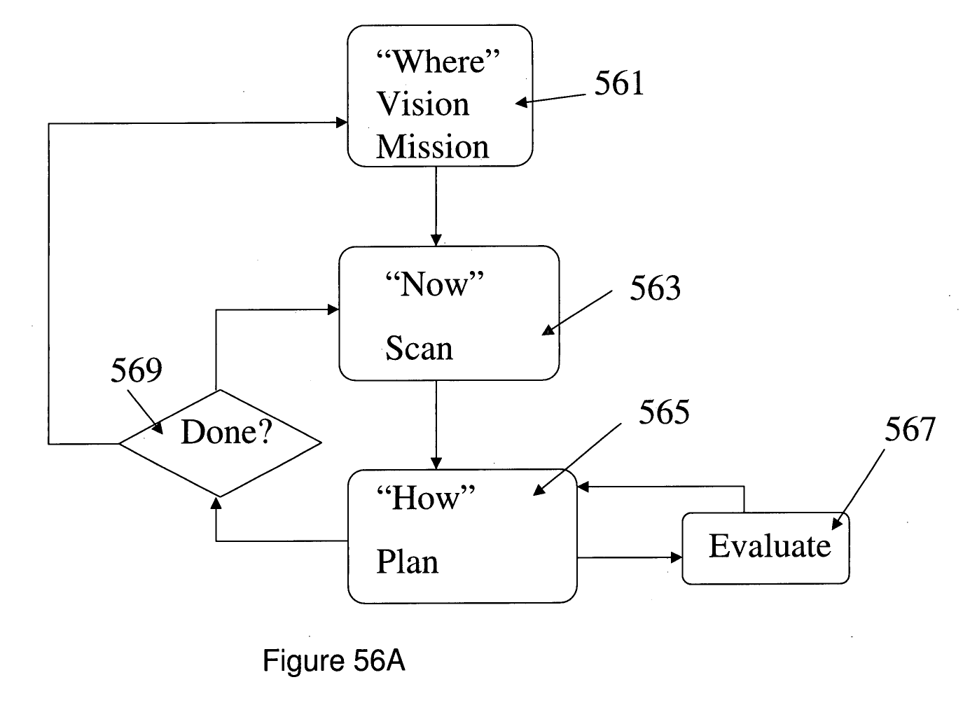

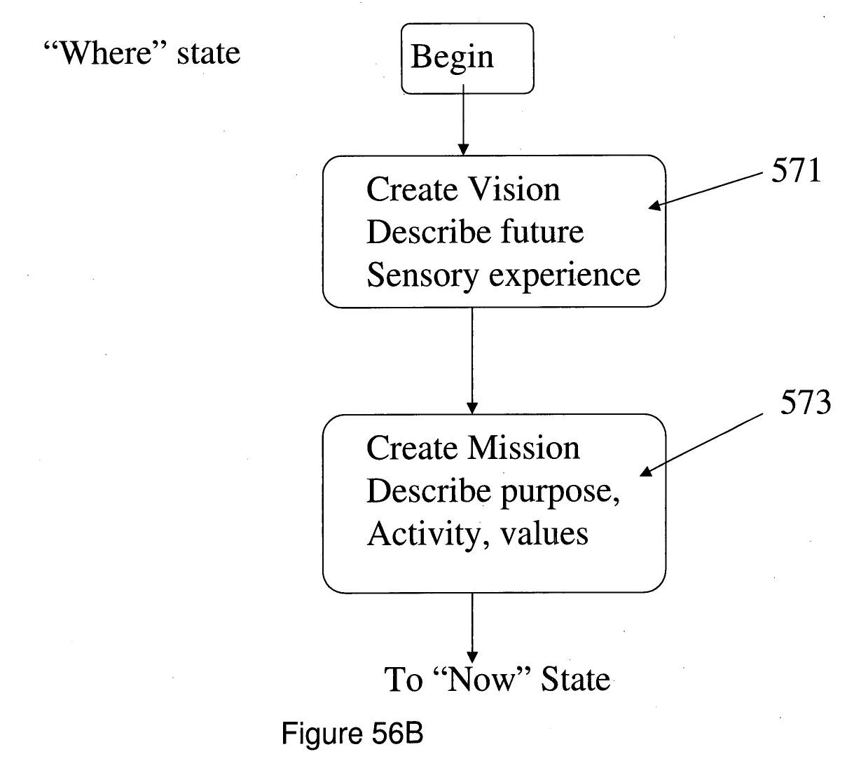

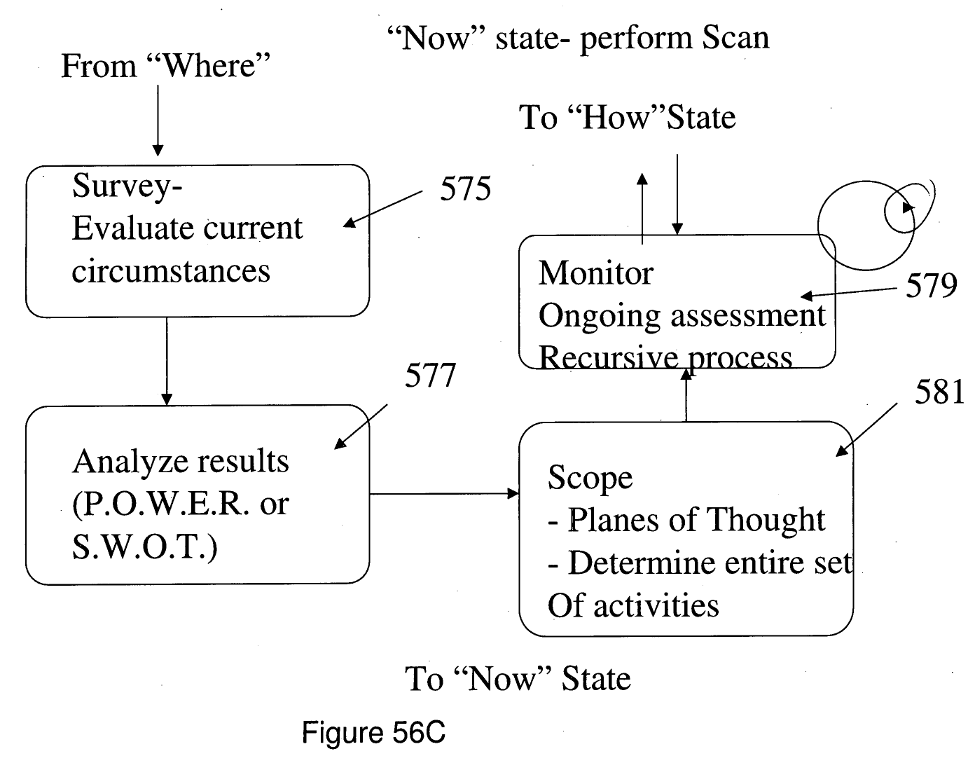

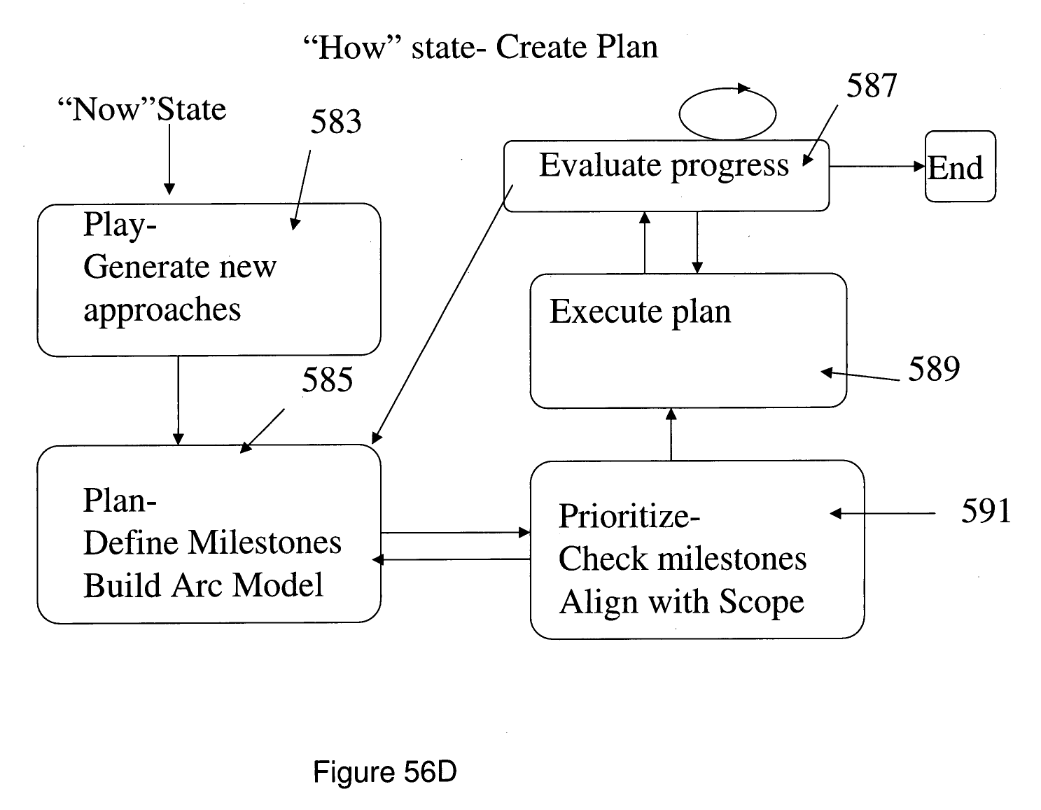

In FIG. 56A, process 561 represents the “Where” state. As described above, the user begins the method by creating a Vision describing the desired future reality and by creating a Mission, which includes the purpose, activity and values statements. The method flow then transitions to the “Now” state where the various steps of the Scan process are performed as described above. Step 565, the next step, is the “How” process, which includes the steps of creating and building a plan, which may be represented as a navigable arc, and executing the plan. The plan is dynamically evaluated at step 567 and this step is recursive and continuous, so that the results of the evaluation are used to update the plan, and periodically the entire process recursively checks again the present set of circumstances, and the Scan and Plan steps are again executed to keep the process and the executable steps current and optimal at all times. This process is adaptive, and the ongoing Evaluate step ensures that change is identified and adapted to—and moreover, desired change often is intentionally created in the direction of the Vision—and this adaptive step is done on an on-going basis, in contrast to the prior art static planning processes.

FIG. 56B depicts the flow and steps executed at the “Where” state, as described above. In state 571, the method begins with the users creating the Vision statement and sensory description as described above. In state 573, the process continues and the users create the Mission statement, including the purpose statement, the activities encompassed, and the values of the individual, corporation, or group. The process then takes this information into the “Now” state.

FIG. 56C depict a detailed flow chart view of the process steps performed in the “Now” state as described above. Starting at the Survey state, 575, the users evaluate the present set of circumstances, resources, and capabilities. In State 577, the users or individual analyze the results as described above using the various tools available, or other tools not shown in the figure, to further assess and comprehend the present set of circumstances. In state 581, the Scope steps are performed as described above, the Scope step determines the entire set of activities that the planning should encompass. Then in state 579, importantly, the recursive step of Monitor is performed; this step encompasses an ongoing assessment of the current set of circumstances that will be performed as the individual or group progresses along the navigable arc plan towards the destination Vision. This step includes all of the individuals and this step is scalable for the action items for each individual; that is, in addition to the overall plan, these tools should also be applied for each individuals' assigned responsibilities in the same manner, so that the entire effort, at every level, benefits from these methods.

FIG. 56D depicts the “How” state of the invention. In this state, the steps described above are performed, importantly this state is also recursive and on going in several aspects. In the Play state 583, the individual or group uses various tools to develop new approaches to problems and opportunities. In the Plan state 585, the group defines milestones and strategic objectives, creates tactics for addressing the objectives, and builds a plan that preferably may be depicted visually using the navigable arc model. In the Prioritize state 591, the plan is evaluated against the Scope results to ensure that the planned actions fit within the defined scope of the activity. The Plan may be recursively updated and modified until it reaches a point of alignment with the Scope. It is expected and assumed that the dynamic planning process of the invention will cause the plan to be a working document that is changed on an ongoing basis. In step 589, the plan execution is begun and continues throughout the process. However, the plan can be changed dynamically and so the individuals responsible for executing the plan are expected to update their own, aligned, individual plans to reflect changes in circumstances, new opportunities, additional or limited resources, etc.

The Evaluate step is a critical part of the “Where, Now, How” method and at 587 is depicted as a recursive loop that is continuous. If in the Evaluate step changes are identified that are to be made to the plan, the process flows back to the Plan step and moves back through the Execute and Evaluate steps. Further, it is expected that the “Now” process will be performed periodically as described above, thus the arrows from the Evaluate step back to the “Now” state depict the recursive and ongoing nature of the dynamic and adaptive plan of the invention.

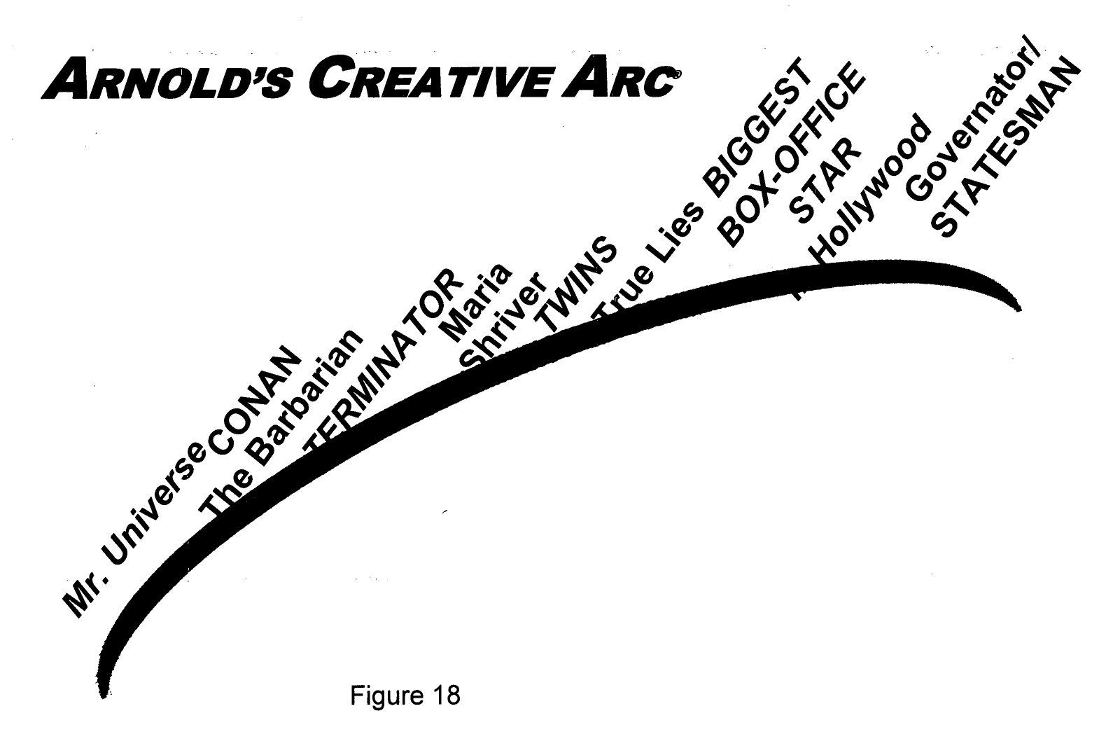

FIG. 18 is an illustration of how events in an individual's life might be modeled as a journey along a navigable creative arc using the methods of the invention. In FIG. 18, significant events in the life of Arnold Schwarzenegger are depicted as they could have been modeled on an arc using the methods of the invention. Arc 115 traverses the lifespan of Arnold Schwarzenegger. At the left side of FIG. 18, certain events are depicted such as winning the Mr. Universe contest and appearing in a first feature film (“Conan the Barbarian”). As the creative arc is traversed towards the present day, more recent events are shown on the creative arc, ending with the recent election as governor of California, the “statesman.”

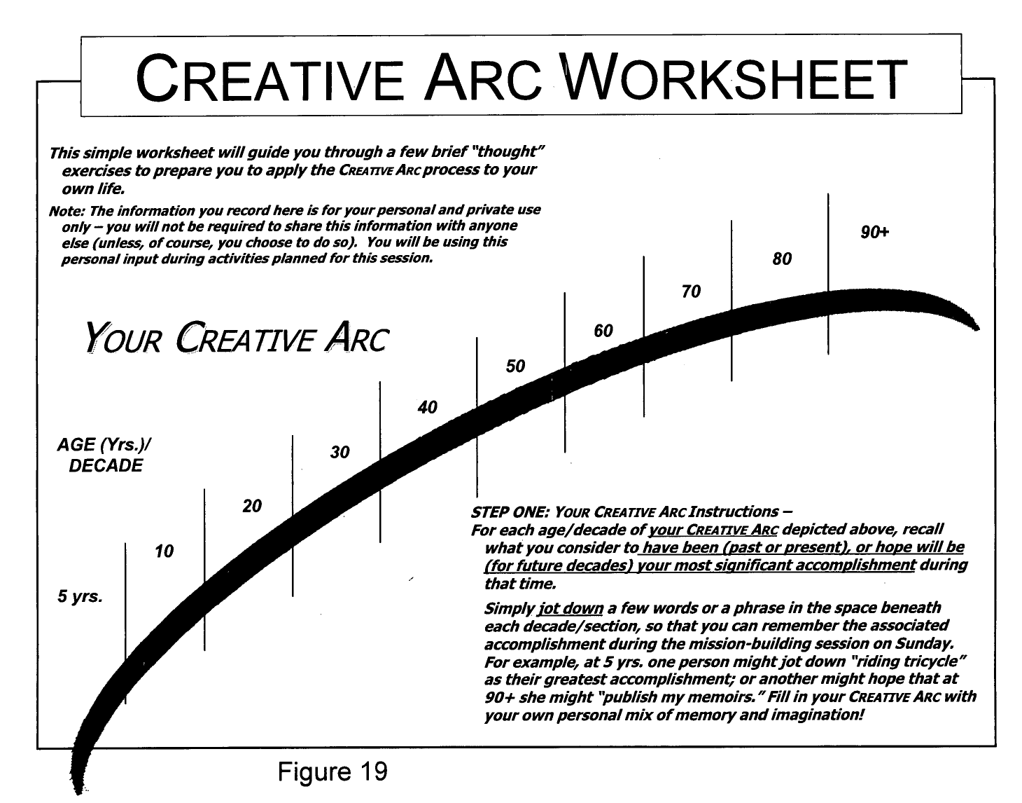

FIG. 19 depicts a worksheet that might be used by a facilitator or trainer or as part of a computer-based program to assist an individual in identifying their own life experiences in terms of the concept of a creative arc. The arc will encompass both past, present and future events and so help develop information needed for the “Now” and “Where” method steps. This worksheet is preferably also provided as part of a software program described below. Using this worksheet enables the individual to comprehend how the method of the invention may be applied to planning events and making transitions in a personal development plan by using the fractal form of the creative arc.

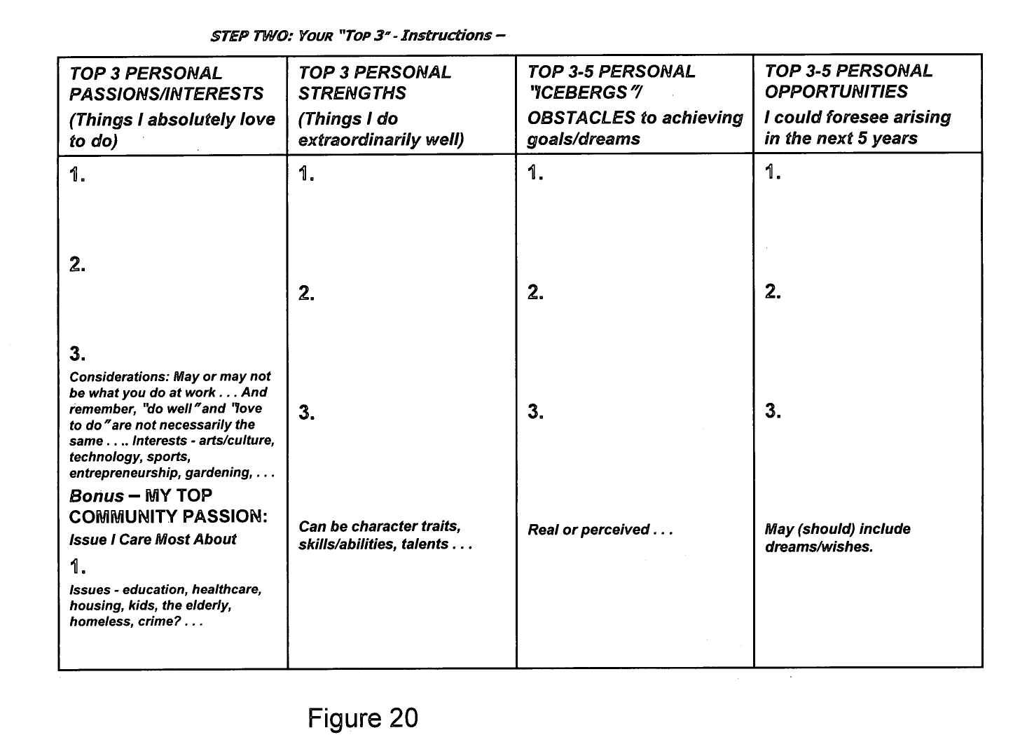

FIG. 20 depicts a second worksheet that may be used in developing a personal creative arc using the methods of the invention. In using the worksheet of FIG. 20 the individual identifies certain strengths, weaknesses, goals, and attributes which are preferably used in the inventive methods to develop a personal creative arc. This worksheet also may be used by a facilitator or trainer in a moderated session or provided as part of a manual or software program described below.

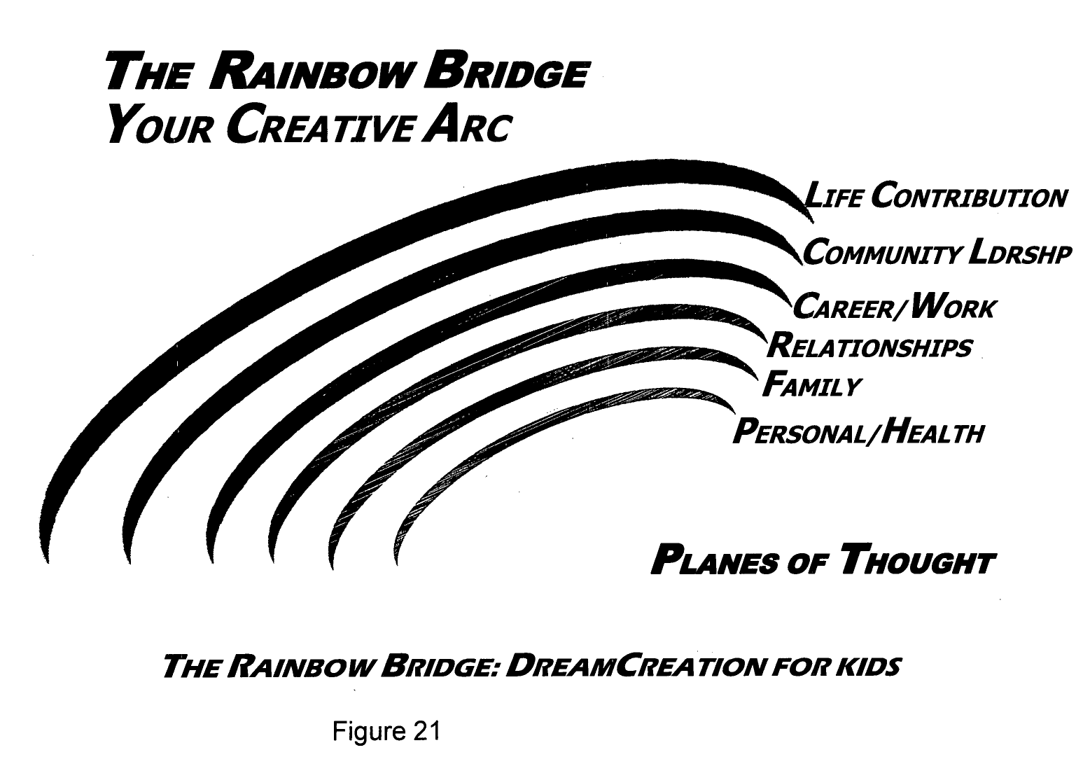

In another embodiment of the methods of the invention, a form of the “Where, Now, How” method of the invention particularly directed at school-aged children has also been developed as depicted in FIG. 21. In this form, the arcs are typically colorfully coded and the levels discussed are school, hobbies, church, home, family—the emphasis is on activities children experience and so the career and work levels are not included. Generally the overall method is the same as described above, the materials or software used to provide the invention to children as planning individuals may include rainbow colored arcs which are more attractive to children but otherwise the approach and method is the same as for adult participants.

A common planning problem that most businesses and some groups or organizations address is a plan for brand development. This embodiment of the methods of the invention specifically addresses this problem.

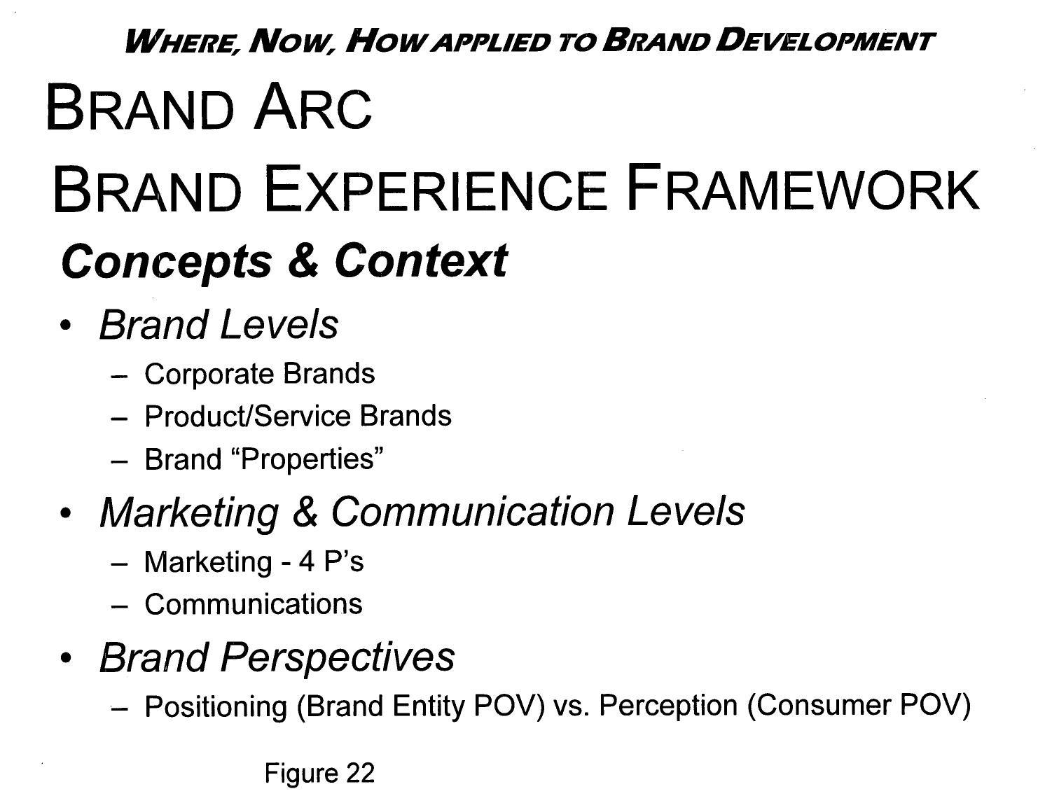

FIG. 22 depicts a framework for applying the “Where, Now, How” method of navigational planning to the process of brand development for a business or group. In FIG. 22, Brand Levels are identified as in the framework; a corporate level, a product/service level, and a “properties” level are identified. The Marketing and Communications Levels are the marketing competencies associated with the Brand, including the 4 Ps and Communications. The Brand Perspectives are the positioning (brand entity point of view) vs. the perception of the brand (consumer point of view.)

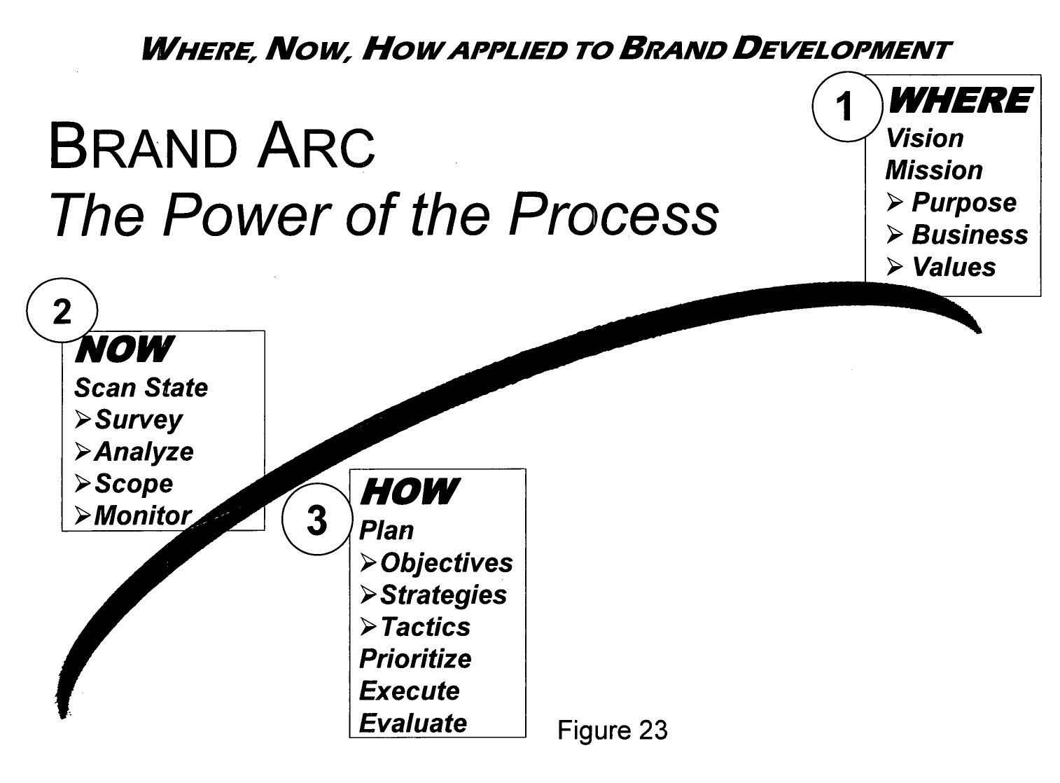

FIG. 23 depicts the application of the creative arc of the methods of the invention to the brand creation process. In FIG. 23, the Where step again involves creation of the Vision, Mission for the Brand, as described above. The “Now” step again involves the Scan process including the Survey, Analyze, Scope and Monitor steps described above. The How step again involves the Plan processes described above, with steps Objective, Strategies, Tactics used instead of or in addition to the “Play” step described above.

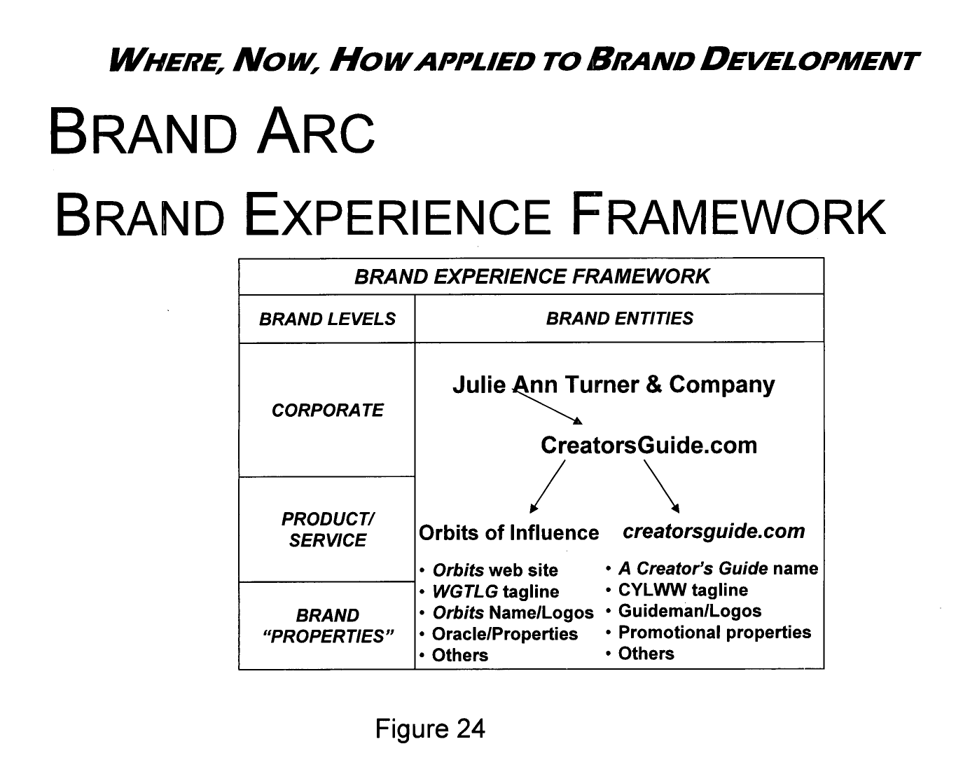

FIG. 24 depicts a Brand Experience Framework to be used in developing the Brand Levels described above. The levels shown are Corporate, Product or Service, and Brand Properties. The Corporate level depicts the corporate entities that exist or are created. The Product/Service level depicts the product or service entities provided, such as websites, storefronts, catalogs, and the like. The Brand Properties are the names, slogans, trademarks, logos, brochures, packaging, events and the like that are properties associated with the Brand.

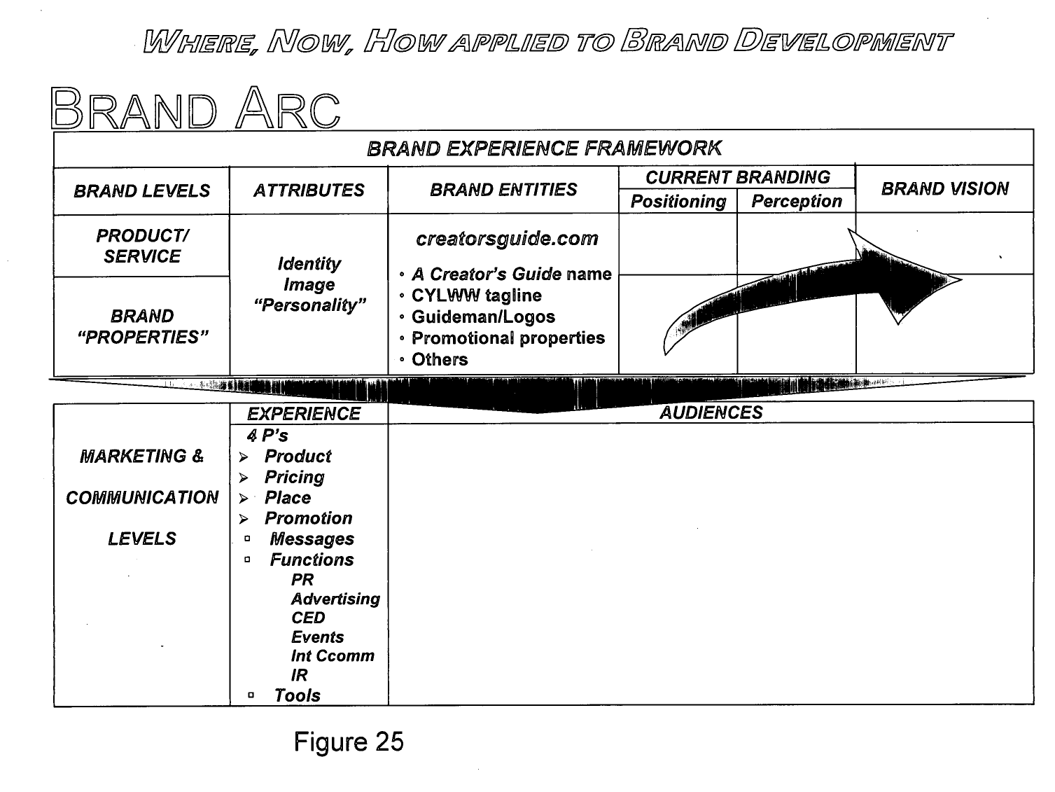

FIG. 25 depicts a visual representation of how the creative arc process is applied to the Brand Arc method of the invention to create a vision for the Brand and to crate a plan for transitioning from the present status to the new reality represented by the vision. In FIG. 25, the brand experience framework described in relation to FIG. 24 is depicted with the marketing and communication levels shown as the Brand Experience, the arrows depict the transition along the Brand Arc from the “Now” (current Branding) to the Where (Brand Vision) while the arrow pointing downwards represents the use of the marketing and communication level experiences to make the transition along the Brand Arc happen using the How process of the invention.

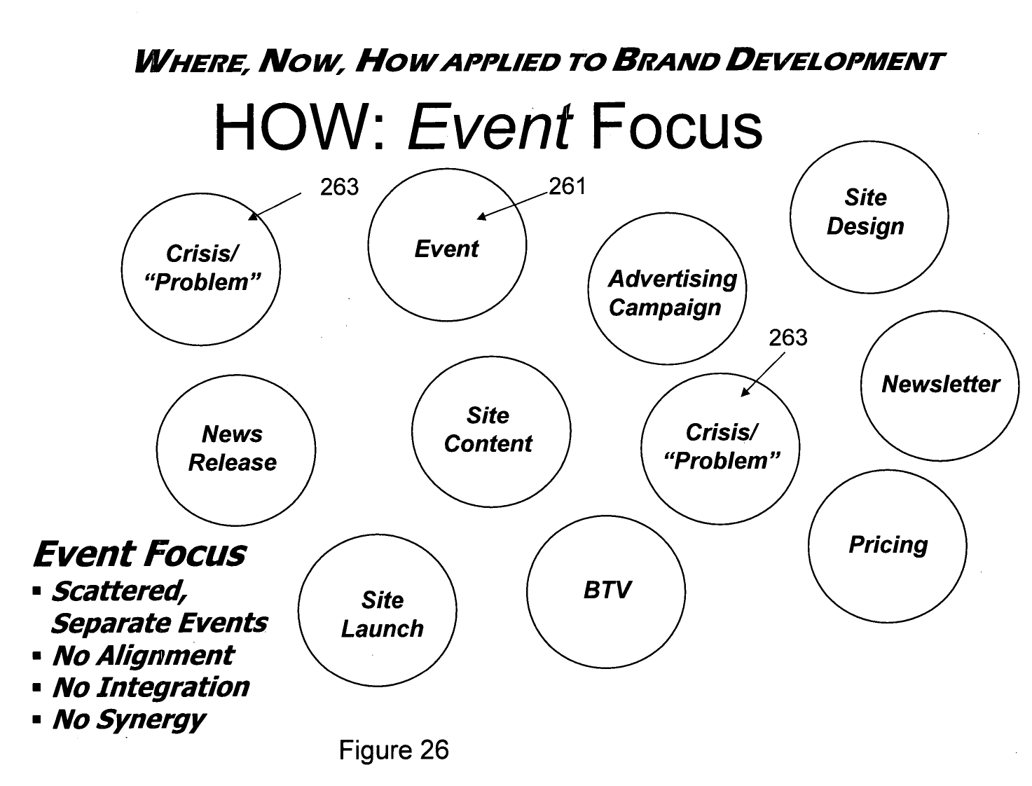

Once the “Where” and “Now” processes are performed using the creative arc framework of FIG. 25, a “How” process needs to be performed. FIG. 26 depicts a set of “events” which traditionally might be contemplated in executing a branding process. Initially, the branding process is focused on the events as independent actions, and each is not aligned with or related to the others. Examples are “events” 261 such as appearances, press conferences, promotions and the like, “crisis problems” such as staff resignations, negative press, resource limitations and the like, and other activities which are not referred to in detail but which are self-explanatory.

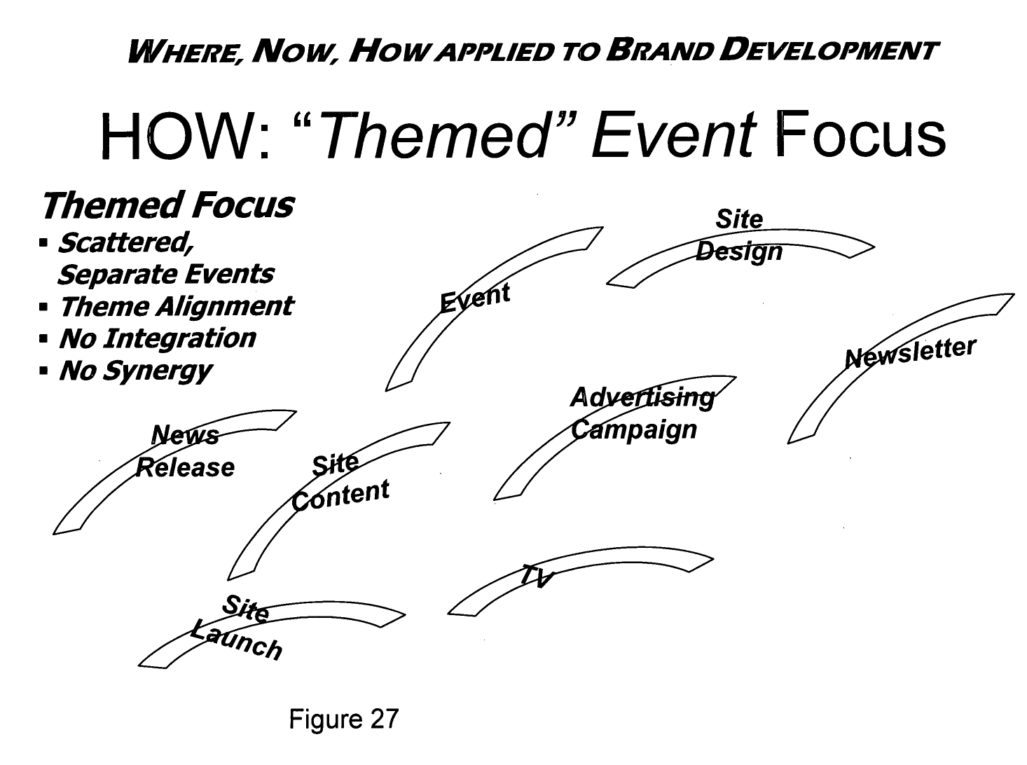

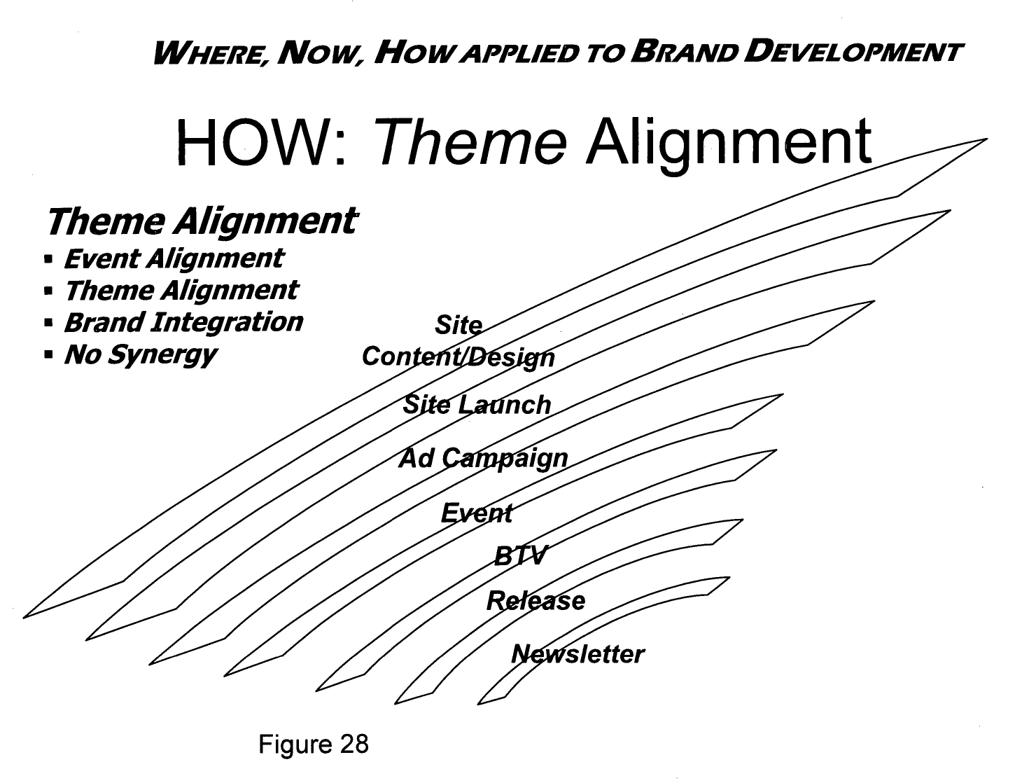

FIG. 27 depicts the actions of FIG. 26 when modeled using the fractal creative arc of the invention. Each of the actions is now a fractal arc representing a transition or time-based plan for execution. In FIG. 28, the arcs of FIG. 26 are aligned and are shown depicting a set of prioritized arcs, each representing a planned transition or schedule, and the alignment indicating the events are synergized and recognize certain common resources and benefits.

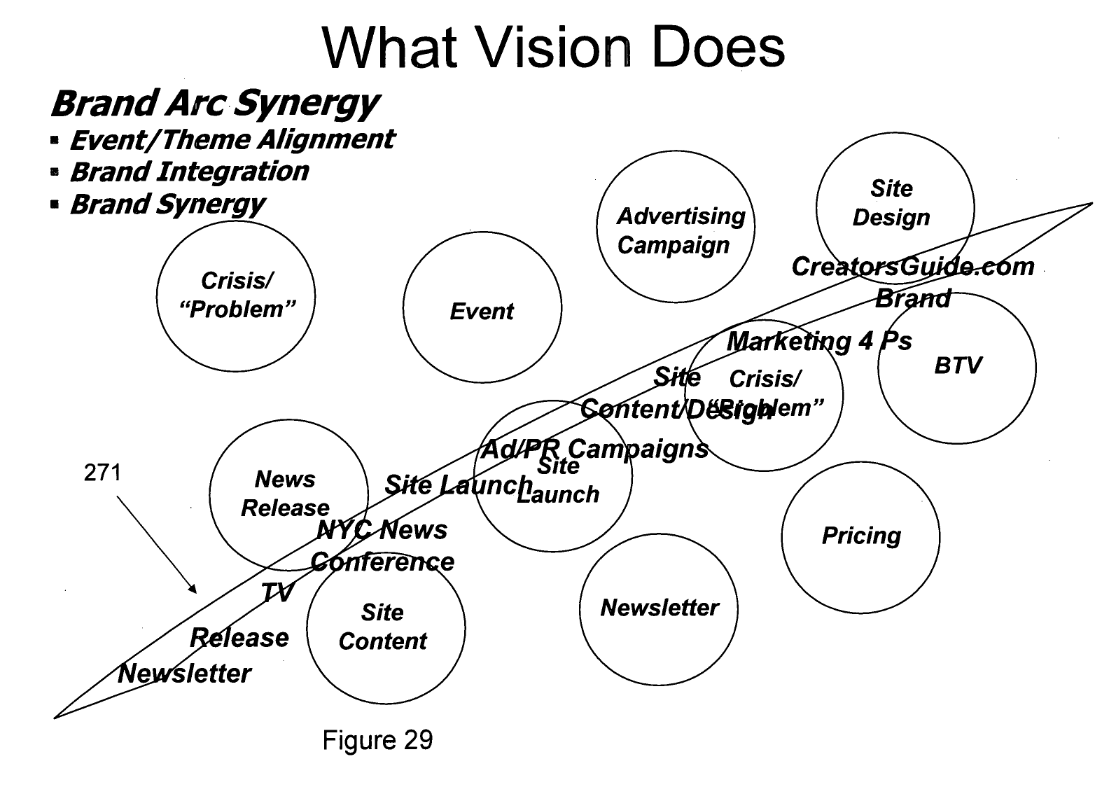

In FIG. 29, a master creative arc 271 is shown overlying the various events. The Vision of “Where” is applied to the “How” process step to prioritize the activities which enables a schedule to be created for the events. “Now” an executable plan visually depicted as a navigable arc is developed and the group or individuals has a dynamic plan to work to in making the transition to the desired future branding development. The arc event on the left side of the page, labeled “Newsletter,” represents the first step to be executed and the arc event on the upper right side of FIG. 28, labeled Creatorsguide.com Brand, represents the goal or “Where” circumstance to be achieved in the future, the schedule is depicted as the journey along the navigable arc. Although not depicted here for simplicity, dates or milestones may be added to the arc to make a schedule or calendar from the arc, and the individuals empowered to execute the various processes or steps required to meet the schedule may be listed or designated along the arc.

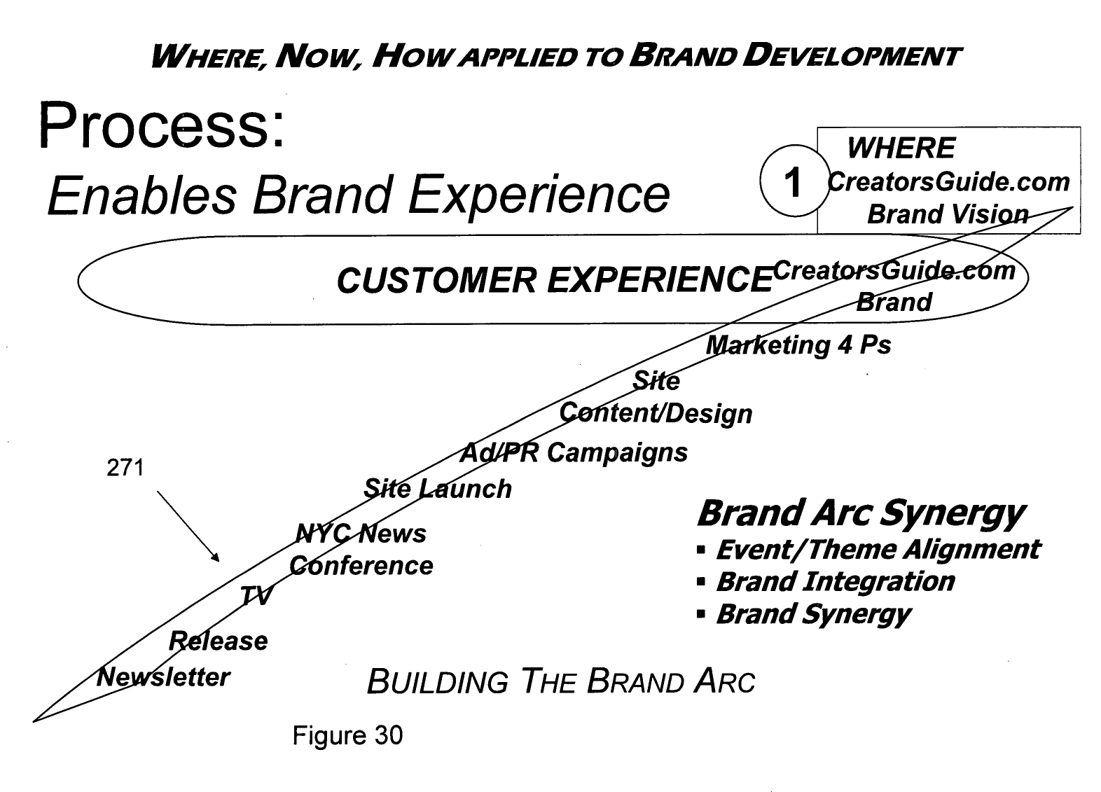

FIG. 30 again represents the Brand Arc method of the invention as a navigable arc, however now the arc is depicted from the Customer Experience point of view, with the perception and experience of the customer encountering the Brand depicted as a continuous journey along the Brand Arc.

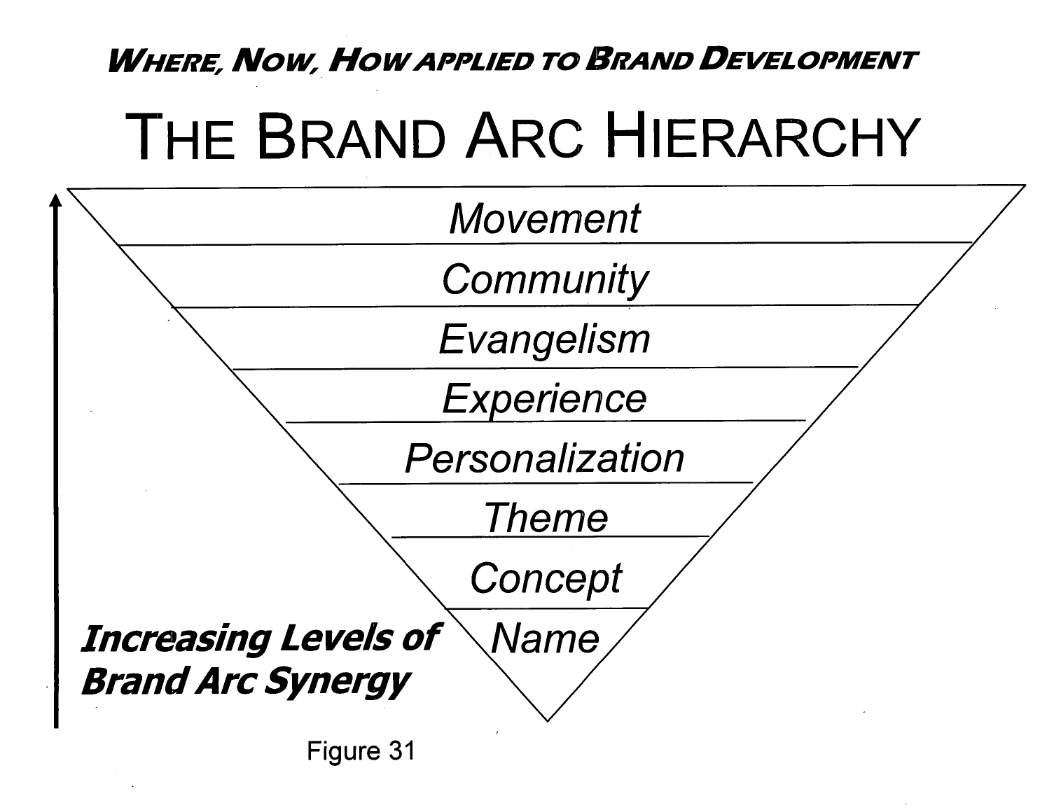

FIG. 31 depicts the method of the invention applied to the brand development as a hierarchy of levels, beginning at the lowest level with the choice of a name, then expanding upwards to higher levels including the concept level, the theme level, and moving upwards towards a community level where the brand might define a community of people who like and associate themselves with a brand, as an example Harley Davidson has created a brand experience so that even people who do not own and do not ride a motorcycle will purchase and wear apparel with the brand appearing on it, in order to associate themselves with the community of individuals defined by the brand.

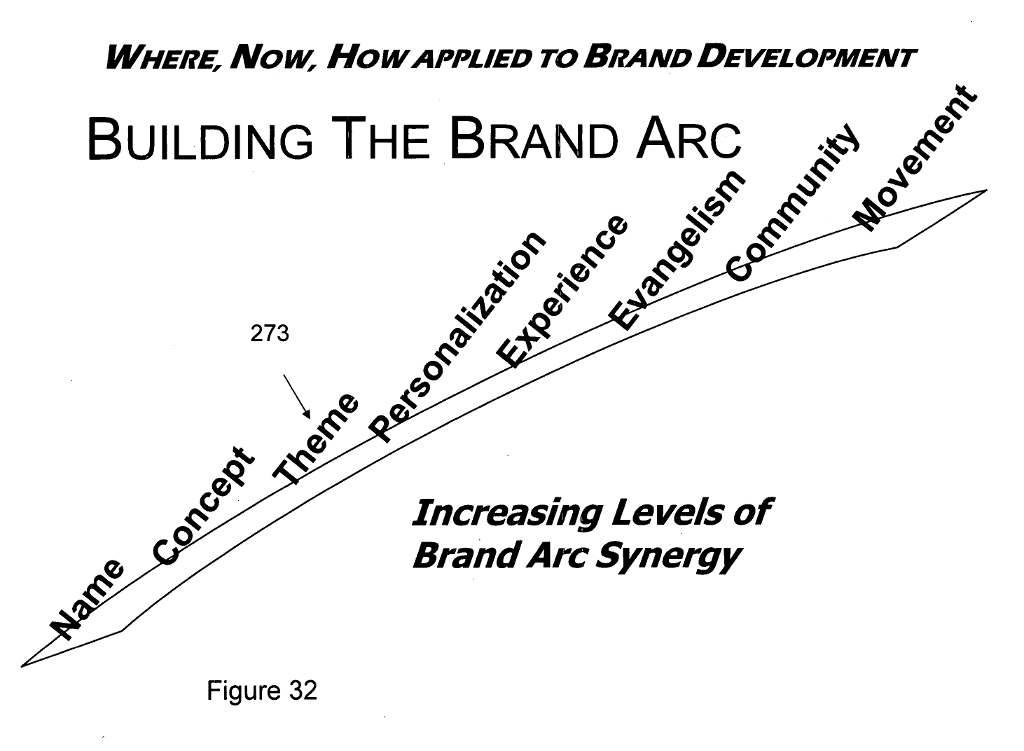

FIG. 32 depicts a creative arc of the invention used to model the transition steps or a plan to move the beginning level, the name, of a brand development towards the desired future of a community or movement associated with the brand. The Brand Arc 273 is a model for a plan of executable steps that are prioritized and aligned so that as they are performed the brand is expanded and develops until the final stage where the community is identified with the brand.

Another aspect of the brand method of the invention, which is a step to create a positioning statement. The positioning statement is analogous to the Mission statement of the Vision step and is particularly applied to the brand development method of the present embodiment. The positioning statement contains descriptions of what characteristics define and distinguishes a particular brand from other competing brands, for example.

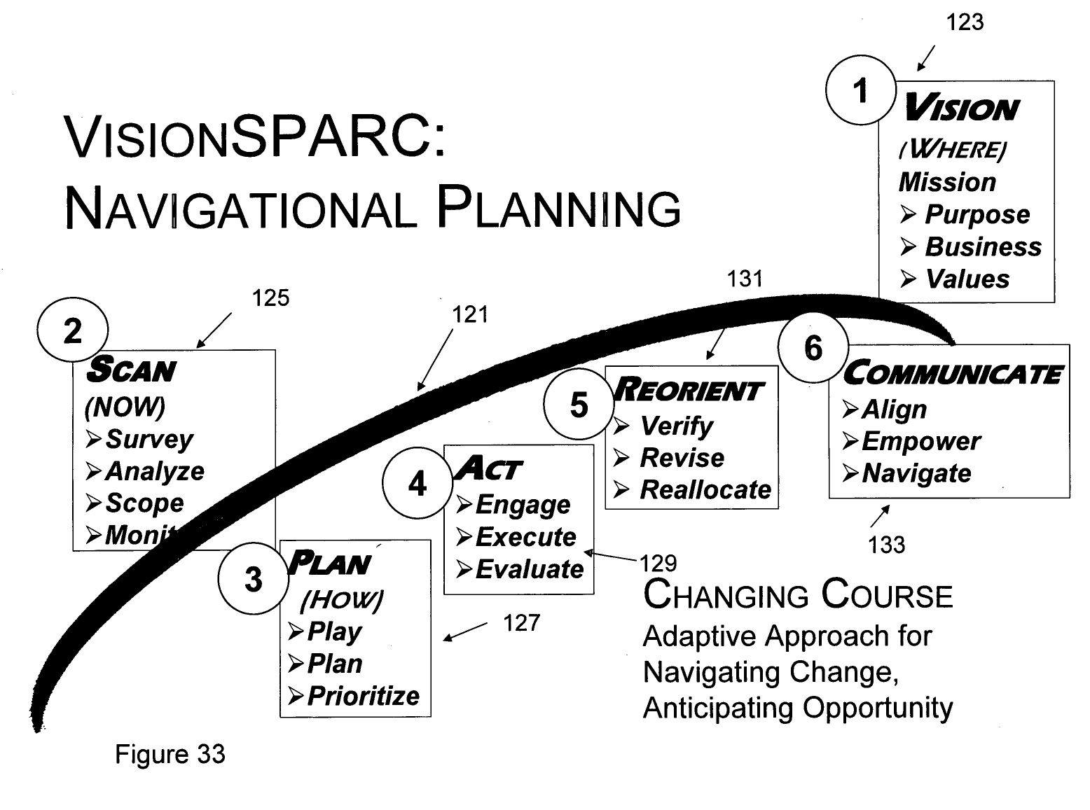

In yet another embodiment of the methods of this invention, the prior method steps presented above may be further refined and extended, in order to provide more detail about the specific stages, especially the “How” stage of the process, for those using the Creative Guidance System. This embodiment is given a mnemonic, of “VisionSPARC,” simply to make the steps easy to remember, however, the names of the steps do not limit the invention. FIG. 33 illustrates the process steps to be performed in using this additional method of the invention to plan and execute a transition to a new, desired future set of circumstances. In FIG. 33, a creative arc 121 is shown again as a journey from ending in the “Vision” box 123, which is similar to the “Where” box of FIG. 8. Box 125 illustrates the “Now” process step, which has further steps within it exactly as in the “Where, Now, How” method embodiment previously described. Box 127 is a Plan process step, which is similar to the “How” process step of the method previously described. Box 129 is the fourth step of the VisionSPARC method, which is the “Act” process. Box 131 illustrates the fifth step of the present method, the “Reorient” process, which is then followed by the sixth step of the present method, the “Communicate” process illustrated in box 133. The method as a whole is then comprised of the steps of Vision, Scan, Plan, Act, Reorient, and Communicate, which is conveniently represented by the mnemonic phrase VisionSPARC.

The Vision step 123 is again the first step to be performed using the creative process to describe in a sensory way the experience of actively being in the future set of circumstances. This innovative feature of the methods of the invention provides a methodology for the individual or group to create a new future reality without considering the current limits on resources or experience and without considering what steps will have to be taken to implement the transition to the desired state, and so is the Vision process is far less limited in scope than traditional problem-oriented planning techniques. The Vision step, like the “Where” step in the prior embodiment, further includes again the Mission steps, the individual or group will generate statements which describe accurately the purpose, the business and the values the individual or group either currently possesses, or chooses to possess in the future set of circumstances.

Process 125, the “Now” or “Scan” process, is next performed and involves exactly the same steps as in the “Where, Now, How” embodiment described in the prior method presented, and so will not be again described here.

Process 127, the “Plan” step, is next performed and involves exactly the same steps as in the “Where, Now, How” embodiment described in the prior method presented, and so will not be again described here.

Process 129, the “Act” step, is next performed. This step is a refinement and extension on the steps of the prior method described in the above embodiment. The “Act” process step is performed in three smaller steps illustrated as the “Engage,” “Execute” and “Evaluate” steps. “Engage” is the step of ensuring those individuals who will be performing the plan to actively enter into, interact with and have input into the plan, so that everyone in a group or business who impacts the plan is actively part of the planning process and can commit to the execution of the plan. In performing complex planning cycles, traditionally, and in the prior art, often a smaller group or committee performs the planning steps, and the plan is only then shared with the broader group of participants who are then charged with executing that plan. In the “Engage” step of this method embodiment of the invention, the plan is now communicated to the participants who will either execute the plan or be impacted by it, and they have input into, and participate with the final stages of, the planning process. Preferably, a “launch” event may be held to formally start the execution of the plan, or other communication tools such as websites, emails, posters, fairs, meetings and the like may be used to engage the actors who will execute the plan with the plan and refresh the Vision in the minds of everyone involved in the process.

“Execute” is the step of actually beginning and performing the steps of the plan; however, this process is not rigid or static and may be performed contemporaneously or simultaneously with the “Evaluate” step shown in the “Act” process; so that during the actual execution of the plan, it is still dynamically updated with the outcome of the “Evaluate” step with regular frequency. In the “Evaluate” step the participants involved in the execution of the plan are to measure their results and update the plan as it is executed using the Scan steps of the “Now” process, for example, to constantly and dynamically update the plan with new information, opportunities, problems, resources or shortages, etc. In this way the plan becomes a dynamic, constantly changing tool that has current information introduced into it frequently, so that the plan does not become a mere static schedule with little or no relationship to the real execution process, such as the prior art planning tools might produce.

Process step 131 of the VisionSPARC method, the Reorient step, is next performed. Again the “Reorient” step introduces real-time feedback into the plan as it is executed, so that the plan never becomes static or obsolete while it is being executed. In the Reorient process, three steps are performed: a “Verify” step which checks the steps being executed to perform the plan against the current reality and which also verifies that the steps are aligned with the Vision and contribute to reaching the Vision set of circumstances; also the participants should verify that the Vision is still the correct destination.

Next a “Revise” step is performed which changes the plan, the vision, or both in response to the Verify step, the Monitor or Scan steps, or the Evaluate steps. Each individual participating in the plan should apply these tools to their work and frequently update the plan with new information and so ensure the plan reflects the steps actually being executed. Each individual is empowered to input information into the plan and of course each individual participant can apply the methods of the invention to create a personal Vision and a plan which is part of, and aligned with, the overall plan.

Importantly, the Reorient process 131 includes a “Reallocate” step, in which the individual or group executing the plan reconsiders resource allocations previously made, particularly in light of the revisions to the plan in the Reorient step. This is a critically important step, because otherwise, change in the plan, and particularly changes that require additional steps or resources, might not be effectively executed if the proper resources or staffing is not available; alternatively the new steps might delay or effectively prevent the participants from completing steps already in the plan, due to a limit on their time or availability. The Reallocation step again dynamically updates the plan to avoid the revisions to the plan from causing the plan to be obsolete or ineffective.

Finally process 133, the Communicate step, is performed as the last process of the VisionSPARC method depicted in FIG. 12. The Communicate step is performed to ensure all participants involved in executing the plan are made aware of any adjustments in the plan and the resources associated with the plan's tasks and schedule, to maximize the potential for an individual or group to achieve the desired goals during execution of the plan.

The first method step of the Communicate process is the “Align” step. In this step, the individual or group of individuals executing the plan looks for alignment of the plan with the Vision and with other levels and other arcs being implemented across the levels, as well as for alignment, and potential synergy to be attained, among all the tasks, resources and participants involved in executing the plan. FIG. 5 depicts arcs aligned across several levels. If the various arcs of an organization are aligned, then synergy will exist; for example, if the charitable giving performed by the organization is aligned with a benefit or activity the employees would like to participate in, then two hypothetical levels of charitable giving and employee satisfaction, while not entirely overlapping, are aligned and there is synergy. If the charitable giving were for a cause or benefit of no value or interest to the employees the levels would not be aligned and there would be no synergy between the arcs. Looking for alignment in the “Align” step, and perhaps subsequently revising a planned arc at one or more levels to align them, may achieve additional synergy.

The “Empower” step of the Communicate process is next performed. The “empower” step indicates that each individual participating in the process is to take responsibility for executing their assigned tasks, and be given the tools, for example the methods of the invention described herein, to impact and change the plan and contribute, in a dynamic way, to the planning and execution process. Further each individual is empowered to align their plans with the overall plan, and to create their own plan, or small group or teams can create their own plan, to enable them to execute the steps within the overall plan for which they are responsible. The scalability of the methods of the invention make it possible for any participant to be involved in the planning, and to communicate changes or new opportunities or new information to the plan, so that the plan is a living document which remains relevant and accurately describes the ongoing execution process at any point in time. The Creative Guidance System is unique from the prior art, in that the tools of this navigational system are shared with, and may be used by, all involved, at all levels of the planning process, such that planning becomes an ongoing process owned by, and dynamically driven by, everyone involved in achieving the desired Vision.

The last step to be performed under the “Communicate” process step is the “Navigate” step. In the Navigate step the individuals or group of individuals are to begin planning the next arc, that is, to consider where to go next (using the journey model) or to begin creating the next Vision to be achieved. By starting this process while still engaged in executing the current plan, the individual or organization is ensured that it will continue forward, continue to innovate or improve, and continue to learn and expand new skills, add new capabilities, and thereby be able to take advantage of new opportunities and address new challenges.

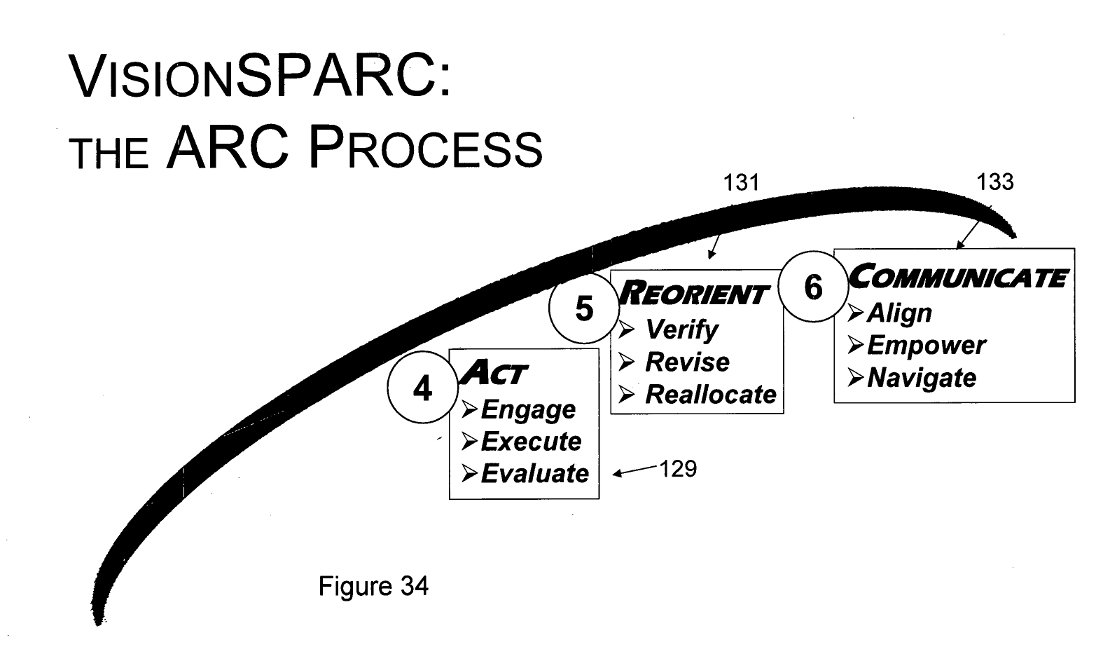

FIG. 34 depicts the new steps added to the creative arc process of FIG. 8 to form the VisionSPARC method and processes; Act, Reorient and Communicate. Thus the VisionSPARC method of the invention is a more refined application of the creative arc method and processes to the creation process and the plan that results, depicted visually as a navigable arc.

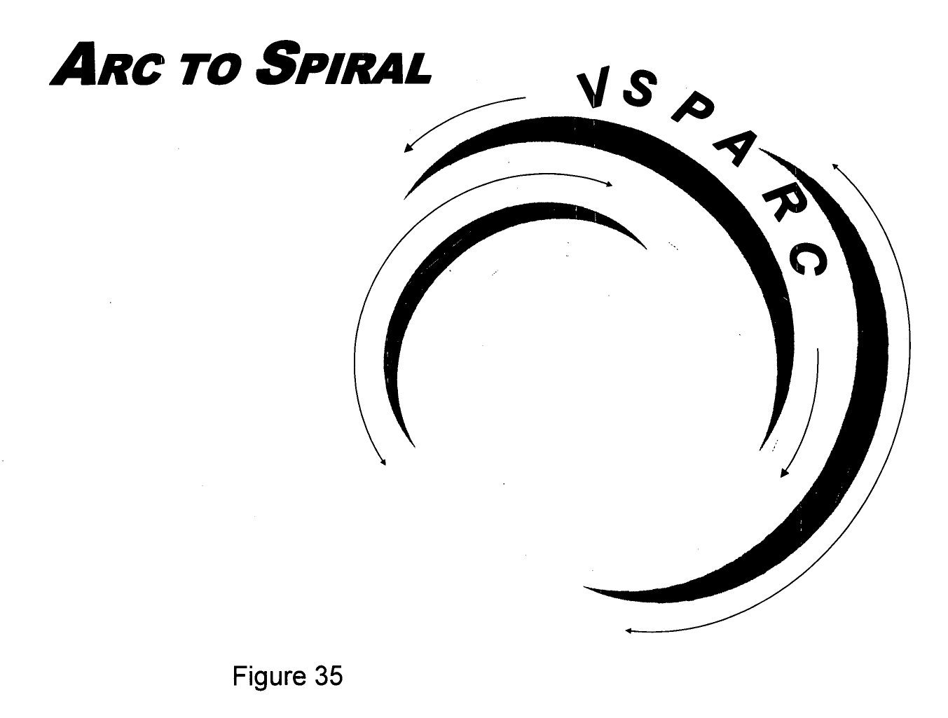

FIG. 35 depicts a sequence of arcs as a two dimensional form, the spiral form, to illustrate how, by combining ever increasing arcs, the journey an individual or group takes to the desired vision or goal is representable as a spiral formed of a series of increasing arcs.

Having described the methods of “Where, Now, How” and the VisionSPARC and the master planning tools of the arc and the spiral forms, some examples are presented to further illustrate the impact of the methods of the invention when applied by an individual or group.

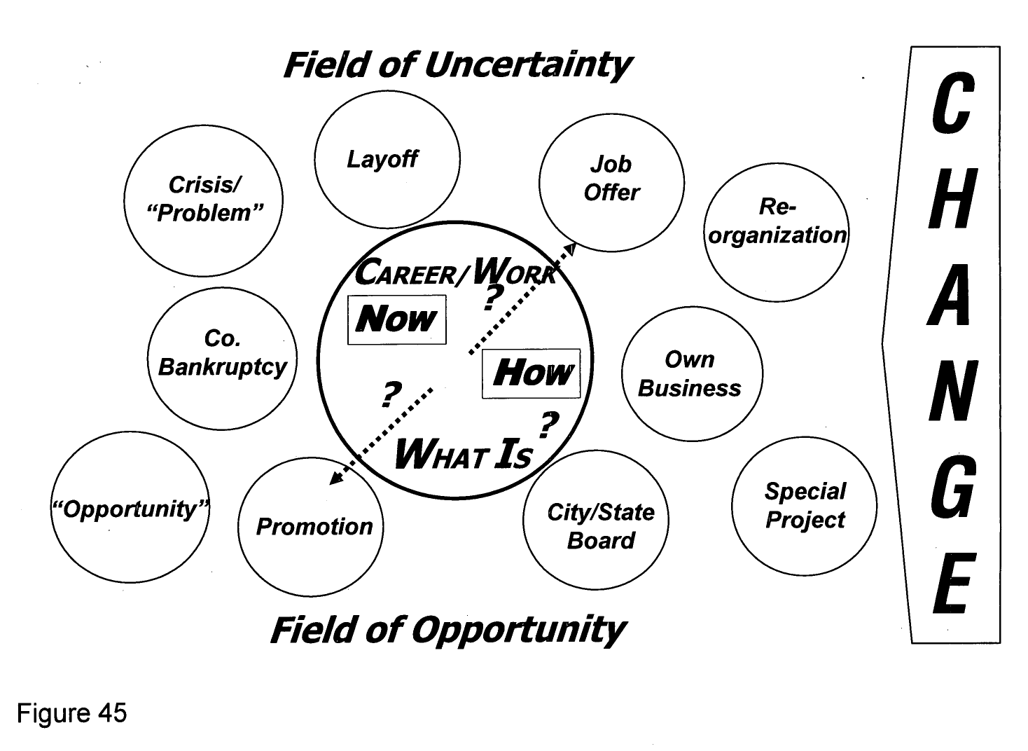

FIG. 45 depicts an illustration of various events that might impact an individual in the career or work areas of his or her life at various times. Towards the top of the figure are shown events that might cause uncertainty, for example a layoff, job offer, reorganization, corporate bankruptcy, and towards the bottom of the figure are shown events that might present opportunities, for example promotion, owning a business, special projects, and the like. A change force 110 is shown applying these events to the current situation, which is sphere 111 in the center of the figure. The question marks indicate the results of traditional planning and strategies in response to these events and the force of change, that is, not knowing what to do and no method for moving forward, the individual represented by the set of circumstances in sphere 111 is reactive and is thinking in terms of coercion (change is applied to him without control) and scarcity (resources are being preserved and not considered abundant).

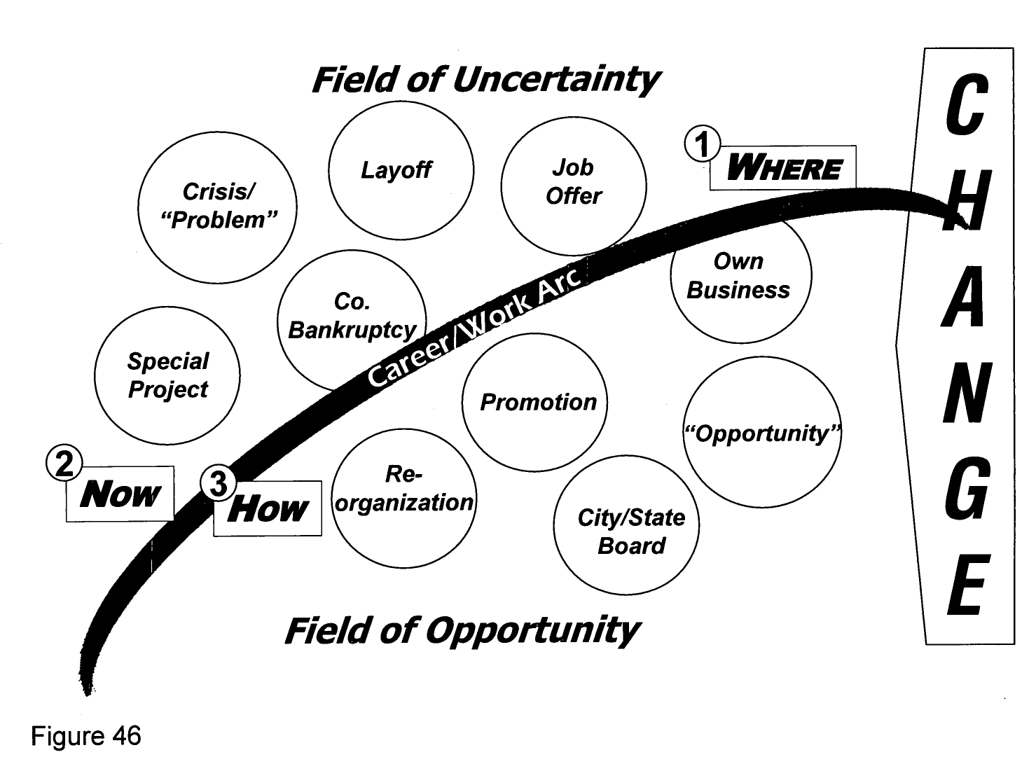

FIG. 46 illustrates the impact of the creative arc concept on the situation represented in FIG. 45. In FIG. 46 the creative arc 113 gives the individual a tool to navigate through the changes expected in life because the individual has a plan that is being executed and is not stuck in a reactive mode but is choosing to create a future outcome or destination and because the planning process is dynamic and incorporates real-time events, the changes do not stop the progress or adversely impact the plan but are incorporated into it and accounted for. The individual now applies choices and has the knowledge of where the plan is taking him and so does not merely react or remain uncertain but takes action on an ongoing basis. Arc 113 represents this dynamic plan as a route across these events or challenges.

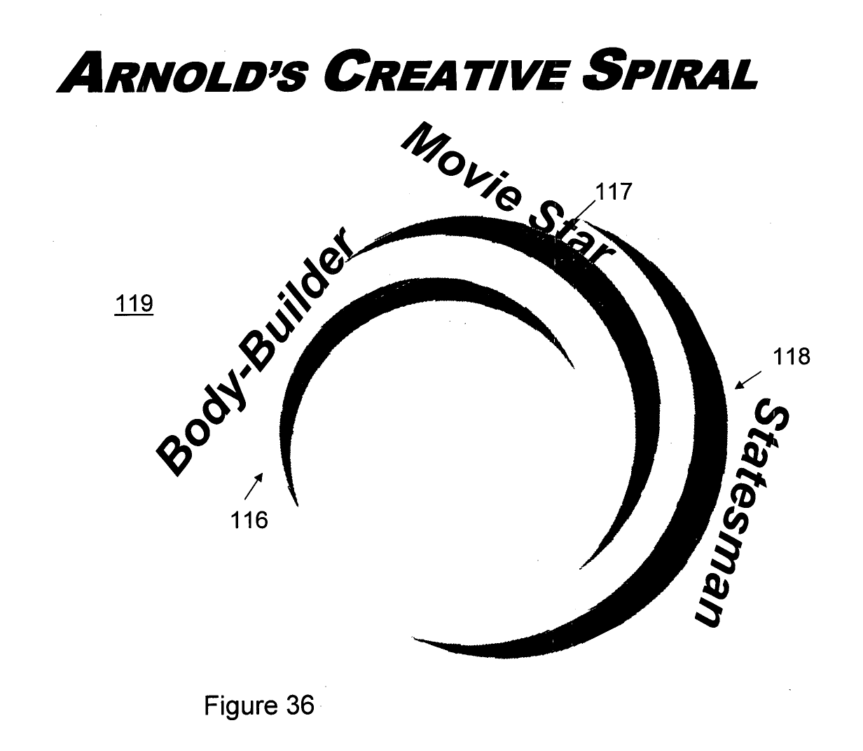

FIG. 36 depicts how the master form of the methods of the invention, the spiral form, might be used to plan and model the creative spiral form for Arnold Schwarzenegger. In FIG. 36, each arc 116, 117, 118 represent a different creative arc. As the arcs are combined together a spiral form 119 is generated with each section being enlarged and enhanced over the previous section, notice also that the arcs are arranged so that a new arc journey begins while a previous arc is still being traversed, this indicates that the individual is beginning a new creative arc even while executing on a previous arc. The combined spiral form also indicates that the capabilities and knowledge of the individual are increasing as the arcs are traversed; the spiral is larger and enhanced in more recent times than in earlier times.

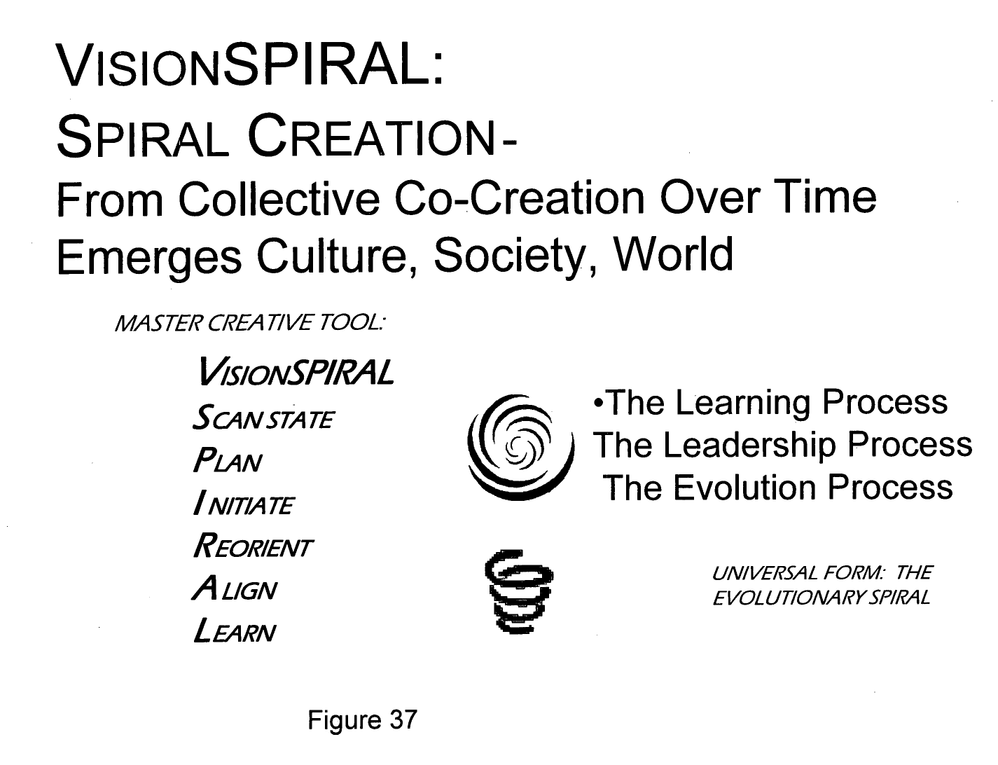

The methods of the invention presented above are now extended to yet another embodiment of the invention. This embodiment, for convenience and as an aid to remembering, is given the mnemonic “VisionSPIRAL.” The process steps of the VisionSPIRAL planning method are Vision, Scan, and Plan, Initiate, Reorient, Align, and Learn as depicted in FIG. 37. This method is a further refinement and extension of the methods described above, and reflects the evolution that may be attained over time through the consistent application of the Creative Guidance System and its principles. The VisionSPIRAL method leads to ongoing expansion of the capabilities, resources and knowledge of an individual or institution and so may be depicted visually as a three-dimensional spiral formed of the fractal arc form described above. The spiral form is particularly compelling, because although it is cyclical in some respects, if a transition is considered as a journey along the spiral the path never returns to the beginning; instead the overall dimensions of the spiral continues to expand as each arc is within it is traversed, and, as each arc both expands capacity and moves the individual or organization to a higher level—of accomplishment, performance, knowledge, collaboration, etc.—the spiral form also appropriately reflects the positive evolution achieved through the application of the Creative Guidance System and its principles.

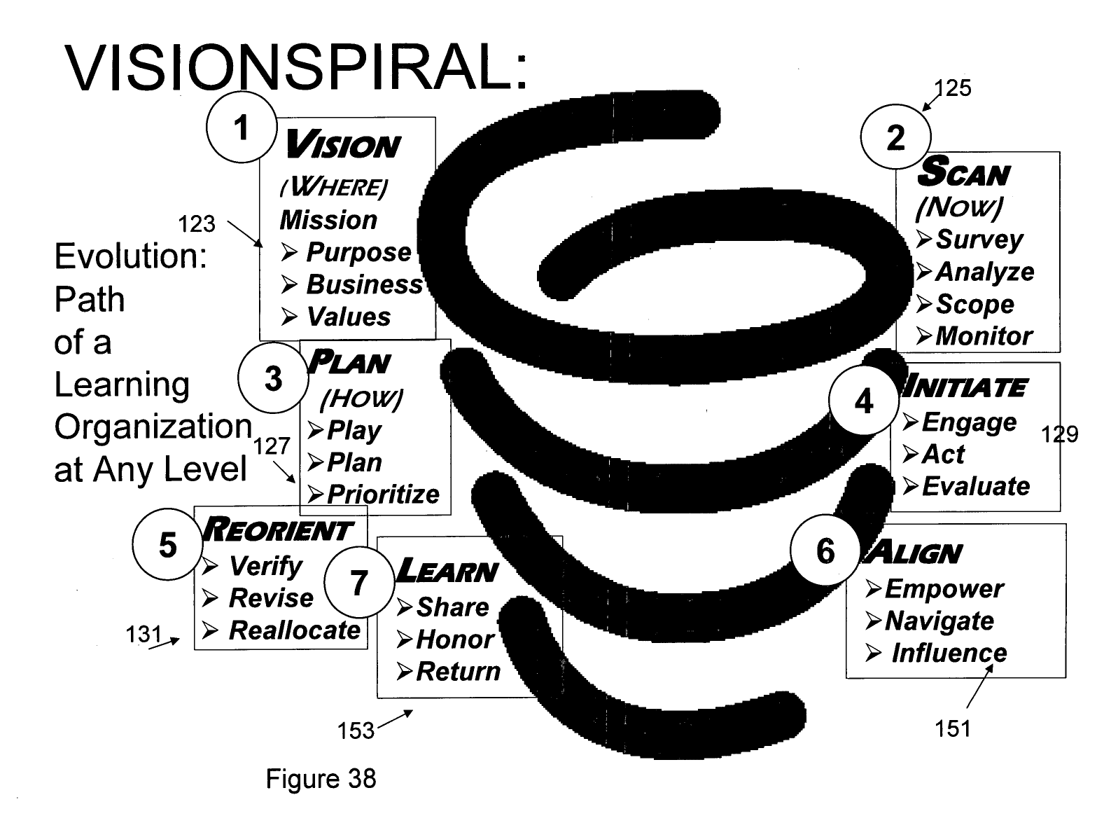

FIG. 38 depicts in illustrative form the process steps of the present method of the invention, the VisionSPIRAL method. Process 123, the Vision process, is again based on the “Where” process of the first embodiment and incorporates the steps of Vision and Mission, as described above.

Process 125, the Scan process, is again based on the “Now” process of the first embodiment and includes the steps described above of Survey, Analyze, Scope and Monitor.

Process 127, the Plan process, is likewise again based on the “How” process of the first embodiment and again incorporates the steps of Play, Plan, and Prioritize described above.

Process 129 is a new process step that extends the previous embodiments. In the “Initiate” process, the execution of the plan developed in the “Plan” process begins. The steps performed are the “Engage” step as described above, preferably including a launch or kick-off event to formally being the execution of the plan, an “Act” step where the participants begin actively executing the plan and again the “Evaluate” step where the participants each begin evaluating the results and updating dynamically the plan as the plan is executed.

Process step 131, the “Reorient” step, is next performed. This process step is again the Reorient process step as described above and incorporates three steps of “Verify,” “Revise” and “Reallocate.”

The Align process step 151 extends the prior embodiments of the invention. This process step involves three steps, first the participants perform the “Empower” step where each individual is given the training and tools to participate in and revise the plan dynamically as it is executed, also each individual, team or group is encouraged and empowered to use the methods of this invention to create their own Vision and plan and to execute it as their part of the overall execution strategy. The individuals next perform a “Navigate” step where the individuals, groups or teams within the overall business or entity begin planning for future arcs by creating new Vision circumstances so that when the current arc is completed, another arc may be begun (a further plan is already in place) so that the enterprise continues to innovate, advance or gain capability and knowledge and does not reach an end in the plan but is already planning the next transition while the current plan is being executed, each individual is acting as a navigator by contributing to the next arc journey even while executing the current plan.

The individuals complete the Align process by performing an “Influence” step, where the group engages in dialogue or other communications to influence stakeholders, community, investors, customers or others within and outside their organization with the Vision they are working to achieve in mind. Preferably the techniques and methods described in the co-pending patent application “A Method for Enhancing Influence” may be used or other methods of creating dialogue or otherwise influencing others may be used in this step.

The VisionSPIRAL process completes with the “Learn” process 153. In the “Learn” process, the participants executing the plan are to communicate with each other and with other stakeholders about the experience and to communicate newly acquired knowledge and skills, by performing three more steps. First the “Share” step is performed which is a process of distributing the knowledge and sharing the experience gained in the execution of the current plan by individuals and groups with others in the group or if desirable outside of the group who might benefit. Next the “Honor” step is performed which includes recognition of outstanding contributions, celebration of success and acknowledgement of the achievements of the individuals and the whole entity in completing the arc to the new Vision.

Finally process 153, the Learn process, completes with a “Return” step. In the “Return” step the participants' again begin a new Vision process and continue the creative process by making sure that even as one spiral or arc is completed the next one begins, thereby ensuring that the group or business can continue to grow and expand in its capabilities, resources and experiences without stagnating after one planning cycle. The methods of the invention include continuous planning so that the process becomes the way in which the participants perform their work and so the process of the invention becomes continuous and inherent in the daily activities of the organization, it is not a yearly or periodic process but instead is the process by which the organization intentionally evolves and advances. The organization or group using the VisionSPIRAL method of the invention is a “Learning Organization” which is constantly expanding and moving towards new visions or goals.

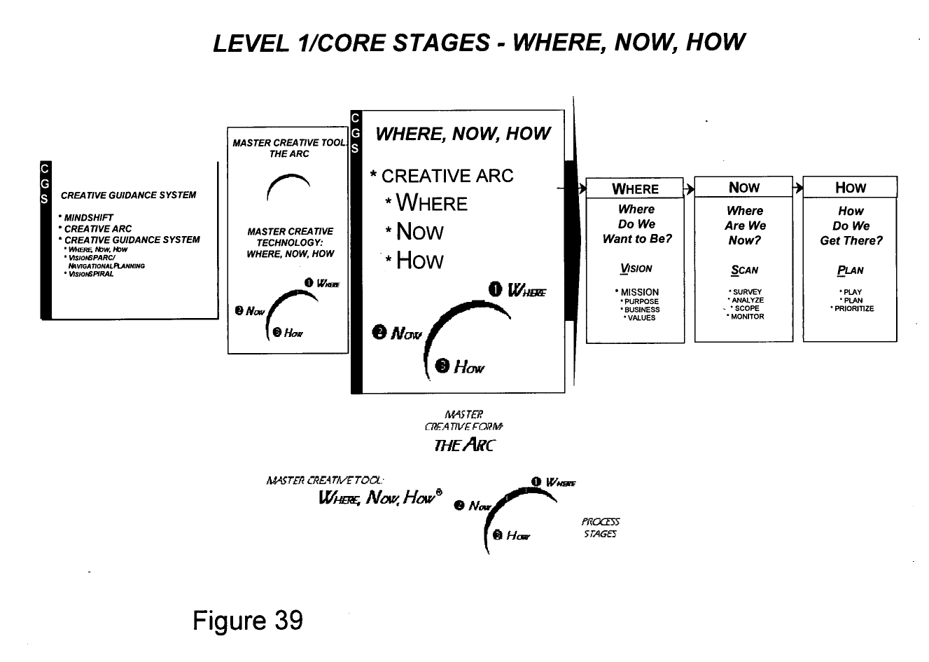

FIG. 39 depicts, in flowchart form, the methods and tools of the first level of the invention, the “Where, Now, How” method as described above. In FIG. 39, the Creative Guidance System enables the individual, group or organization using the system to create a vision or future reality to be achieved, use the processes of “Where”, including the Vision and Mission methods described above, to further identify the desired future reality, use the Scan methods described above as the “Now” step to identify and comprehend the present resources and status, and use the methods and processes described above as the How step, including the steps of Play, Plan, Prioritize and Execute described above, to create a plan for transitioning to the desired future reality or achievement. The master creative form of the Arc is used as a visual representation of a navigable arc which represents the journey traversed to transition to the future reality described by the Vision and Mission methods. The Arc may be used as a scheduling or planning tool, or, by adding dates and deadlines, as a calendar for executing the Plan. The “Where Now How” method may be provided as part of a software program as further described below, as a kit, as a facilitated training program, or as a self study program.

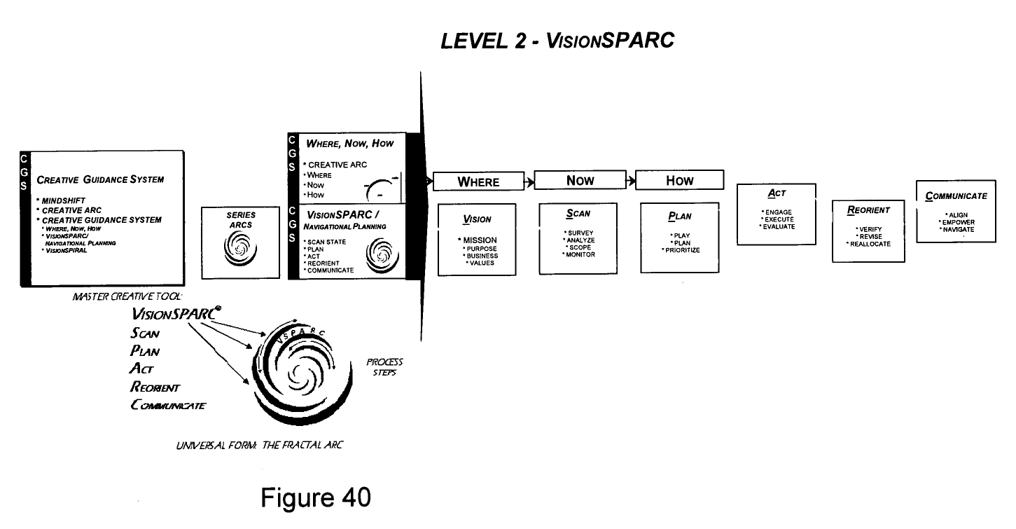

FIG. 40 depicts, in flowchart form, the methods and tools of the second level of the invention, the VisionSPARC method, and extends the methods and tools of the first level with further refinements and improvements. The individual, group or organization using this level of the methods of the invention may again perform the steps described above with respect to the VisionSPARC methods, that is, again perform the steps of the “Where, Now, How” processes described above, and then subsequently perform the steps of the Act, Reorient, and Communicate steps as described above. In this level of the methods of the invention, the master planning or creation tool is a two dimensional spiral formed from a series of Arcs. The arcs are visual representations of a set of transitions to be performed or experienced in moving to the Vision or new reality desired. The two dimensional spiral form may be used as a visual representation of steps or processes to be executed in the form of an executable plan, and deadlines or dates may be added to this visual representation to create a two dimensional depiction of a calendar or schedule which represents the plan to be executed. Again, as described further below, this method of the invention may be provided as a software module to be used by an individual or a group, as a facilitated training program, in kit form for a self study or self guided program, as a manual or in other forms including websites or printed materials.

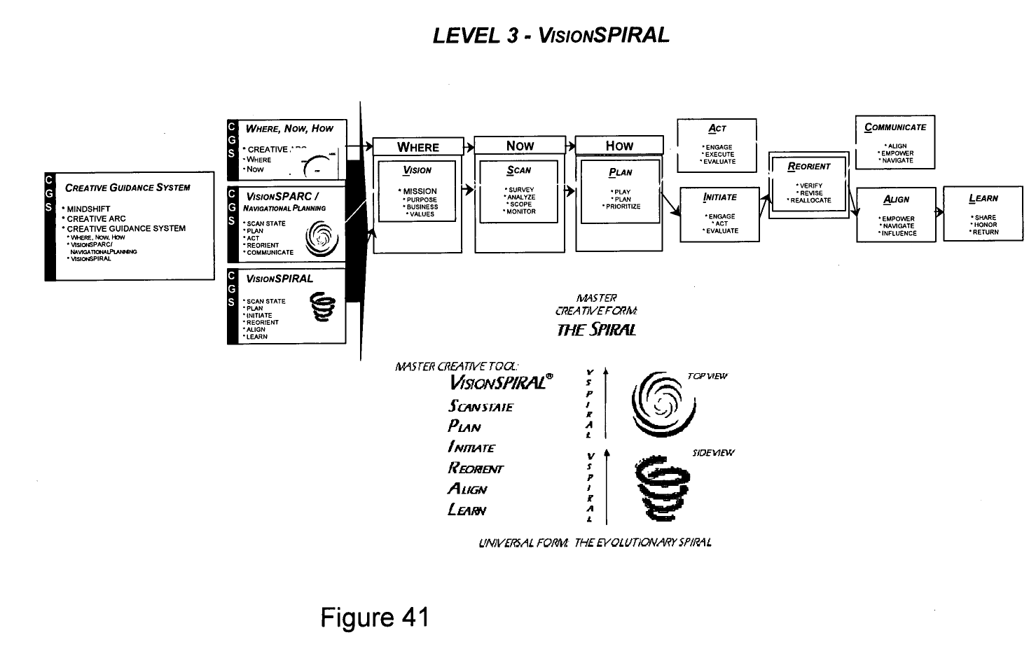

FIG. 41 depicts, in flowchart form, the third and most refined level of the method of the invention, the VisionSPIRAL method. Again, this method extends and refines the methods of the VisionSPARC method as shown in FIG. 41, the individual, group or organization, after performing the methods and the steps described above for the “Where, Now, How” steps of the invention, now performs the Act, Initiate, Reorient, Align and Learn steps as described above with respect to the VisionSPIRAL method of the invention. The master planning or creation tool of this level is a three dimensional spiral form which is formed from a series of ever expanding creative arcs. The spiral may be depicted as a series of executable steps to be performed in transitioning to the future reality described by the Vision statement, the spiral may be used as a visual calendar or scheduling tool by adding dates or deadlines to the form. Again, as described further below, this third method of the invention may be provided as a software module to be used by an individual or a group, as a facilitated training program, in kit form for a self study or self guided program, as a manual or in other forms including websites or printed materials

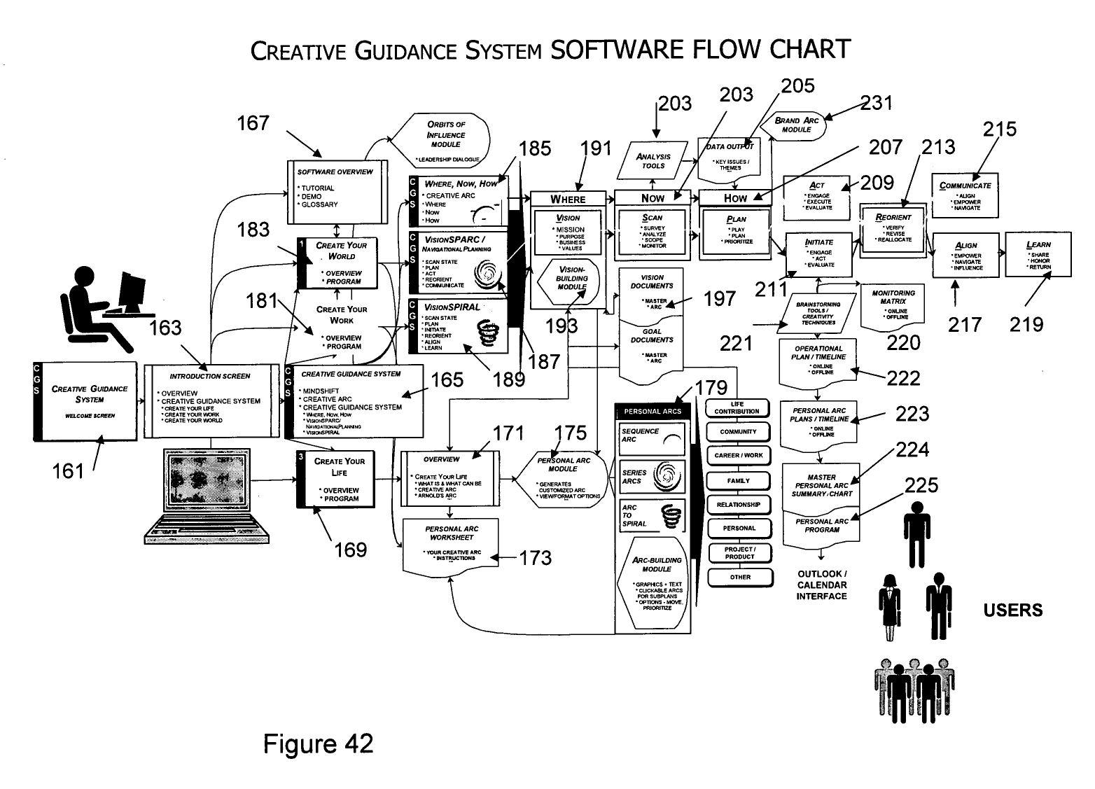

The methods of the invention in the various embodiments described above may be advantageously presented as an interactive software program which implements the system, referred to as the “Creative Guidance System,” of navigational planning of the invention. FIG. 42 depicts, in an overall flowchart form, the software various processes that are used to provide an interactive software tool for a group or individual to use any of the three embodiments described above to create and execute a plan using the methods of the invention.

Module 161 is an entry point screen that is followed by module 163, an introductory screen which explains in short form the various components of the program. Module 165 is a screen where the user can select which path to take to perform various processes within the overall program which implements the Creative Guidance System. Tutorial 167 provides the information, in searchable form for example or as an online manual, to enable the user to read about each of the concepts and methods used and the user can return to this module at any time for additional information and insight.

Module 165 also allows the user to move to any one of three modules which each can be considered at planning stage. In module 169 the program user will interactively experience a software module, Create Your Life, which applies the tools and concepts of the Vision, Arc and Spiral tools to the personal activities of the individual. The Overview module 171 provides the information about the “What Can Be” planning approach described above and the user may use a built in “personal arc worksheet” 173 to create arcs for various levels of activity. Module 175, the “Personal Arc Module” may be executed where the user develops additional visual aids and creates various views of arcs for their personal development. Module 179 further provides the spiral and three-dimensional spiral building modules for use in creating visual plans or arcs and spirals for the personal development of the individual, these may be used as part of the overall planning process by entering this personal arc module from the Vision step of the planning tool modules “Where, Now, How,” VisionSPARC and VisionSPIRAL, as described in further detail below.

Returning to module 165, the Creative Guidance System module, the user may transition to planning tools for different aspects, including the “Create your Work” program, which assists the user in developing a career path, a new career, or enhancing an existing career by developing plans for adding qualifications or skills, advancing professional networking and organizational activity and the like, and the “Create your World” program 183 which applies the concepts and methods of creating a vision and arcs or plans to be executed to the concept of making positive changes in the community, society or environment, for example.

From any of the modules 169, 181, 183, the “Create your Life,” “Create Your Work” “Create Your World” programs, the user may enter into any one of the three planning tools of the Creative Guidance System as described above, the “Where, Now, How” method, the VisionSPARC method, or the VisionSPIRAL method. Note that although a single user is described as using the software of this embodiment of the invention in this example, for groups, organizations or communities the participants may all use the software and by using a shared results file or directory, or a webpage with posted results, may if desired share their results among the group or with each other.

The navigational methods of the invention are each implemented as a module in the software, modules 185, 187 and 189, and each provides as a computer session with interactive features, the methods described above. The Vision module, 191, is common to all three methods and the user will be guided through the creation of a Vision as described above and may use various tools shown as modules 193, 197 to develop the Vision for any level as shown in the various levels 199 in the figure. The module will also guide the user or group in creating the Mission documents including the Purpose, Business and Values of the individual user or group.

From this Vision module 191 the user will transition to the “Now” or Scan module 201. In this module the software will provide interactive tools for performing the Survey, Analyze, Scope and Monitor steps of the invention as described above, for the Analyze step preferably statistical and other visual aid or presentation tools are provided as modules 203 so that the user may incorporate data or other information gathered about the current situation into these tools, for example, the P.O.W.E.R. Matrix method or the S.W.O.T. (Strengths, Weaknesses, Opportunities, Threats) analysis worksheet may be provided as an interactive computer program, other known analysis tools such as a Pareto analysis, “six sigma” worksheet or others may be incorporated with the software program of this embodiment. Outputs from this step may be preferably stored and made available to later processes as Output 205.

The user now transitions to the “How” or Plan module 207. This module includes interactive tools for performing the “Play,” “Plan” and “Prioritize” steps as described above and creates an initial plan.

If the user is engaged in the basic “Where, Now, How” method of the invention, then the software module now completes the plan which may be formatted in a file compatible with various tools, for example with computer mail or organizing systems such as MS Outlook or Calendar.

If, however, the user has chosen the VisionSPARC planning method, the software now transitions to the Act module 209. This module guides the user or group interactively through the process steps described above of “Engage,” “Execute” and “Evaluate.” If the user has chosen the VisionSPIRAL planning method the module 207 is followed by the module 211, the Initiate module, which again interactively guides the user or group in performing the three steps described above, the “Engage,” “Act” and “Evaluate” steps.

In module 213, the user is guided through the Reorient process of the methods of either the VisionSPARC or the VisionSPIRAL embodiments described above, the program interactively guides the user or group in performing the “Verify,” “Revise” and “Reallocate” steps.

Likewise, the software program guides the user through the Communicate, Align and Learn modules 215, 217 and 219 and the user performs the steps described above for each of these modules entering the results into the program for future reference, these steps will not be further described here but are as described above.

The software program depicted in FIG. 42 does extend the invention by providing additional modules 220, 221, 222, 223, 224 and 225. These modules provide additional tools and create output for the users, module 220 is a “monitoring matrix” to assist in the Monitor step the user or group will perform as part of the “Scan” or “Now” process step, module 221 is a “brainstorming/creativity” module where the user will be able to use tools to assist in thinking of creative solutions or approaches to the planning process, module 222 is an operational timeline tool which will incorporate the plan and other information and assist the user in creating a plan timeline for executing the plan and this timeline may be dynamically adjusted as described above, module 223 is a companion module which creates a personal arc plan and timeline, module 224 is a master personal arc summary chart which the user can use to develop arc information in a charting tool, and module 225 is a software tool which provides an interface with popular desktop programs such as MS Outlook and Calendar, to allow the plan information to be used in the schedule and reminder functions of these commonly used and familiar software tools.

The software program of FIG. 42 therefore provides, in an interactive form, a module that implements each component of the Creative Guidance System described above. However, the use of the software embodiment of the invention is not required to practice the systems and methods of the embodiments described above and an individual or group may practice the methods using only written materials such as manuals or notebooks or may practice the methods of the invention without reference to any materials whatsoever.

Module 231 of the software program depicted in FIG. 42 is labeled “Brand Arc” module. This software program, which is optionally provided as part of the software embodiment of FIG. 42, implements the additional embodiment of the methods of the invention as applied to the development of a brand as described above.

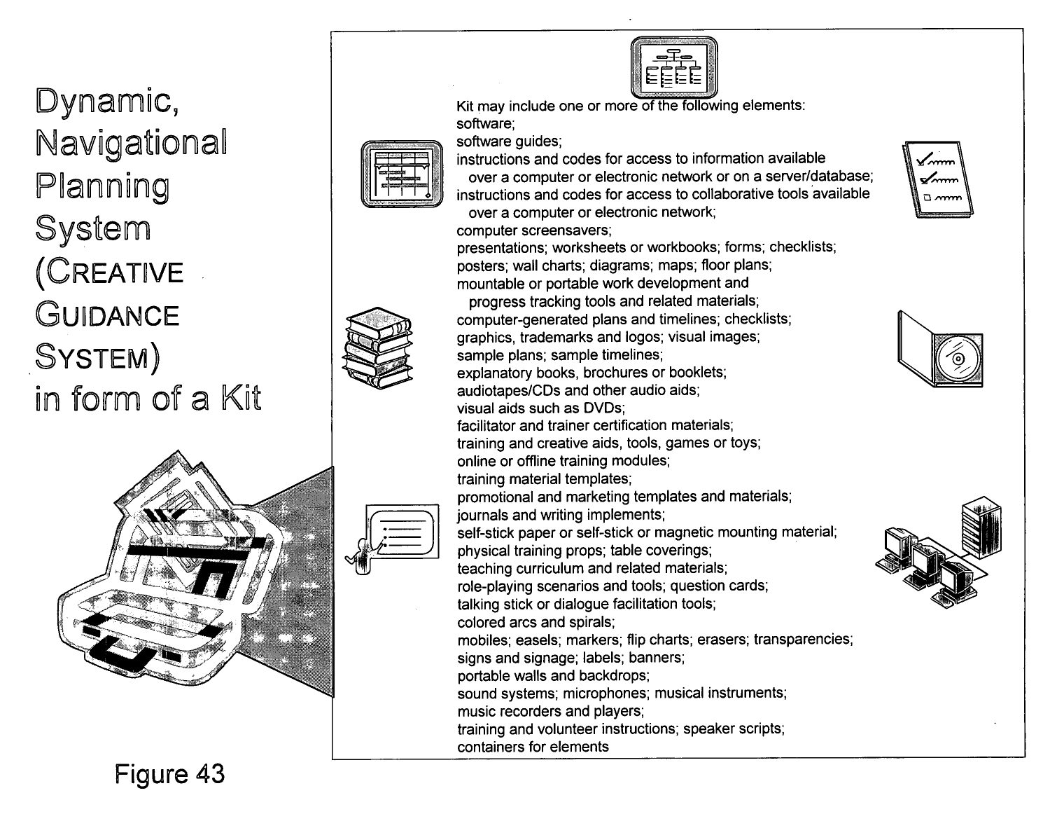

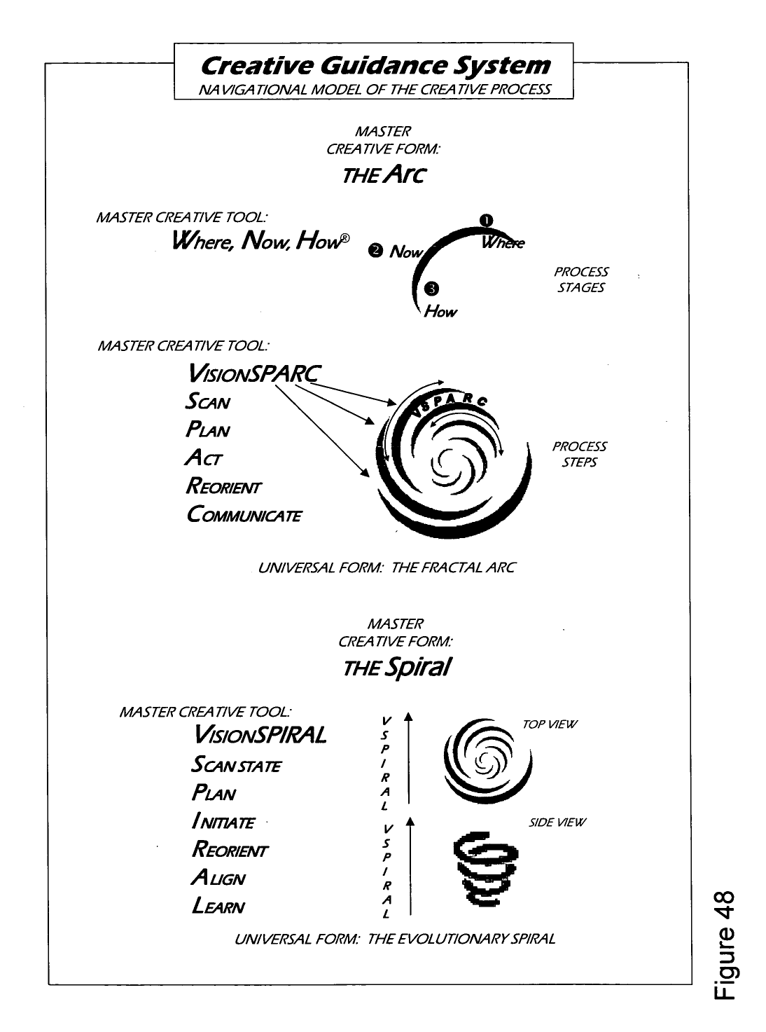

The tools and apparatus of the present invention include a kit for use by a trainer or facilitator to train individuals and groups in the use of the methods of the present invention, and/or to conduct a guided planning session or meeting using the methods of the present invention. FIG. 43 depicts the kit as a group of objects and tools that may be provided in a single package or a group of packages or containers. The kit may include, at least some or all of the following elements, and of course additional elements may be included without departing from the present invention:
Software computer products implementing some or all of the software modules shown in the software flowchart of FIG. 42; alternatively printed materials and guides to allow a participant to perform the methods of the invention without a computer may be provided;
Posters depicting the Creative Guidance System tools and methods in various ways, for example a poster of the Master Tools shown in FIG. 48 is particularly useful and may be left displayed throughout a meeting or conference for reference;
Worksheets including the ones described here and others for developing the personal arcs, group arcs, Vision and Mission statements and for planning the schedules, survey and analysis worksheets, and the like;
Vision Wall—a display method such as a chalk board, whiteboard, or other method where participants can post their individual or group goals during the sessions; educators can use these to list areas of interest or fields of study, also this board can be used for an ongoing plan to track the status of various arcs within the plan;
Creative Guidance System presentation, and related worksheets and materials, may be used by facilitators or trainers to explain the Creative Guidance System.
Optionally, creativity aids such as games, creativity toys and aids, shapes including arcs, spirals and 3-dimensional objects to reinforce and remind the participants of the various aspects of the invention;
Mnemonic aids such as posters, handouts, manually manipulable objects such as balls or toys with the mnemonics and phrases used with the preferred embodiments of the invention such as “Where, How, Now,” VisionSPARC, VisionSPIRAL.

A book or handbook explaining the Creative Guidance System may be made available to users of, or facilitators or trainers of, the Creative Guidance System to facilitate understanding and use of the System.

Banners, mug, calendars, T-shirts as desired to increase interest in and enhance the experience of the conference, meeting or event.

The kit contents may not include all of these items or it may include additional items. For example, the Orbits of Influence method of the pending patent application is also available as a kit; this Creative Guidance System kit may incorporate that kit in part, or, in its entirety.

The methods of the invention may also be used in combination with computer-based training or web-based access. Virtual conferences may be held and a web based interface may be provided to enable participants to conduct group dialogue sessions using, for example, so called meet me or instant messenger capability, files containing vision and mission statements and proposed arcs may be exchanged, combined group arcs or spirals may be created, shared, exchanged and displayed, so that the methods of the invention may be applied and used to plan by groups which has many individuals in remote locations, such as an international charity or a global corporation, as examples.

The system, method and software apparatus of the present invention creates various tools and outputs, such as mission, vision statements, dynamically adaptable plans which may be represented as navigable arcs, spirals or three dimensional spirals, and other aids which the individual or group may use in executing the steps necessary to transition to the “What Can Be” future reality that the executable plan enables the group or individual to achieve.

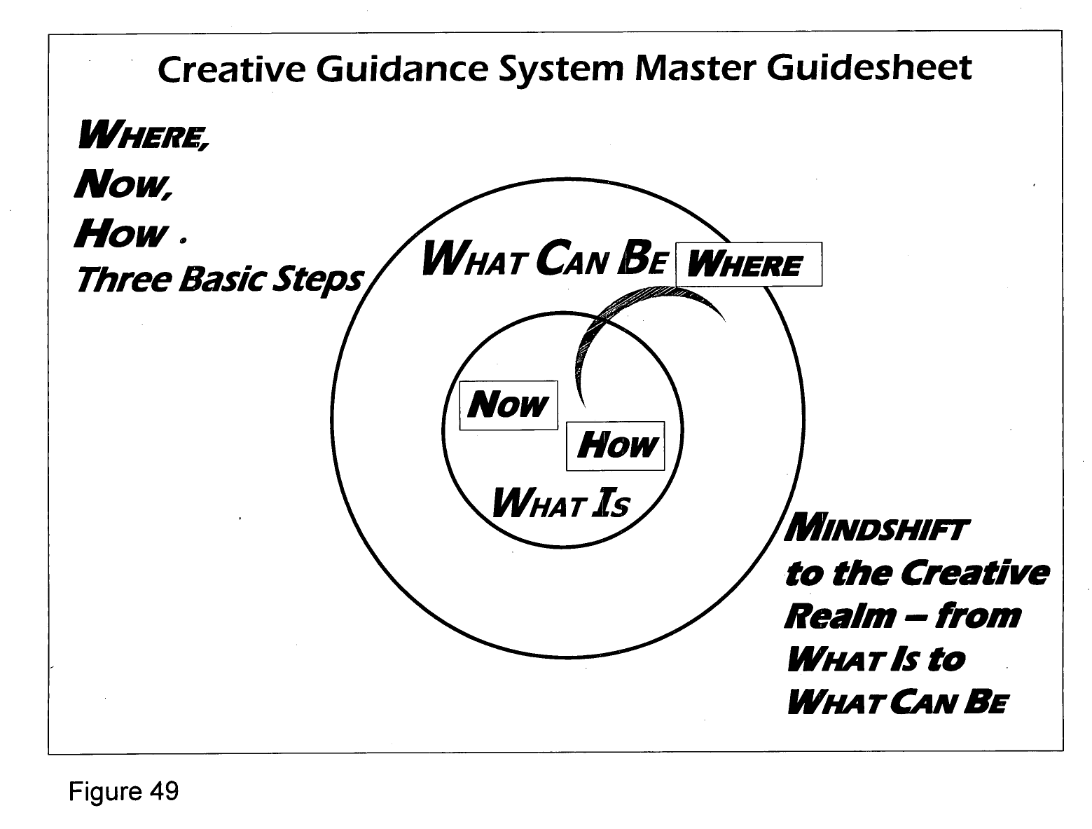

FIG. 49 depicts a guidesheet which may be used as a worksheet, computer screen graphic, viewgraph or handout that may be used to train individuals and groups to use the “Where, Now, How” methods of the invention with the creative arc tool form.

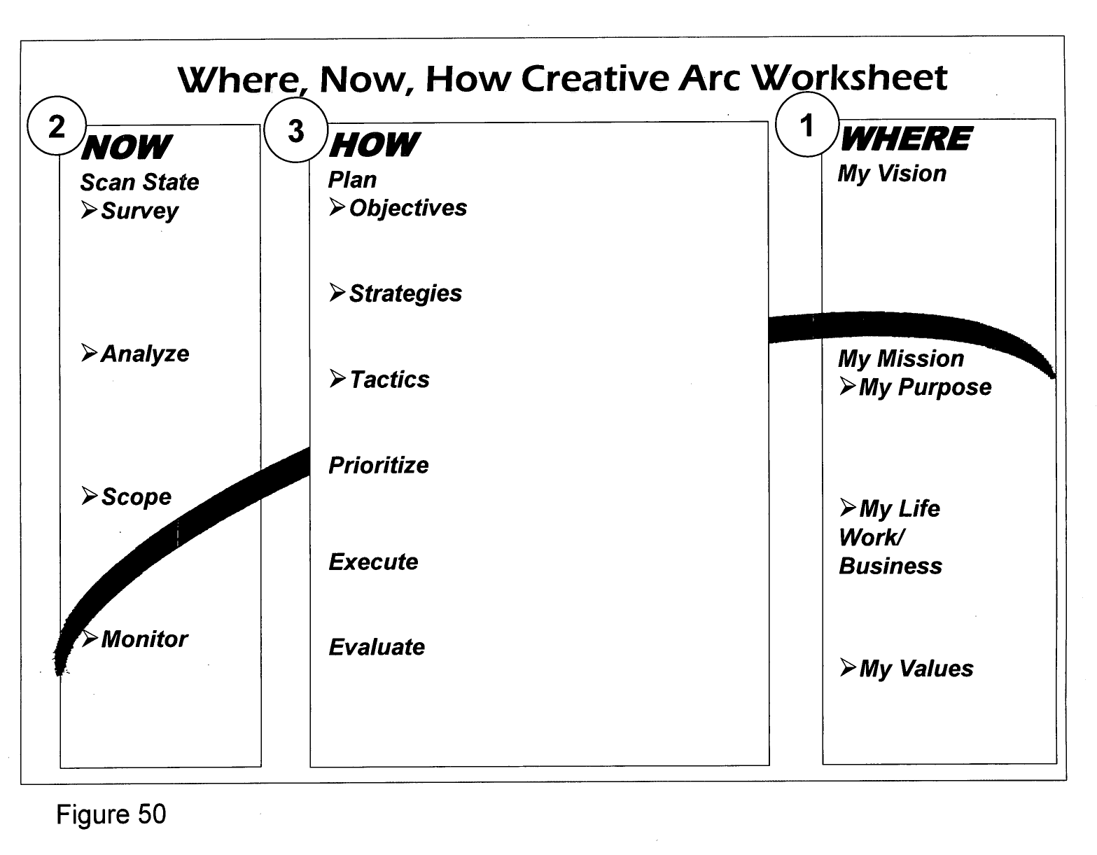

FIG. 50 depicts a worksheet, which may be provided as a paper handout, or incorporated into a software program or internet based user interface, for assisting the individual participant in first creating a vision and mission statement, second, performing the “Now” steps described above, including the Scan steps: Survey, Analyze, Scope and Monitor, and performing the “How” step which creates the objectives, strategies, tactics, priorities, execution and evaluate steps, and becomes the dynamic and adaptable plan for making the transition to the desired outcome, the Vision.

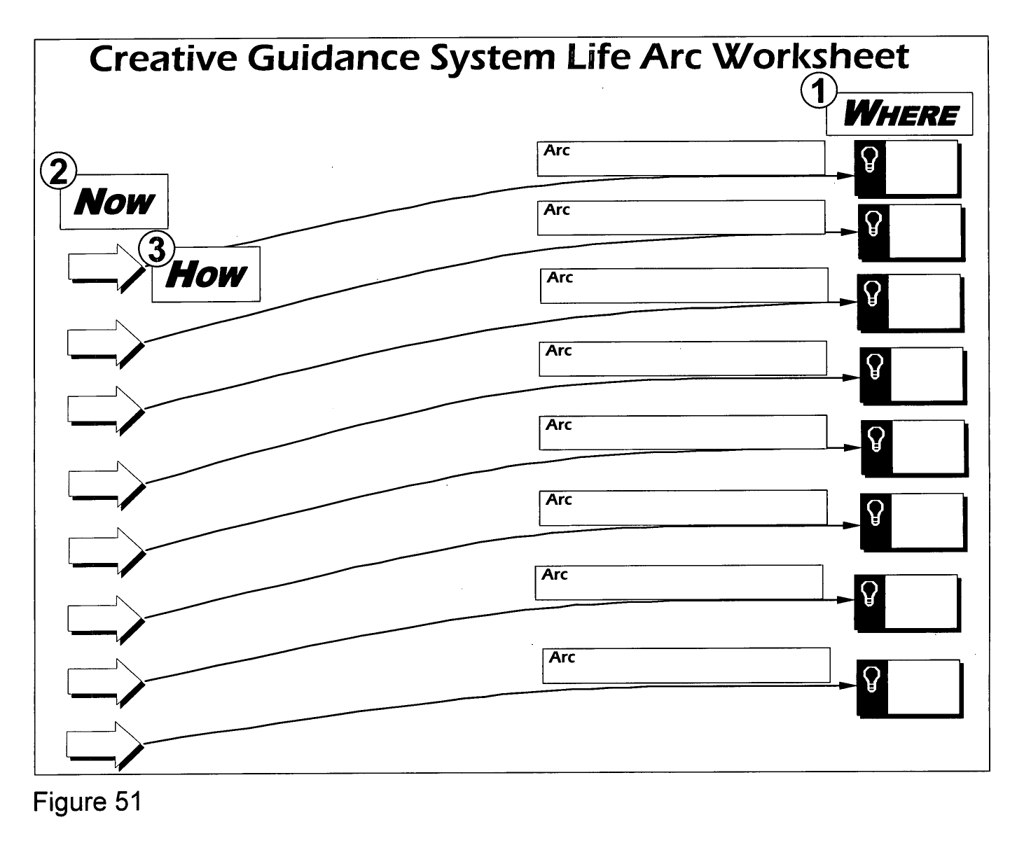

FIG. 51 depicts a Creative Guidance System Life Arc Worksheet which may be used with the methods of the invention. The worksheet may be provided as a handout, a screen shot, a internet interface, or as part of a software program or manual, for assisting the individual participants or groups in identifying the themes, or “planes of thought” that they are or would like to experience and enhance using the planning tools of the invention.

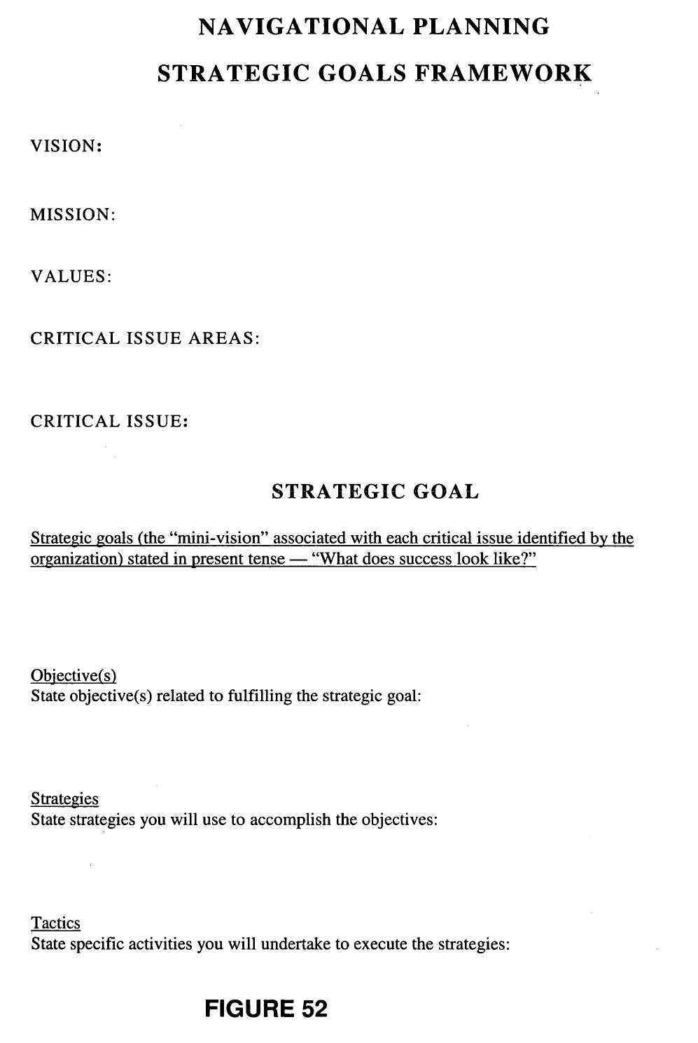

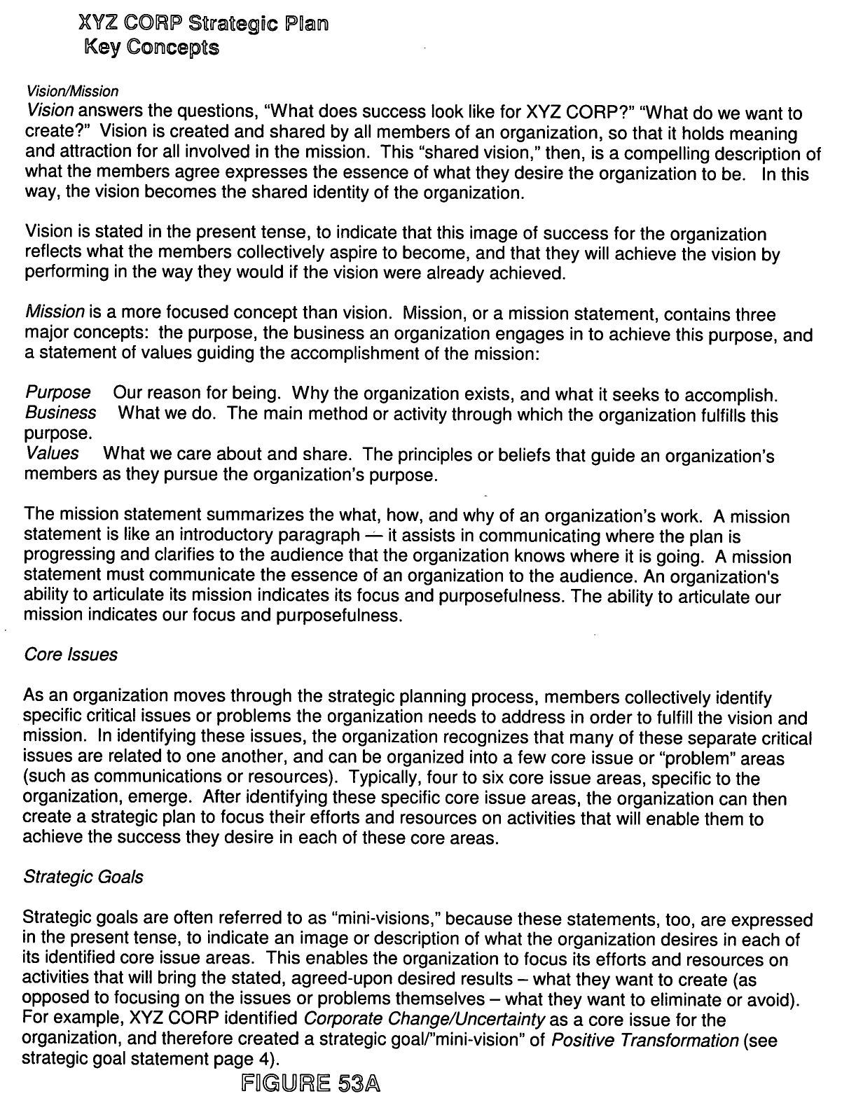

FIG. 52 depicts a worksheet for use with the methods of the invention to create a navigational plan for an individual or organization. Again the worksheet may be provided as a handout, a screen shot, a internet interface, or as part of a software program or manual, for assisting the individual participants or groups in performing the steps of the “Where, Now, How” process, creating a Vision and Mission, identifying the core Values, and Critical Issues, and creating Strategic Goals, with “mini-mission” statements, stating objectives to be attained to fulfill the goal, creating strategies used to accomplish the objectives, and identifying resources, existing or to be acquired, to be used in carrying out the strategies. This process is repeatable and scalable and any Strategic Goal can be further refined into subgoals using the same process until appropriate levels are reached.

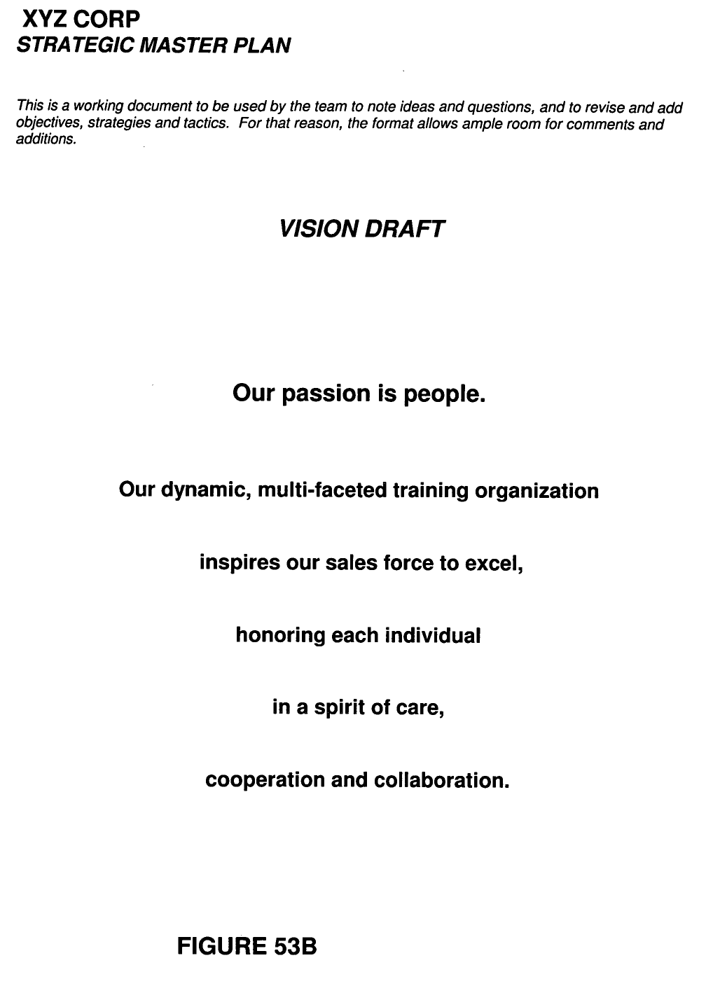

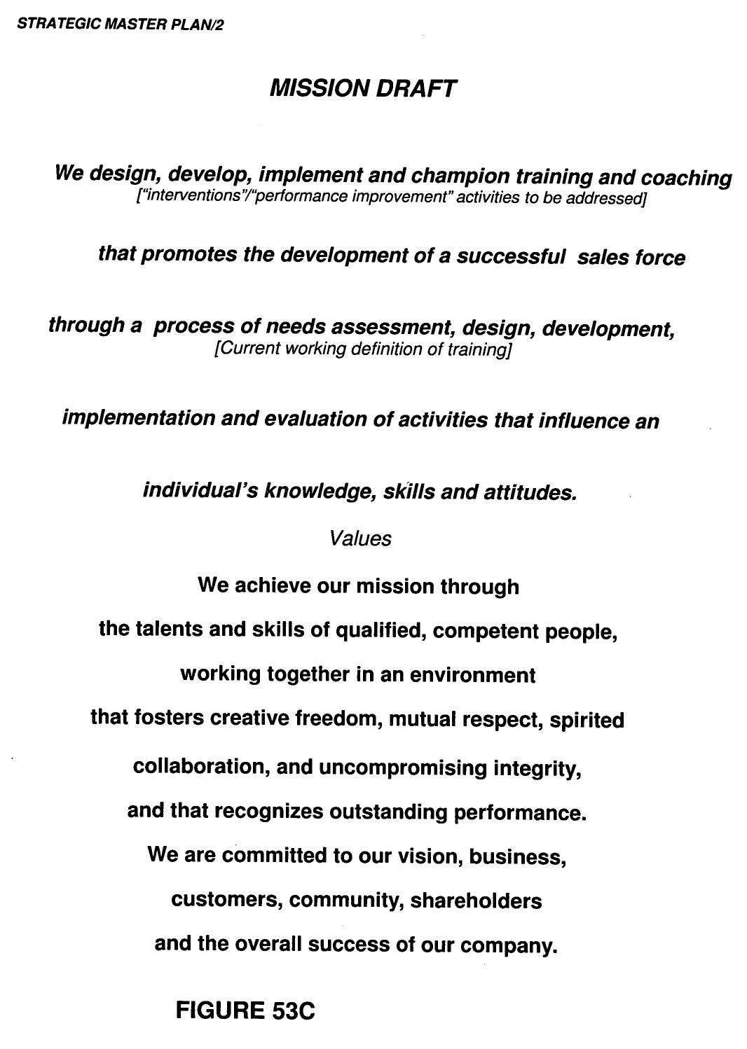

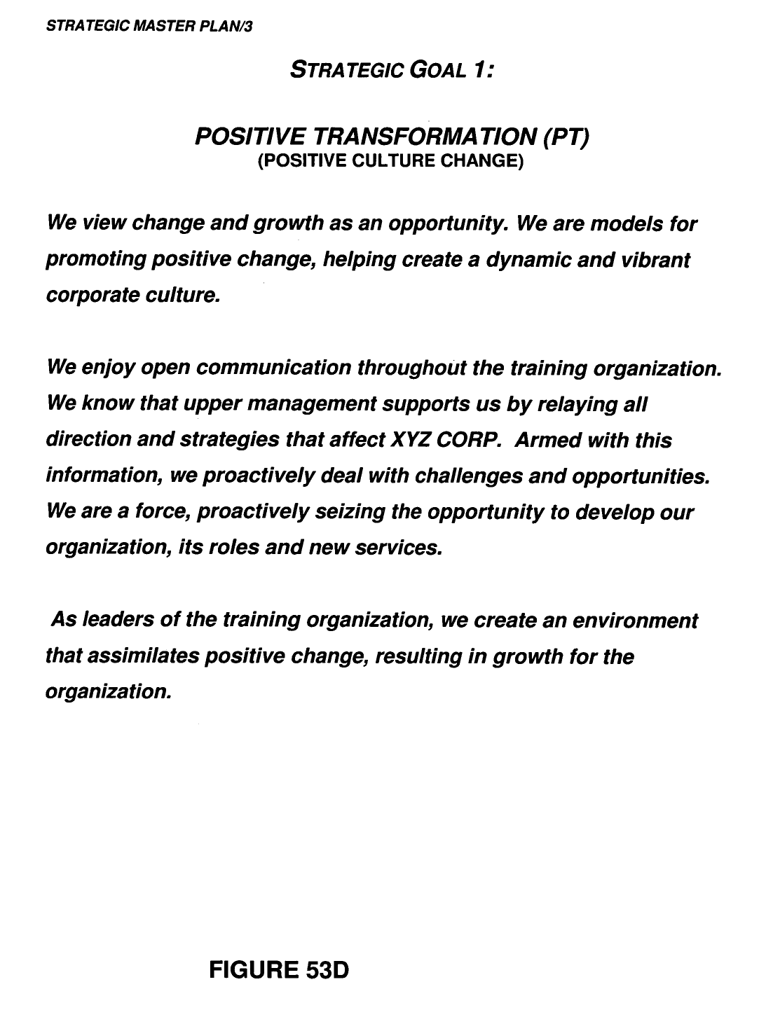

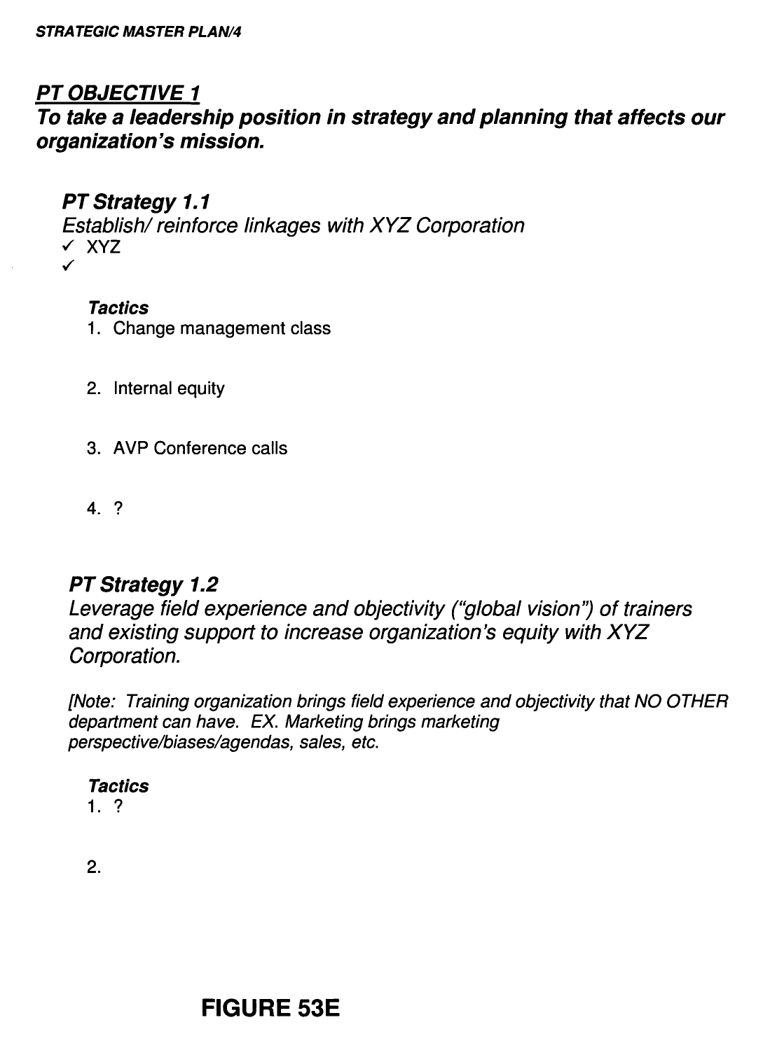

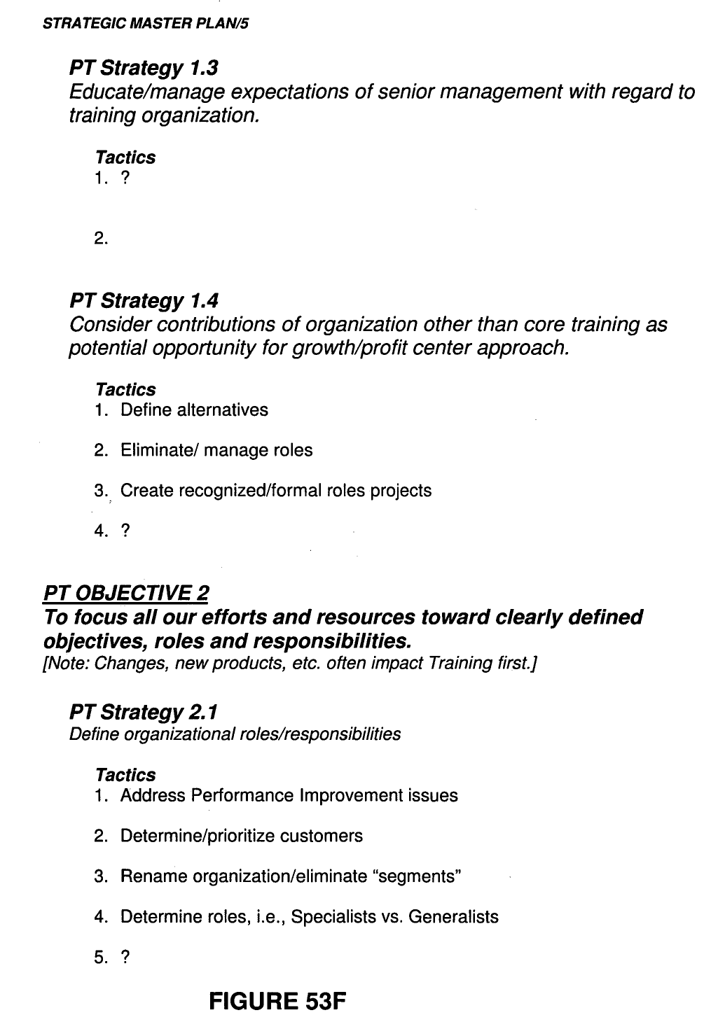

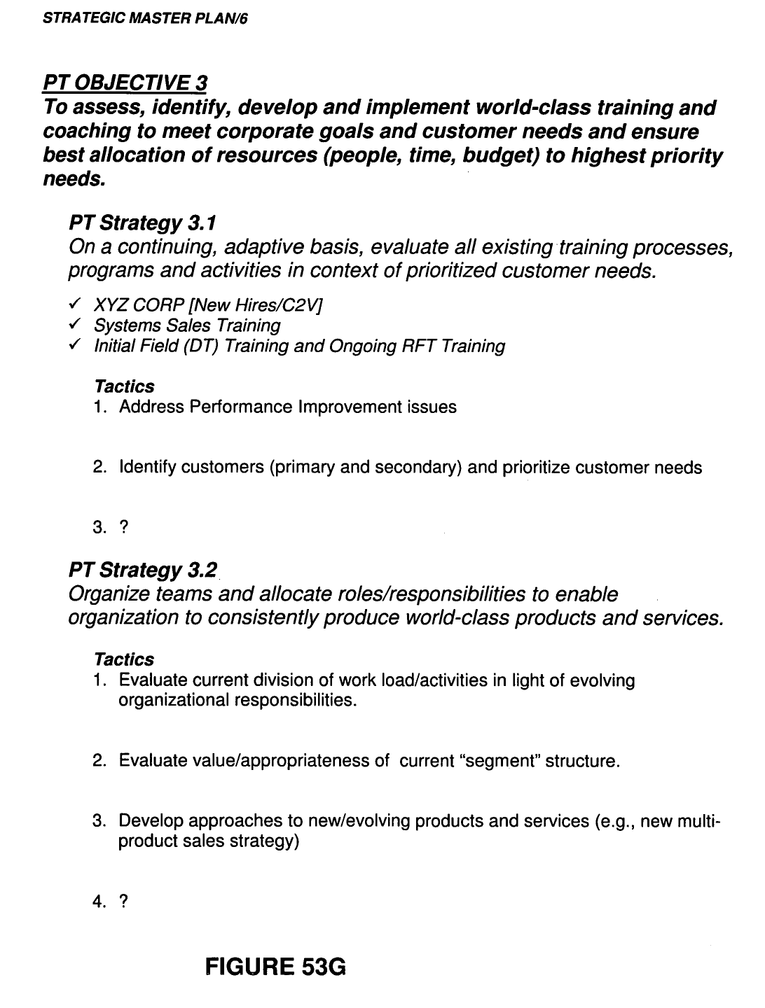

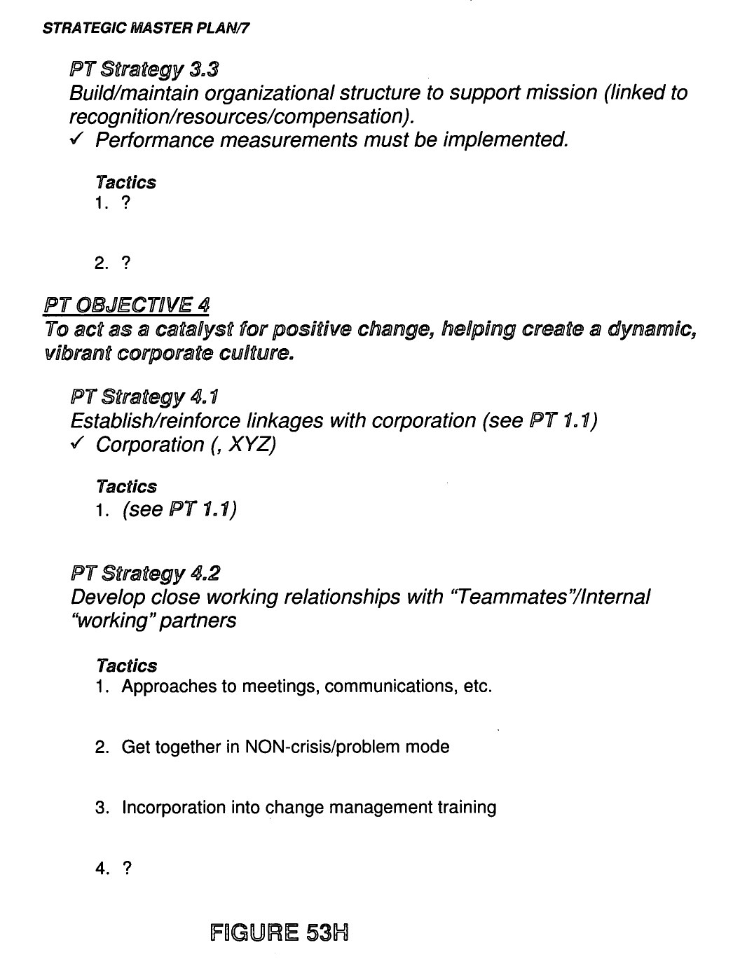

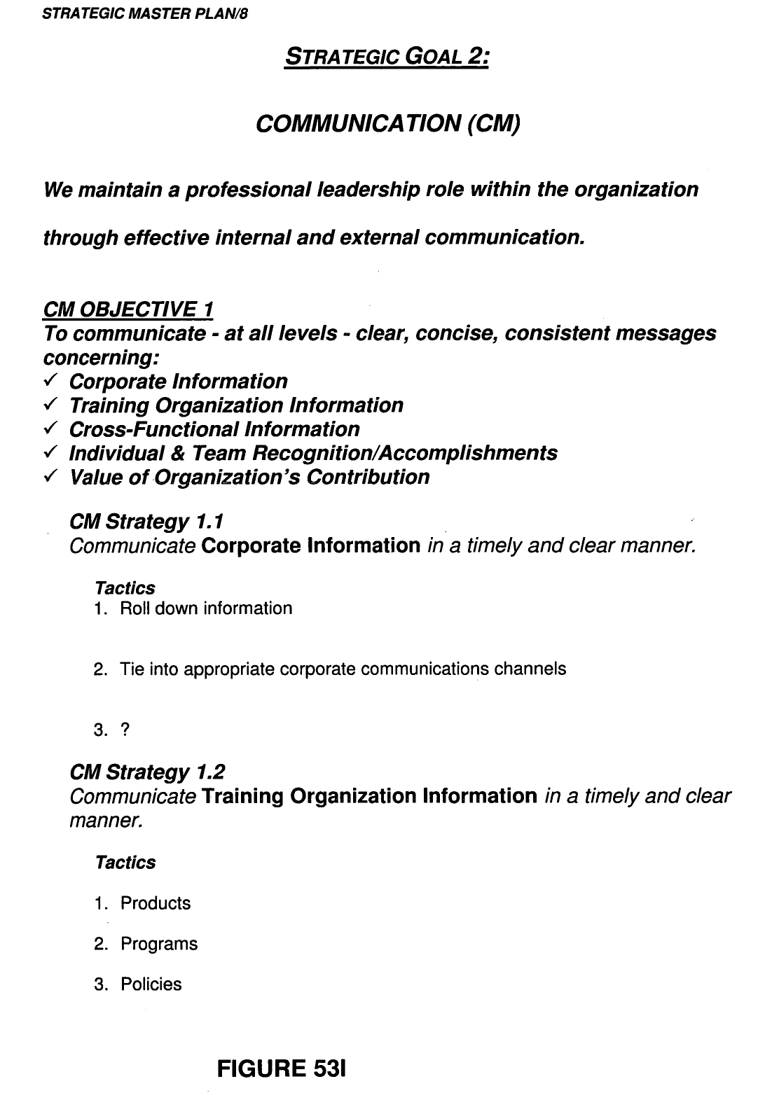

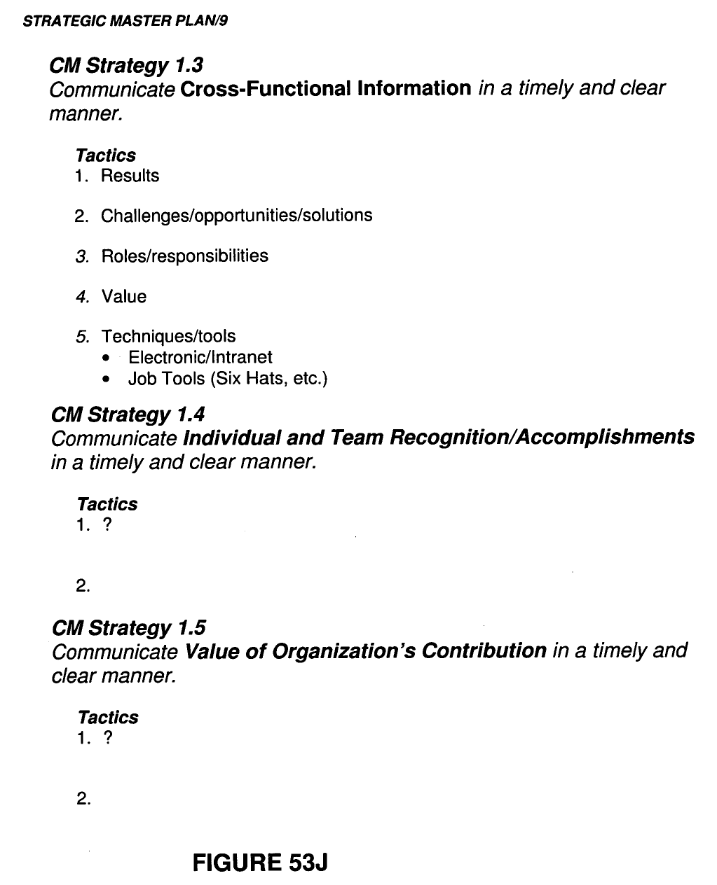

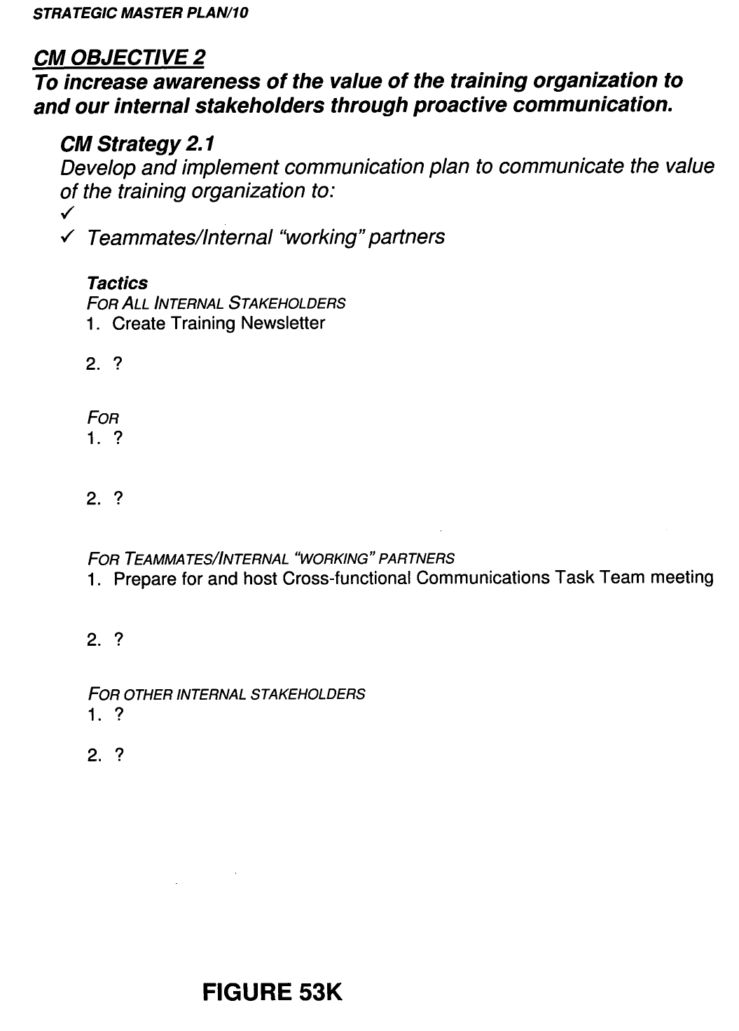

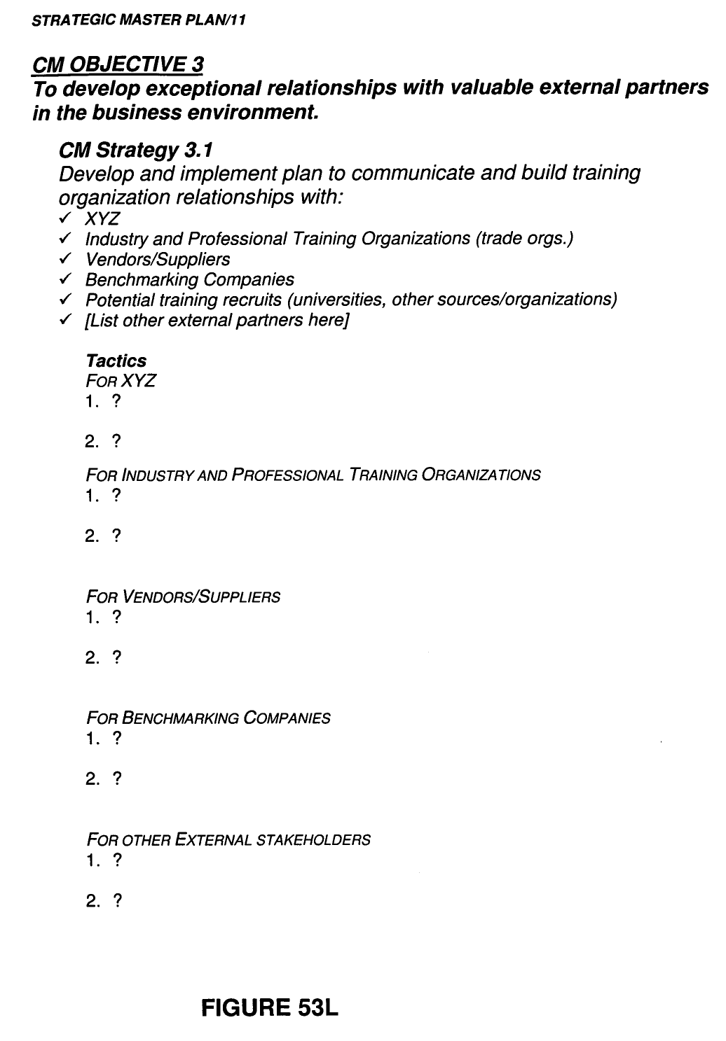

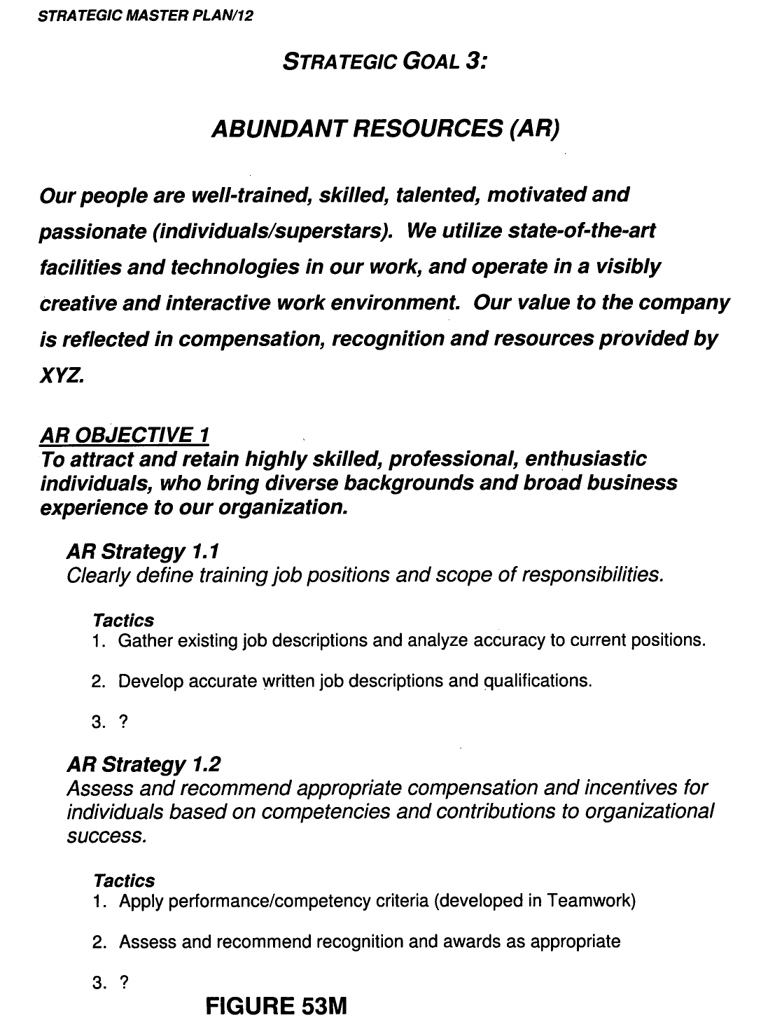

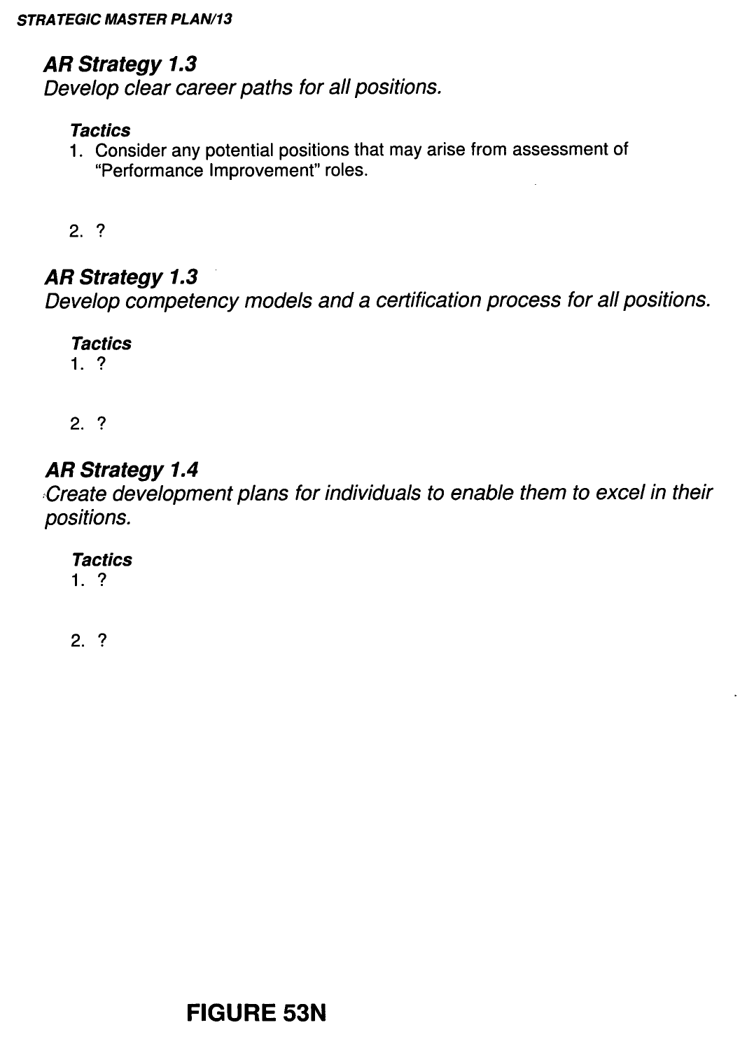

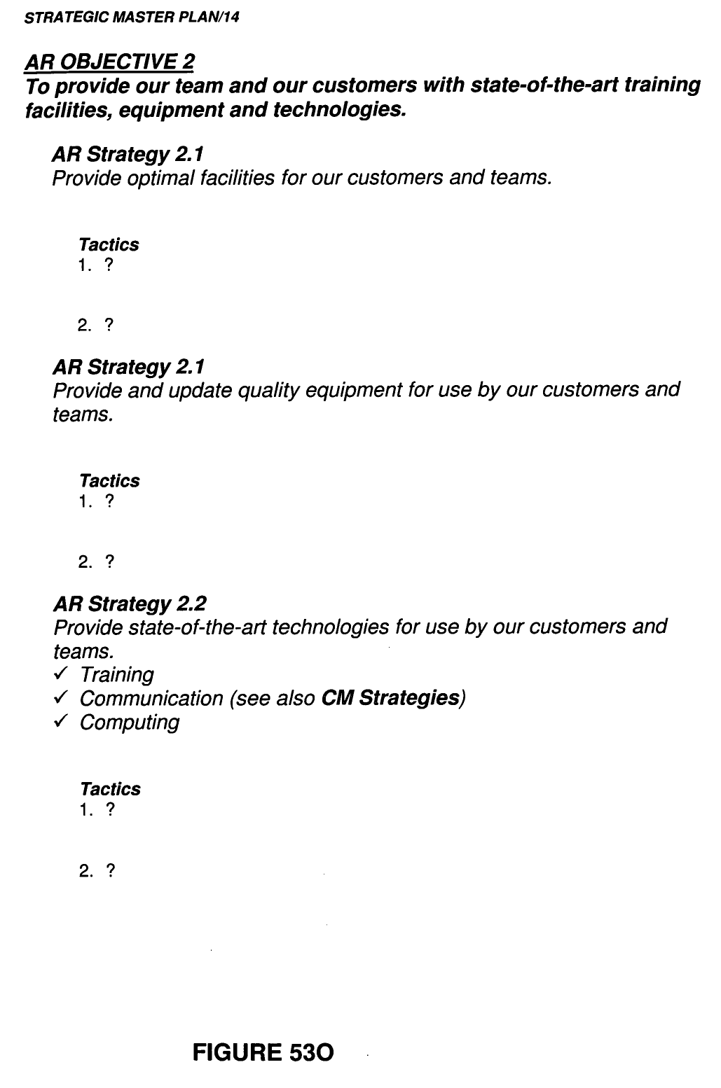

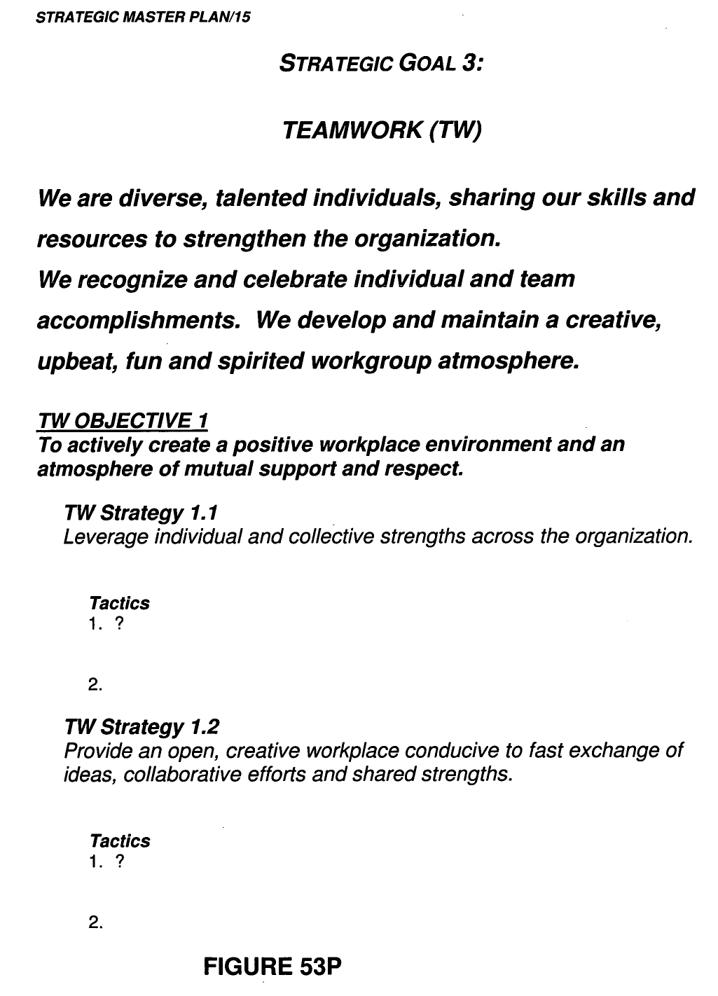

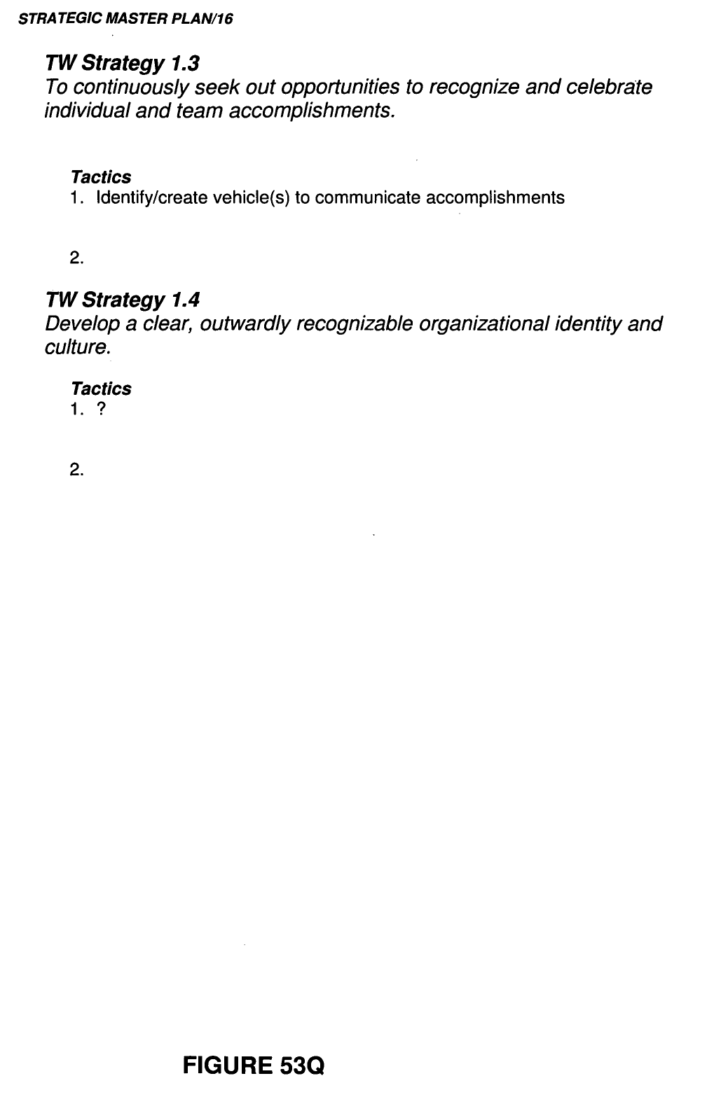

As an example and without limiting the invention, FIGS. 53A-Q depict a Master Plan for a corporation, XYZ Corp., which could be obtained using the methods, tools and steps of the invention described above. FIG. 53A provides an explanation of certain key concepts of the tools so that participants using the methods of the invention can understand and participate in the creation of the various components such as the Vision and Mission statements, strategic goals, and core issues. FIG. 53B depicts a sample Vision and FIG. 53C depicts a sample Mission statement created for the corporation. FIGS. 53D-G depict the vision/mission, objectives, and strategic approaches to obtaining the objectives for a first strategic goal, described as Positive Transformation, the mission statement of 53D makes clear that this strategic goal is to create a positive culture change in the organization. Figures E-H depict the objectives for the strategic goal; each objective is further described in terms of strategic approaches the organization may use to achieve this goal. The Master Plan is a working document at the stage depicted and indeed throughout the process of the invention, and so the various forms depicted as output from the process leave room for additional strategic approaches, changes, added resources, and identification of other opportunities as the Plan is executed. Since the Plan is reoriented on an ongoing basis, it is never “finished” but is updated to reflect the current state of the organization and new strategic goals may be added even as earlier ones are achieved. FIGS. 53I-L likewise depict the forms for the second strategic goal in terms of objectives and strategic approaches for achieving them. The second strategic goal is Communication in this example. The third strategic goal, Abundant Resources is likewise depicted in FIG. 53M-O, and the fourth strategic goal in this example, Teamwork, is depicted in FIGS. 53P and 53Q. Each strategic goal has a mission and vision statement, objectives and strategic approaches for achieving these objectives, these components are the results of the processes and steps of executing the methods of the invention as described above.

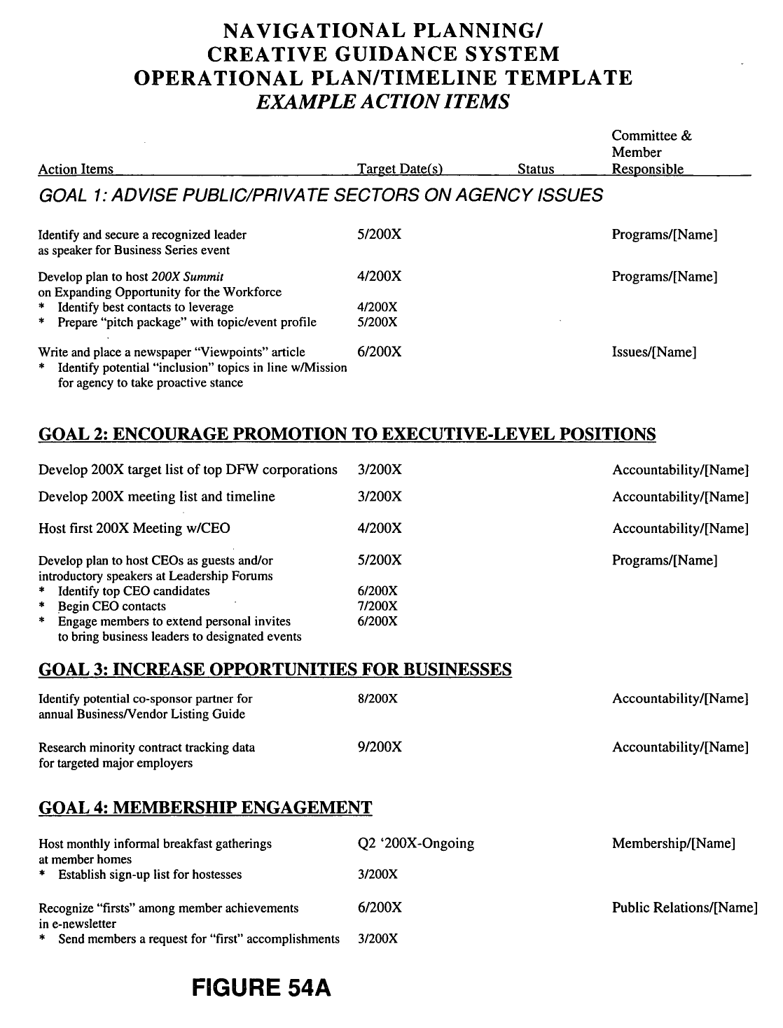

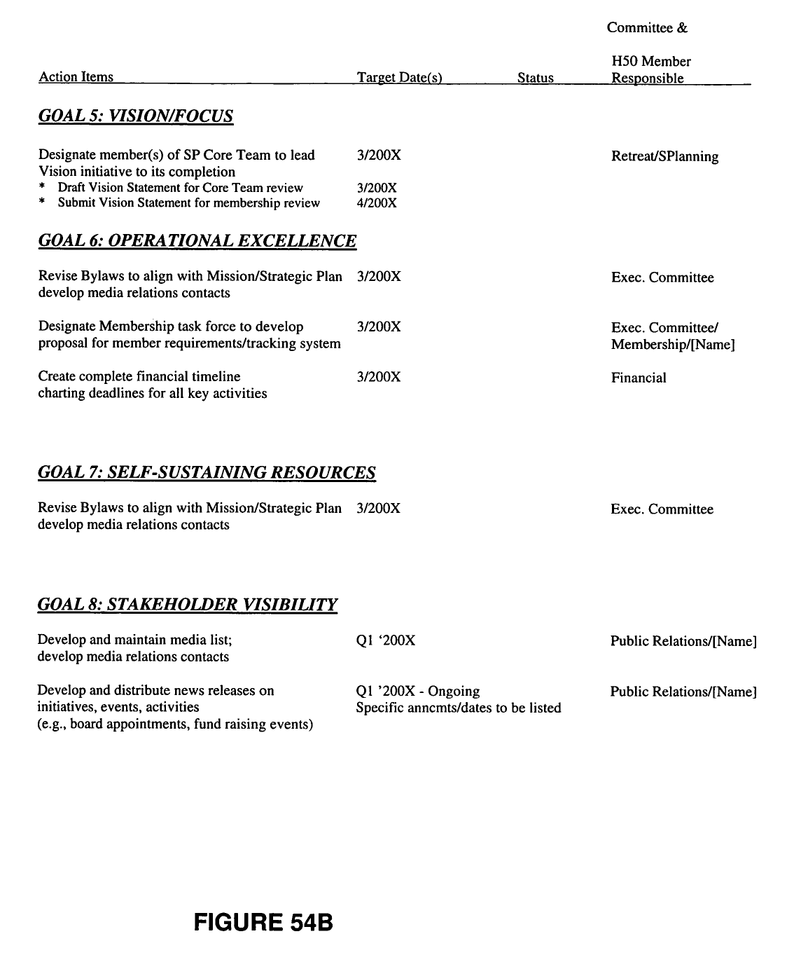

FIGS. 54A-B provide, in a table form which may be recorded on, a printout, screen shot for display, web page, website or other human or machine readable formatted media, a sample Operational Plan/Timeline that may be created using the methods and tools of the invention, including without limitation the software modules described above. The Operational Plan in this example identifies specific goals for a corporation, and has executable steps associated with each goal and a timeline for achieving each step. Again, the Operational Plan is a dynamic and adaptable plan and so this Plan will be changed to reflect for example adding or losing resources, changes in the goals, changes in the approaches identified, etc, which come out of the on going use of the methods and tools of the invention as described above.

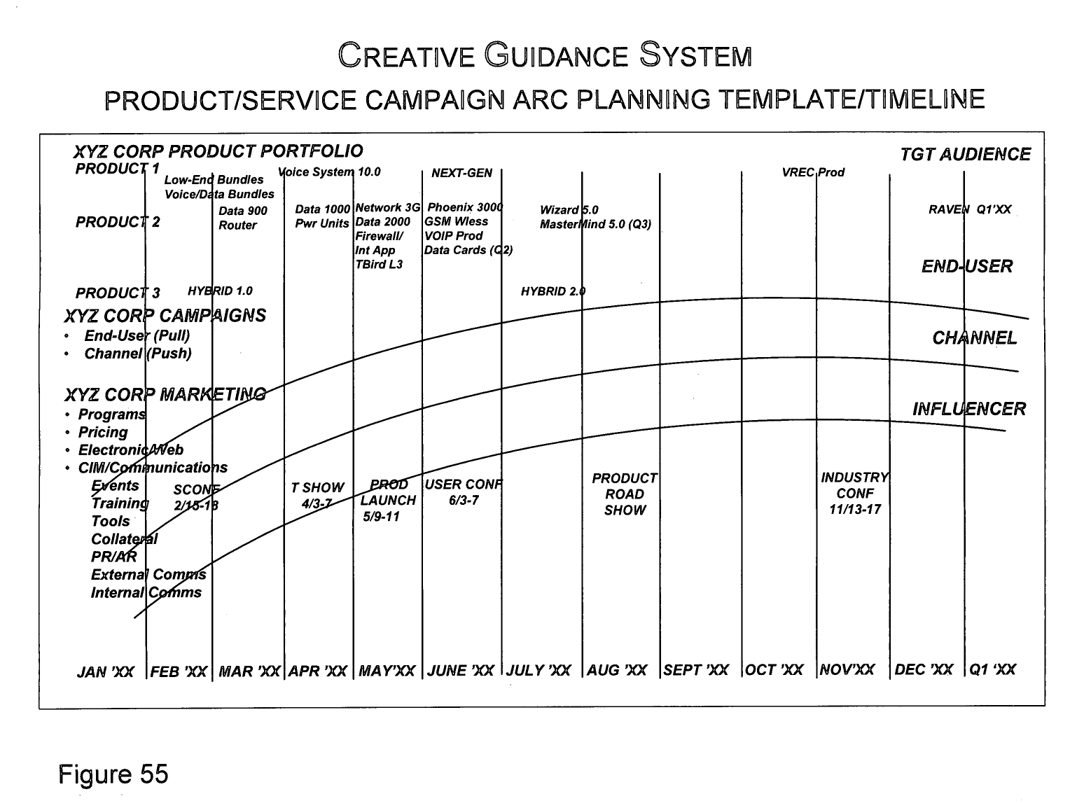

FIG. 55 depicts a sample plan created with the methods and tools of the invention which utilizes the creative arc tool and which represents the plan visually as a navigable arc. The planning template depicts the deadlines and executable tasks and strategic objectives are shown as steps along the navigable arc from the present state to the desired Vision or future set of circumstances. The responsible group or individual for strategic objectives may be identified, and if desired necessary resources may be listed.

The system, method and apparatus of the present invention may be provided as a franchise opportunity or licensing model. Individuals may be trained as facilitators or trainers and given the right to provide the invention in certain areas or regions; alternatively corporate entities or large groups may wish to have an individual become qualified as a trainer and provide the methods of the invention to their members at in house training sessions, or apply the methods at in house planning sessions.

The above descriptions of the system, methods and apparatus of the invention include exemplary and specific examples, however the invention is not so limited. As one skilled in the art will recognize, various combinations and variations of the features of the invention can be made without departing from the present invention, and these and other embodiments and examples clear to those skilled in the art are encompassed by the invention and are within the scope of the appended claims.

What is claimed is:

1. A method for creating a visually representable plan to achieve a desired goal, comprising the steps of:
providing a dynamic, navigational planning method to individual or group users and stakeholders who are participants;
training the participants to use the tools of the arc and the spiral, the related and recurring sequence of planning steps they represent, and the mnemonic names or acronyms for each sequence of steps;
initiating a planning process by focusing the participants on describing desired future outcomes, experiences and potential desired goals and creating a dynamically adaptable plan to generate desired outcomes which do not yet exist, the process comprising the step of;
describing the desired goal as a future set of circumstances wherein one or more participants will attain certain desired attributes and experiences;
collecting information about the current set of circumstances by surveying the participants, planning situation and environment, assessing this information through the use of analytical tools, and analyzing the results of this survey step to assess, measure and evaluate the current set of circumstances and focus the scope of the planning;
after the previous steps are completed, creating a navigational plan and corresponding timeline for executing actions to transition from the current set of circumstances to the desired goal, enabling users to dynamically navigate and constantly adjust and adapt the plan and corresponding timeline to incorporate emerging opportunities and address challenges, and to accordingly reallocate resources in real time to attain desired result(s); and
visually representing said plan as at least one navigable arc along which may be placed executable steps and milestones for completing the executable steps, which, when executed will enable the participants to achieve the desired goal.

2. The method of claim 1 and further comprising the steps of:
consistently re-executing the steps of collecting and assessing information to reflect changes in the current set of circumstances from time to time and re-evaluating and updating the current set of circumstances; and
updating elements of the plan and the visually represented navigable arc and the corresponding timeline to adapt to and address these changes in the current set of circumstances and to re-orient the plan to the desired goal(s), again representing the executable steps and milestones along the arc, incorporating the updated information, and communicating these navigational changes to the participants.

3. The method of claim 1, wherein the step of describing the future set of circumstances comprises the steps of developing and describing the future set of circumstances as group of clearly identifiable experiences and attributes which the participants will recognize, experience and benefit from when the desired goal is attained.

4. The method of claim 3, wherein the step of developing and describing is used to create a Vision statement that may be represented in written, visual, audio or electronic form.

5. The method of claim 3, wherein the step of developing and describing the future set of circumstances is performed as an organized group dialogue event using enhanced dialogue sessions to create a description that may be represented in written, visual, audio or electronic form.

6. The method of claim 3 wherein the step of developing and describing further comprises the steps of creating a Mission statement that may be represented in written, visual, audio or electronic form, which includes identifying a purpose the participants wish to achieve, the enterprise, business, work or activity the participants will act within to achieve the purpose, and a statement of values to be used in guiding the enterprise to achieve the Mission.

7. The method of claim 6 wherein the steps of creating a Mission statement are performed during an organized group event using enhanced dialogue sessions.

8. The method of claim 1 wherein the step of collecting information about the current set of circumstances further comprises the steps of surveying the participants
to collect objective information about the current set of circumstances, analyzing the information collected to determine additional information, assessing the collected information to determine the resources and attributes available to the participants, and monitoring the current set of circumstances on an ongoing basis by collecting new information which is used to update the description of the current set of circumstances.

9. The method of claim 8, wherein the steps of surveying, analyzing, assessing the resources and scope and monitoring are re-executed on an ongoing basis during the execution of the plan.

10. The method of claim 1, wherein the step of creating a plan which may be visually represented as at least one navigable arc further comprises creating a schedule or timeline for the total, and identifying executable steps to be executed using play and related creative tools, techniques, games or toys as a method of considering alternative approaches to problem-solving and of identifying executable steps.

11. The method of claim 10, wherein the step of using play further comprises conducting an organized event wherein the participants use role-playing to consider alternative approaches to problem-solving.

12. A method of creating a plan that is visually represented as a series of navigable arcs or series of arcs, or an integrated or master arc or interrelated spiral comprised of arcs, or which may be expressed as any written, audio, visual or electronic representation of the plan generated through the use of these tools, steps and methods, comprising the steps of:
providing software for execution on a participant's computer;
executing a software module for providing a dynamic, navigational planning method having unique tools to individual or group users and stakeholders who are participants;
executing a software module training the participants to use the unique tools of the arc and the spiral, the related and recurring sequence of planning steps they represent, and the mnemonic names or acronyms for each sequence of steps;
executing a software module planning process which aids the participants in describing desired future outcomes, experiences and potential desired goals and creating a dynamically adaptable plan to generate desired outcomes which do not yet exist, the planning process comprising the step of;
executing a software module for creating description of the desired goal as a future set of circumstances to be attained wherein one or more participants will have certain desired attributes and experiences;
executing a software module collecting information about the current set of circumstances by surveying the participants, planning situation and environment, assessing this information through the use of analytical tools, and analyzing the results of this survey step to assess, measure and evaluate the current set of circumstances and focus the scope of the planning;
after the previous steps are completed, executing software for creating a navigational plan and corresponding timeline for executing actions to transition from the current set of circumstances to the desired goal, the software enabling users to dynamically navigate and constantly adjust and adapt the plan and corresponding timeline to incorporate emerging opportunities and address challenges, and to accordingly reallocate resources in real time to attain desired result(s); and
executing software that visually represents said plan as at least one navigable arc along which may be placed executable steps and milestones for completing the executable steps, which, when executed, will enable the participants to achieve the desired goal.

13. The method of claim 12 wherein the method further comprises the steps of:
executing a software module which provides a displayed, printed, audio, visual or machine readable stored timeline of actions to be taken by the participants to implement the plan and to initiate and execute the transition to the future goal.

14. The method of claim 13, and further comprising the steps of:
executing a software module that assists the user in reevaluating the plan by verifying the progress made and the resources and conditions that exist on a periodic basis, reallocating resources or scheduling the addition of resources to continue progress on the actions in the plan, and revises the executable steps and the milestones associated with the executable steps to dynamically update the plan, and outputs an updated representation of the plan.

15. The method of claim 14 and further comprising the steps of:
executing a software module or set of collaborative tools available over a computer or electronic network that assists the participant in creating a communication system to communicate the plan and the visual representations of the plan to the participants, to empower the participants to interact with and modify the portion of the plan they are to execute, and to provide feedback paths to the other participants and to revise the plan based on their results.

16. The method of claim 15 wherein the method of creating a communication system further comprises creating an electronic communication system on a network.

17. The method of claim 15 wherein the method of creating a communication system further comprises the steps of creating an Internet-based online collaborative space and related tools.

18. A kit for the creation of plans which may be visually represented as one or more navigable arcs and which may be expressed as any written, audio, visual or electronic representation of the plan, comprising:
a container for portably containing the elements for convenient use;
a tutorial for instructing the user in the use of the apparatus for creation of plans by identifying a future set of circumstances, analyzing a present set of circumstances, identifying strategic objectives to be performed to transition from the present set of circumstances to the future set of circumstances;
materials including worksheets for performing the method of creation of plans;
materials for visually representing the transition from the present set of circumstances to the future set of circumstances as an arc with the strategic goals being placed along a navigable journey along the arc; and
visual aid materials for providing explanatory graphics depicting the arc and spirals comprised of one or more arcs to aid the user in understanding and performing the plan creation method and in using the navigable arc visual representation;
whereby upon opening the container a user may utilize the tutorial and learn to use the apparatus to create a plan for transitioning from the present set of circumstances to the future set of circumstances and may create a visual representation of the plan in the form of at least one navigable arc.

19. The kit of claim 18, and further comprising:
arc templates that a particular plan may be written on and which may be combined to form at least one plan visually represented as an arc.

20. The kit of claim 18, and further comprising arc templates that a particular plan may be written on and which may be combined to form at least one plan visually represented as a series of interrelated arcs.

21. The kit of claim 20 wherein the series of interrelated arcs is arranged to form a plan visually represented as a spiral.

22. The kit of claim 21 wherein the series of interrelated arcs is arranged to form a plan visually represented as a three-dimensional spiral.

23. The kit of claim 18 and further comprising software recorded on computer media for providing the tutorial and a computer based arc generation tool for creating visually represented plans in the form of at least one navigable arc.

24. The kit of claim 18 and further comprising:
software disks including the tutorial in the form of an executable program; and
manuals for the software disks.

25. The kit of claim 18 and further comprising at least one of:
software including the tutorial;
visual aids for conducting a facilitated training session to teach users the method for creating plans visually represented as a navigable arc;
materials for recording descriptions of the present set of circumstances, the future set of circumstances, strategic objectives, and for representing the plan as a navigable arc;
arc templates for enabling the user to create visual representations of plans as navigable arcs;
spiral templates for enabling the user to create visual representations of plans as a series of navigable arcs;
toys for encouraging users to create descriptions of desired future circumstances;
three-dimensional spiral representations which the user can personalize by recording plans upon for enabling the user to create visual representations of plans as a three-dimensional spiral formed of a series of navigable arcs.

26. A computer program product comprising:
application computer program code for executing a method for creating a plan for attaining a future desired goal visually represented as one or more navigable arcs, the application program code being responsive to a user commands and executing the steps of:
displaying and creating forms for surveying and collecting information from the participants to be used in describing a desired future set of circumstances the participant will experience when a goal is attained;
displaying and creating forms for surveying and analyzing a present set of circumstances and capabilities in the participants and software for providing visual representations of the present circumstances;
executing games and role-playing software for use by the participants in play sessions to create possible approaches to problems and to create executable steps to be used as part of the plan; and
outputting visual representations of executable plans in the form of navigable arcs having defined executable steps developed during the play sessions and with user provided milestones for executing the steps arranged along the visual arcs;
whereby the plan for transitioning from a present set of circumstances to a desired future set of circumstances which represents a state of the participants after a goal is attained is visually presented in the form of one or more arcs and the schedule of executable steps is represented as a journey along one or more of the arcs.

27. A method for creating a plan that is visually represented as a navigable arc, comprising the steps of:
providing software for an individual to use;
using the software, guiding the individual in creating a description of a future desired set of circumstances;
using the software, guiding the individual in performing a series of surveys to characterize the present set of circumstances; and
subsequently, using the software to create a plan which is a set of objectives to be performed in order to transition from the present set of circumstances to the desired set of circumstances;
wherein the plan is visually represented as an arc having a beginning associated with the present set of circumstances and an end associated with the desired set of circumstances and the objectives to be performed are represented as steps along a navigable arc.
